(19) United States
(12) Patent Application Publication
(10) Pub. No.: US 2025/0166306 A1
(43) Pub. Date: May 22, 2025

(54) METHOD AND SYSTEM

(71) Applicant: COVER Corp., Tokyo (JP)

(72) Inventors: Kohei MORI, Tokyo (JP); Wataru SHIMOE, Tokyo (JP)

(21) Appl. No.: 18/945,516

(22) Filed: Nov. 13, 2024

(30) Foreign Application Priority Data
Nov. 16, 2023 (JP) 2023-195231
Nov. 16, 2023 (JP) 2023-195232
Nov. 16, 2023 (JP) 2023-195233
Nov. 16, 2023 (JP) 2023-195234
Nov. 16, 2023 (JP) 2023-195235

(51) Int. Cl. G06T 19/00

(52) U.S. Cl. CPC G06T 19/00; G06T 2219/024

(57) ABSTRACT

The method executes a process of changing setting of the virtual space provision unit to a continuous provision state so that the virtual space is continuously provided to users when it is a predetermined state that is established in response to multiple types of actions including entry into the virtual space by a user who does not satisfy a specific condition, the predetermined state being to change the setting of the virtual space provision unit; and in response to an entering of the virtual space among actions by a user who satisfies the specific condition, executes a process of changing the setting of the virtual space provision unit to the continuous provision state, also in a situation where the predetermined state would not be established when a user who does not satisfy the specific condition entered the virtual space.

### CROSS-REFERENCE TO RELATED APPLICATIONS

This patent specification is based on Japanese Patent Application, No. 2023-195231, No. 2023-195232, No. 2023-195233, No. 2023-195234, and No. 2023-195235 filed Nov. 16, 2023 in the Japan Patent Office, the entire contents of which are incorporated by reference herein.

### BACKGROUND

### 1. Technical Field

The present invention relates to methods and systems.

### 2. Description of the Background

A system is known, which provides a virtual space to users via a network and enables them to interact with other users in the virtual space.

If the load on a server increases due to concentrated access to the server, measures to reduce the load on the server are taken by pre-setting an auto-scaling function to increase the number of servers or improve the CPU and memory specifications to enhance the processing capacity of the entire server (see, for example, Patent Literature 1). Furthermore, attempts have been made to reduce the server load by performing a process for reducing the amount of communication with user terminals if the server load increases (see, for example, Patent Literature 2).

### CITATION LIST

### Patent Literature

Patent Literature 1: JP 2017-111664
Patent Literature 2: JP 2014-230798

### BRIEF SUMMARY

In a system in which the aforementioned virtual space is provided, when a famous user enters the virtual space, accesses from fan users may suddenly increase because they are trying to follow the famous user and enter the virtual space. With a conventional auto-scaling function, however, such a sudden increase of access to the virtual space may cause users to wait due to the delays in server processing. This is because this function increases the number of servers only after the load has increased. Furthermore, a sudden load placed on the server may cause a server failure, which may necessitate the suspension of the functions of the system providing the virtual space.

In views of the above, the present invention provides a method and a system that enable measures to be taken against the load caused by the entry of a specific user into a virtual space.

(1) A computer control method according to one aspect of the present invention makes a computer (e.g., distribution server 100) perform a process of controlling a virtual space provision unit (e.g., controller 130, login authentication API server, and room server) that provides a user with the virtual space, and the method includes:
a first step of executing a process (e.g., steps S301 to S302 in FIG. 18 and steps S401 to S403 in FIG. 19) of changing setting of the virtual space provision unit to a continuous provision state so that the virtual space can be continuously provided to users when it is a predetermined state that is established in response to multiple types of actions (e.g., entry by logging in, entry into a room, motion action in the virtual space) including entry into the virtual space by a user who does not satisfy a specific condition (e.g., a general user having a user attribute number “1” or a user having a negative evaluation index in FIG. 7A), the predetermined state being for changing the setting of the virtual space provision unit (e.g., when the load on the distribution server 100 exceeds a threshold or when the upper limit number of people that can be associated with a room is reached); and
a second setting change step of, in response to a user who satisfies the specific condition (e.g., a performer or celebrity having a user attribute number “2”, “3”, or “5” or a user having a positive evaluation index in FIG. 7A) entering the virtual space (e.g., entering by logging in or entering a room), executing a process (e.g., steps S303 to S304 in FIG. 18, steps S404 to S406 in FIG. 19) of changing the setting of the virtual space provision unit to the continuous provision state also in a situation where the predetermined state would not be established when a user who does not satisfy the specific condition entered the virtual space (e.g., NO in step S301 in FIG. 18, NO in step S401 in FIG. 19, the load on the distribution server 100 does not exceed a threshold, or the upper limit of the number of people that can be associated with a room is not reached).

This configuration allows the setting of the virtual space provision unit to be changed in advance to the setting of the continuous provision state when a user who satisfies the specific condition enters the virtual space. This allows for countermeasures to be taken in advance for the load that may be caused by a user who satisfies the specific condition entering the space.

(2) In the above (1), the continuous provision state includes increasing resources that function as the virtual space provision unit (e.g., this includes a state in which the distribution server 100 is able to withstand the load and a state in which the user waiting time can be reduced by scaling out the distribution server 100 or scaling up the distribution server 100 in steps S302 and S304 in FIG. 18).

This increases the resources that function as a virtual space provision unit, thereby enhancing the processing capacity of the virtual space provision unit so as to withstand the load, allowing the virtual space to continuously be provided to users.

(3) In the above (2), the process of changing the setting of the virtual space provision unit to the continuous provision state includes a process of increasing the number of resources that function as the virtual space provision unit (e.g., this includes scaling out of the distribution server 100 (increasing the number of servers), and processing in which the server management device 105 in FIG. 16 and FIG. 17 increases the number of servers (e.g., servers 101c, 101d and more) of the login authentication device 101).

This increases the number of resources that function as a virtual space provision unit, thereby enhancing the processing capacity of the virtual space provision unit so as to withstand the load, allowing the virtual space to continuously be provided to users.

(4) In the above (2), the process of changing the setting of the virtual space provision unit to the continuous provision state includes a process of enhancing performance of resources that function as the virtual space provision unit (e.g., this includes scaling up of the distribution server (enhancing the specifications of the CPU and memory of the server).

This increases the performance of resources that function as a virtual space provision unit, thereby enhancing the processing capacity of the virtual space provision unit so as to withstand the load, allowing the virtual space to continuously be provided to users.

(5) In the above (1), the continuous provision state includes decreasing an amount of information to be distributed from the virtual space provision unit to a user terminal of a user so as to provide the user with a virtual space (e.g., this includes the state of being able to withstand the load by decreasing the number of synchronizations between the distribution server 100 and the user terminal, or by decreasing the amount of information itself that is distributed from the distribution server 100 to the user terminal, in steps S402, S403, S405 and S406 in FIG. 19).

This reduces the amount of information distributed from the virtual space provision unit to the user terminal, reducing the processing load on the virtual space provision unit and enabling the server to withstand the load, thus making it possible to continuously provide the virtual space to users.

(6) In the above (5), the process of changing the setting of the virtual space provision unit to the continuous provision state includes a process of, in response to a request from a user terminal, distributing, to the user terminal, request information to decrease an amount of information distributed from the virtual space provision unit (e.g., this includes a process of transmitting information to reduce the frequency of synchronization signal transmitted from a user terminal in steps S402 and S405 in FIG. 19, and a process of transmitting information to reduce the amount of drawing information requested).

This reduces the amount of information requested from a user terminal, and thus reduces the amount of information distributed from the virtual space provision unit to the user terminal, reducing the processing load on the virtual space provision unit and enabling the server to withstand the load, thus making it possible to continuously provide the virtual space to users.

(7) In the above (5), the process of changing the setting of the virtual space provision unit to the continuous provision state includes a process of reducing an amount of information distributed for displaying the virtual space (e.g., this includes a process of reducing the amount of information distributed from the distribution server 100 to the user terminal, in steps S403 and S406 in FIG. 19, and a process of reducing the frequency of synchronizations from the distribution server 100 to the user terminal).

This reduces the amount of display information for displaying the virtual space on the user terminal, reducing the processing load on the virtual space provision unit and enabling the server to withstand the load, thus making it possible to continuously provide the virtual space to users.

(8) In the above (1), the predetermined state includes a state that occurs when load on the virtual space provision unit exceeds a predetermined threshold (e.g., this includes a state where the load on the distribution server 100 exceeds a predetermined threshold).

The load exceeding a predetermined threshold on the virtual space provision unit may cause the possibility that the virtual space cannot be continuously provided to users. To avoid this, this configuration allows the setting of the virtual space provision unit to be changed to a continuous provision state. This allows the virtual space to be continuously provided to users.

(9) In the above (8), the actions by the user include a motion action in the virtual space (e.g., user's movement in the virtual space, and an item use), and
the predetermined state includes a state that occurs when frequency of the motion action increases in the virtual space so that load on the virtual space provision unit exceeds a predetermined threshold.

Due to increased frequency of user's motion actions, the load exceeding a predetermined threshold may be placed on the virtual space provision unit, and this may cause the possibility that the virtual space cannot be continuously provided to users. To avoid this, this configuration allows the setting of the virtual space provision unit to be changed to a continuous provision state. This allows the virtual space to be continuously provided to users.

(10) In the above (8), the predetermined state includes a state that occurs when load on the virtual space provision unit exceeds a predetermined threshold in accordance with the number of users who have entered the virtual space (e.g., this includes a situation where a large number of users make login requests to the virtual space in a short period of time, causing an increased load on a login authentication API server).

Due to the increased number of users entering the virtual space, the load exceeding a predetermined threshold may be placed on the virtual space provision unit, and this may cause the possibility that the virtual space cannot be continuously provided to users. To avoid this, this configuration allows the setting of the virtual space provision unit to be changed to a continuous provision state. This allows the virtual space to be continuously provided to users.

(11) In the above (1), the predetermined state includes a state that occurs when the number of users who have entered the virtual space reaches an upper limit number of users that are allowed to be associated with the virtual space provision unit (e.g., waiting time caused by entry requests from users in number exceeding the number of people allowed in the room).

Due to the number of users entering the virtual space that reaches the upper limit of people allowed in the room, the virtual space may not be continuously provided to users. To avoid this, this configuration allows the setting of the virtual space provision unit to be changed to a continuous provision state. This allows the virtual space to be continuously provided to users.

(12) In the above (1), the specific condition includes a condition that is satisfied when a user who has entered the virtual space is a predetermined special user (e.g., a performer or celebrity with user attribute types of “2,” “3,” or “5” in FIG. 7, a user with whom an increased number of servers is associated in advance, or a user with an evaluation index pre-defined by the administrator (see (User attribute number and evaluation index) in Modification Examples, for example)).

This configuration allows the setting of the virtual space provision unit to be changed to a continuous provision state when a predetermined state occurs in response to a predetermined special user entering the virtual space.

(13) In the above (12), the special user belongs to one of a plurality of types,
the continuous provision state includes a plurality of types of continuous provision states each having a different degree of change defined for each type of the special user, and
the second step executes a process of changing setting of the virtual space provision unit to a continuous provision state with a degree of change corresponding to a type of a special user who has entered the virtual space.

This configuration allows the setting of the virtual space provision unit to be changed to a continuous provision state with a degree of change corresponding to the type of a special user, making it possible to avoid excessive or insufficient provision of the virtual space.

(14) In the above (1), the user has an evaluation value (e.g., evaluation index in FIG. 7A) defined, the evaluation value changing according to external evaluation from other than the user, and
the specific condition includes a condition that is satisfied when a user who has entered the virtual space has the evaluation value that is a predetermined value or higher (e.g., positive value).

This configuration allows the setting of the virtual space provision unit to be changed in advance to a continuous provision state, as in when a predetermined state occurs, in response to a user having an evaluation value of a predetermined value or more entering the virtual space.

(15) In the above (14), the continuous provision state includes a plurality of types of continuous provision states (e.g., an example of increasing the number of servers in accordance with the evaluation indexes in FIG. 8) each having a different degree of change according to an evaluation value of a user who satisfies the specific condition, and
the second step executes a process of changing setting of the virtual space provision unit to a continuous provision state with a degree of change corresponding to the evaluation value of a user who has entered the virtual space.

This configuration allows the setting of the virtual space provision unit to be changed to a continuous provision state with a degree of change corresponding to the evaluation value of a user having an evaluation value of a predetermined value or more, making it possible to avoid excessive or insufficient provision of the virtual space. This enables the virtual space to be continuously provided to users while eliminating wasteful processing in the virtual space provision unit.

(16) In the above (1), the virtual space includes multiple types of virtual spaces (e.g., areas, rooms) each corresponding to a different type of content (e.g., game content, chat-only content) provided in the virtual space, each type of content having a processing load that is variable on the virtual space provision unit, and
the second step performs a process of changing setting of the virtual space provision unit in accordance with a type of virtual space where a user who satisfies the specific condition has entered (see (Setting change process according to content load) in Modification Examples, for example).

This configuration allows the setting of the virtual space provision unit to be changed in accordance with the processing load of the virtual space provision unit providing a different type of content, making it possible to avoid excessive or insufficient provision of the virtual space. This enables the virtual space to be continuously provided to users while eliminating wasteful processing in the virtual space provision unit.

(17) In the above (16), when a user who satisfies the specific condition moves to a different type of space having different processing load in the virtual space, the second step performs a process of changing setting of the virtual space provision unit in accordance with the space after the movement (see (Setting change process according to content load) in Modification Examples, for example).

When a user who satisfies a specific condition moves in the virtual space, this configuration allows the settings of the virtual space provision unit to be changed according to the processing load on the virtual space providing unit for each piece of content, making it possible to avoid excessive or insufficient provision of the virtual space. This enables the virtual space to be continuously provided to users while eliminating wasteful processing in the virtual space provision unit.

(18) In the above (2), the user has an evaluation value defined, the evaluation value changing according to external evaluation from other than the user,
the specific condition includes a condition that is satisfied when a user who has entered the virtual space has the evaluation value that is a predetermined value or higher (e.g., positive evaluation index in FIG. 7A), and
when a first user having a first evaluation value that satisfies the specific condition has already entered a virtual space and then a second user having a second evaluation value that satisfies the specific condition enters the virtual space, a degree of increase in resources is calculated so as to correspond a combined evaluation value based on not only the second evaluation value but also based on the first evaluation value (see (When multiple specific users log in) in Modification Example, for example).

When multiple users whose evaluation values exceed a predetermined value enter the virtual space, this configuration increases the resources with an appropriate degree, making it possible to avoid excessive or insufficient resources. This enables the virtual space to be continuously provided to users while eliminating wasteful processing in the virtual space provision unit.

(19) In the above (5), the user has an evaluation value defined, the evaluation value changing according to external evaluation from other than the user,
the specific condition includes a condition that is satisfied when a user who has entered the virtual space has the evaluation value that is a predetermined value or higher (e.g., positive evaluation index in FIG. 7A), and
when a first user having a first evaluation value that satisfies the specific condition has already entered a virtual space and then a second user having a second evaluation value that satisfies the specific condition enters the virtual space, a degree of decrease in amount of information is calculated so as to correspond a combined evaluation value based on not only the second evaluation value but also based on the first evaluation value (see (When multiple specific users log in) in Modification Examples, for example).

This reduces the amount of information distributed from the virtual space provision unit to the user terminal, reducing the processing load on the virtual space provision unit and enabling the server to withstand the load, thus making it possible to continuously provide the virtual space to users. When multiple users whose evaluation values exceed a predetermined value enter the virtual space, this configuration distributes an appropriate amount of information to the user terminal, thus avoiding increased load due to an excessive amount of information, or decreased user satisfaction due to too little information. This enables the virtual space to be continuously provided to users while eliminating wasteful processing in the virtual space provision unit.

(20) In the above (2), the virtual space provision unit includes a container that is a virtualized server,
the process of changing the setting of the virtual space provision unit includes outputting, to a container management unit that manages execution of the container, a command signal to increase the number of containers executed, and
the continuous provision state includes increasing in the number of containers, thus increasing in an amount of resources of the virtual space provision unit (see (Examples of server) in Modification Examples, for example).

This configuration increases the number of containers, thus enhancing the processing power of the virtual space provision unit to withstand the load, and making it possible to continuously provide the virtual space to users.

(21) In the above (1), entering the virtual space includes logging in to the virtual space.

This configuration allows the setting of the virtual space provision unit to be changed to a continuous provision state when a user who satisfies the specific conditions logs in, thus quickly changing the virtual space provision unit to a state of withstanding the load.

(22) In the above (21),
the virtual space provision unit includes a login information processing unit (e.g., a server corresponding to the login authentication API server, the login authentication device 101 in FIG. 16, and the entry/exit processing unit 134) to authenticate whether a user has successfully logged in, and
the second step includes, when a user who satisfies the specific condition logs into the virtual space, a process of increasing resources of the login information processing unit.

With this configuration, the resources of the login information processing unit are increased, so that even if a load is placed on the login information processing unit due to another user logging in after a user who satisfies the specific condition has logged in, the login information processing unit can be kept in a state of withstanding the load.

(24) A system according to one aspect of the present invention includes a computer configured to control a virtual space provision unit that provides a virtual space to a user, the system including
the computer including a processor and a memory,
the processor being configured to
execute a process of changing setting of the virtual space provision unit to a continuous provision state so that the virtual space is continuously provided to users when it is a predetermined state that is established in response to multiple types of actions including entry into the virtual space by a user who does not satisfy a specific condition, the predetermined state being to change the setting of the virtual space provision unit; and
in response to an entering of the virtual space among actions by a user who satisfies the specific condition, execute a process of changing the setting of the virtual space provision unit to the continuous provision state, also in a situation where the predetermined state would not be established when a user who does not satisfy the specific condition entered the virtual space.

This configuration allows the setting of the virtual space provision unit to be changed in advance to the setting of the continuous provision state when a user who satisfies the specific condition enters the virtual space. This allows for countermeasures to be taken in advance for the load that may be caused by a user who satisfies the specific condition entering the space.

### BRIEF DESCRIPTION OF DRAWINGS

FIG. 1 shows an example of a hardware configuration of a communication system.

FIG. 2 explains the concept of an overall image of the virtual space provided by a distribution server.

FIG. 3 describes the configuration of the distribution server.

FIG. 4 describes the configuration of an administrator terminal.

FIG. 5 describes the configuration of a specific user information media management server.

FIG. 6 describes the configuration of a user terminal (user terminal and distribution user terminal) in detail.

FIG. 7A, FIG. 7B, and FIG. 7C show an example of user information stored in a storage unit of the distribution server.

FIG. 8 shows an example of the relationship between user evaluation indexes and servers, which is stored in the storage unit of the distribution server.

FIG. 9A, FIG. 9B, and FIG. 9C show examples of the screen on a user terminal when entering a virtual space in the present embodiment.

FIG. 10A and FIG. 10B show one example of a notification screen to user terminal in the present embodiment.

FIG. 11 shows another example of a notification screen to user terminal in the present embodiment.

FIG. 12 is a flowchart showing an example of the entry notification process by the distribution server in the present embodiment.

FIG. 13 is a flowchart showing an example of the entry notification process by the specific user information media management server in the present embodiment.

FIG. 14 is a flowchart showing another example of the entry notification process by the distribution server in the present embodiment.

FIG. 15 is a flowchart showing another example of the entry notification process by the distribution server in the present embodiment.

FIG. 16 shows one example of the system configuration of the distribution server in the present embodiment.

FIG. 17 shows one example of the system configuration of the distribution server in the present embodiment.

FIG. 18 is a flowchart showing an example of the virtual space providing server expansion process in the present embodiment.

FIG. 19 is a flowchart showing an example of the distribution information amount change process in the present embodiment.

### DETAILED DESCRIPTION

The following is an overview of the present invention. In this embodiment, a virtual space (metaverse space) is used by multiple users. The multiple users are broadly divided into specific users (also called special users), and other users. For instance, specific users include performers, celebrities, and others. These performers and others may have their fans. If the fans could quickly obtain information that performers and others have entered a virtual space and follow them and enter the same virtual space, their fan activities would become more fulfilling. This embodiment therefore is configured to, when a specific user has entered the virtual space, notify other users of the entry. This allows fan activities of the fan users who support the specific user to be more fulfilling.

When a specific user has entered a virtual space, this may lead to an increase in the number of other users entering the space. In this way, the entry behavior of a specific user may increase the load on the distribution server that provides the virtual space to users. Then, this embodiment makes it possible to change the resources of the server providing the virtual space in advance on the condition that a specific user has entered (including logged in) the virtual space. This embodiment also makes it possible to decrease (reduce) the amount of information distributed from the distribution server that provides the virtual space to user terminals on the condition that a specific user has entered the virtual space. These processes of changing the resources of the server and decreasing the amount of information allow the distribution server to withstand the increased load that is assumed when a specific user enters the virtual space. In this way, measures for the load on the distribution server are taken in advance. This enables a smooth process to let users enter when they attempt to enter the virtual space while following a specific user, and also enables a smooth distribution process, thereby improving user satisfaction.

The following describes embodiments of a communication system according to the present invention, with reference to the drawings. The present invention is not limited to the following examples, and is defined by the claims. All modifications within the meaning and scope equivalent to the claims are intended to be included in the present invention. In the following descriptions, like reference numerals designate like parts throughout the descriptions of drawings to omit their duplicated descriptions.

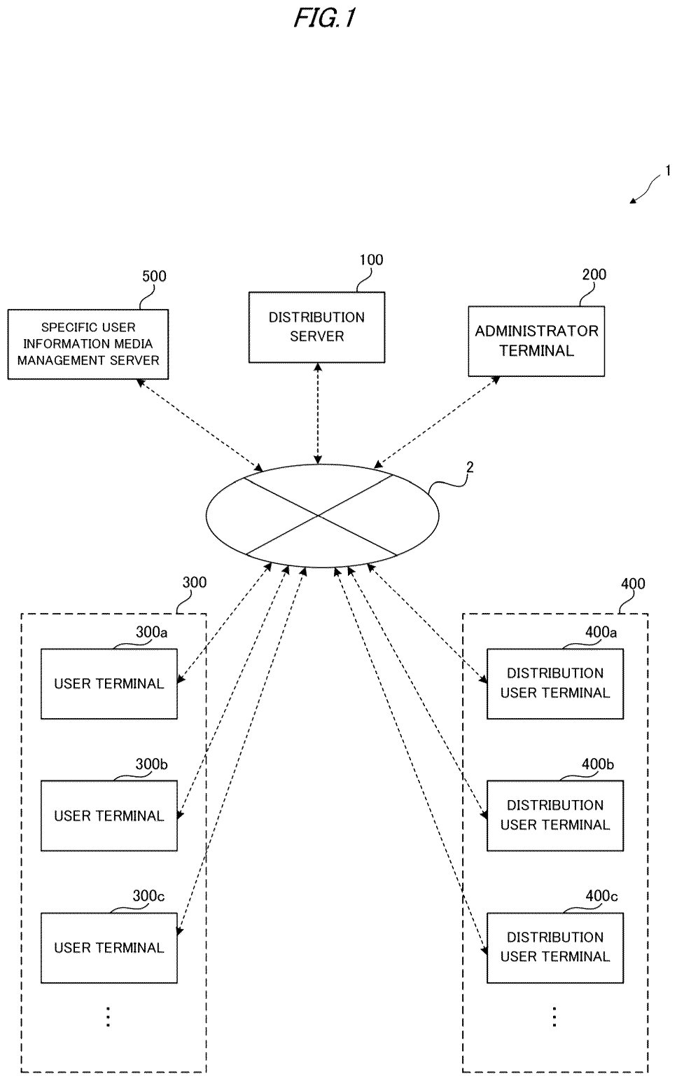

FIG. 1 shows an example of a hardware configuration of a communication system 1. The communication system 1 includes a distribution server 100, an administrator terminal 200, a plurality of user terminals 300a, 300b, 300c . . . , a plurality of distribution user terminals 400a, 400b, 400c, and a specific user information media management server 500. Each of the plurality of user terminals 300a, 300b, 300c, . . . are owned by one of a plurality of users, and they are hereinafter collectively referred to as a user terminal 300. Each of the plurality of distribution user terminals 400a, 400b, 400c, . . . are owned by one of a plurality of distribution users who are able to distribute content independently, and they are hereinafter collectively referred to as a distribution user terminal 400. Both the user terminal 300 and the distribution user terminal 400 are used by a user. They will hereinafter be referred to collectively as user terminals.

The distribution server 100, the administrator terminal 200, the user terminals 300, the distribution user terminals 400, and the specific user information media management server 500 are connectable for communication via a network 2, and are able to transmit and receive information (data) in both directions. The network 2 is the internet, for example, and includes local area network (LAN), wide area network (WAN), mobile communication network (e.g., 5G and wireless network), wired telephone network, fiber to the home (FTTH), cable television (CATV) network, and other access networks.

For instance, the distribution server 100 is a computer such as a workstation or a personal computer having a communication function. The distribution server 100 manages multiple virtual spaces (also called metaverse spaces), which are virtual worlds constructed over a computer, and provides services (content) using the virtual space selected by a user via the network 2.

In this embodiment, a user is allowed to participate in a virtual space provided by the distribution server 100 in response to an operation with the user terminal, and to perform activities, actions, statements, and others via a user character, for example. The users in this embodiment also include general consumers, performers and celebrities. For instance, performers include talented people from various genres, such as performers belonging to the service provider (operating company), entertainers, actors, comedians, multi-talented people, emcees, anchorpersons, singers, musicians, models, and other influencers. For instance, celebrities include famous company executives or employees, athletes, e-sports players, famous scholars and cultured persons, cram school tutors, famous students, and other famous people of various genres. These users are determined to be an influencer and processed as such based on the number of followers in a follow function in a virtual space provided by the distribution server 100.

The content provided using a virtual space is managed and configured according to the type of content. The content that can be provided includes, but is not limited to, content that allows users to watch or experience games, live performances, live events, programs, and others, and content that allows users to interact and communicate with each other using chats and emotes. A user accesses the distribution server 100 using the user terminal 300 or the distribution user terminal 400 and selects desired content, thereby seamlessly participating in (navigating) the content and being able to view and experience the virtual space corresponding to the content.

In accordance with the type of content, a virtual space may include a three-dimensional space (space constructed on the basis of three-dimensional data) generated by computer graphics (CG) or a two-dimensional space (space constructed on the basis of two-dimensional data). The virtual space also provides a virtual character (avatar object), an object showing backgrounds and virtual objects according to the type of content, a menu object selectable by the user, and others. The virtual character placed in the virtual space includes a user character that is preset corresponding to each user participating in the virtual space and is operable in response to operations from the user, and a non-player character that operates according to a program.

An object to be placed in the virtual space includes: for game content, an item object corresponding to the game, a character object corresponding to the game, and a user character (hereinafter also called a user avatar) of a user playing the game content that are placed on a field object corresponding to the game field; and for live content, a stage object, an audience seat object and a lighting object, a user character of the performer performing as the emcee of the live performance on the stage object, and user characters of participating users that are placed on the audience seat object. For content that lets users communicate with each other, the objects placed include a user character for each of the multiple users participating and an item object that can be used for communication. Other objects may include a space modeled after a city, and be not only the one that allows communication between users. For instance, objects such as signs and bulletin boards may be placed, allowing users to obtain and view information both inside and outside the virtual space.

The distribution server 100 stores, in its storage unit 120, information for displaying images in a plurality of virtual spaces corresponding to the distributable content on a user terminal, and sound information for outputting sound. In response to an access from a user terminal, the distribution server 100 distributes content data that includes display information for displaying images in the virtual space of the corresponding content and sound information for outputting sound, thus providing the content (service) to the user.

For instance, the content data includes: information for specifying information relating to an object placed within the virtual space (e.g., the type of object, placement position, orientation, posture, and appearance); information relating to the user character of each user participating in the virtual space (e.g., the type of user character, placement position, orientation, posture, appearance, motion data, and audio data); an object indicating backgrounds or virtual objects according to the type of content; and information for specifying menu objects selected by the user. For the information on objects and user characters, the amount of the information displayed may be increased or decreased by the data distribution unit 132 of the distribution server 100, or by any setting operation by the user on the user terminal. For instance, an increase or decrease in the amount of displayed information may include an increase or decrease in the number of user avatars that can be displayed in the virtual space, an increase or decrease in the number of objects, or an increase or decrease in image resolution.

An object in the virtual space may change in the posture, position, expression, and others in response to operations through a user terminal, and the appearance of an object placed may change over time. Therefore, the content data is distributed at predetermined intervals (e.g., every 0.016 seconds, which is about 60 fps), enabling images in the virtual space that change from moment to moment to be displayed on the user terminal. The content data distributed at predetermined intervals may be distributed in response to the distribution server 100 receiving a signal requesting a synchronization transmitted from a user terminal, and the timing of the distribution at predetermined intervals may be varied with the load on the distribution server 100. For instance, as the load becomes heavier, the number of synchronizations per second may decrease gradually from 6 to 3 and 1, for example. The distribution server 100 may transmit information (request information) to a user terminal so that the user terminal performs a process to reduce the frequency at which a signal requesting synchronizations is transmitted. Even if the user terminal issues a request for content data, the interval at which the distribution server 100 responds to the request may become longer as the load increases.

The distribution server 100 also manages programs and data that enable the progression (play) of a live event, a game, and other content on a user terminal, for example. For instance, when game content is selected by a user, the distribution server 100 distributes, to the user terminal, a program and data for providing a service using the virtual space of that game content. The timing of distribution of the program and data for progressing the content from the distribution server 100 is not limited to when the content is selected by the user, but may be when the user logs into the distribution server 100 or when a specified achievement condition is met.

The administrator terminal 200 is used by an administrator of a service provider, for example. For instance, the administrator terminal 200 is a computer with operation input and communication functions, such as a personal computer. The administrator creates, configures, modifies, and updates the content and images in the virtual space to be managed in the storage unit 120 of the distribution server 100 via the administrator terminal 200. For instance, the administrator creates and configures new content and images in a virtual space, and changes and modifies existing content and images in a virtual space. The administrator also sets and updates the information to be managed in the storage unit 120 of the distribution server 100 via the administrator terminal 200. For instance, the administrator sets and updates the evaluation index (evaluation value) and attributes (e.g., attribute type, attribute number) associated with each user in the user information to be managed in the storage unit 120 of the distribution server 100. The administrator terminal 200 may also create, configure, modify, and update the content to be managed in a storage unit 520 of the specific user information media management server 500. The administrator sets and updates the information to be managed in the storage unit 520 of the specific user information media management server 500 via the administrator terminal 200.

For instance, the specific user information media management server 500 is a computer such as a workstation or a personal computer having a communication function. The specific user information medium is a fan community application (app) related to a specific user (such as a performer) or a website where information related to the specific user is viewable. The administrator (subject) who operates the specific user information medium may be the same as the administrator or operator of the distribution server 100 or the administrator terminal 200, or may be a different person. For instance, the specific user information media management server 500 may manage a plurality of pieces of content that can be provided to users and manage the community in which the content is provided. The specific user information media management server 500 provides such content in response to a request from a user via the network 2.

The content provided by the specific user information media management server 500 is managed and configured by type. The content informs the viewer of certain type of information, and includes information such as video, audio, and text. The certain type of information includes information on a specific user. For instance, the information on a specific user managed by the specific user information media management server 500 includes news and announcements by the administrator (manager), user posts, posted information such as streaming videos related to the specific user provided by external web services, obtained by using a Web API, schedule information for streaming videos related to the specific user, and information on the trends of the specific user including information on the specific user's entry and exit into the virtual space. Such content is displayed on the user's terminal via a medium such as a web browser or a dedicated application on a smartphone, for example, thus the user is allowed to view it.

The specific user information media management server 500 stores, in its storage unit 520, information for displaying, on the user terminal, text and images corresponding to content that can be provided to users, and sound information for outputting sound. In response to an access from a user terminal, the distribution server 100 distributes content data that includes display information for displaying corresponding text and images and sound information for outputting sound, thus providing the content (service) to the user.

In this embodiment, the distribution server 100, the administrator terminal 200, and the specific user information media management server 500 are each independent computers (devices). In another embodiment, they may be implemented by one computer, or the functions of one of these computers (e.g. the distribution server 100, the specific user information media management server 500) may be implemented by multiple computers (e.g., multiple servers).

The user terminal 300 is used by a user who views and experiences content. For instance, the user terminal 300 is a computer with operation input and communication functions, such as a personal computer, a tablet terminal, and a smartphone. Like the distribution user terminal 400 described later, the user terminal 300 may have a motion capture function to capture user actions.

The user terminal 300 communicates with the distribution server 100 and the specific user information media management server 500 in response to an operation with the terminal to receive content data of the content selected by the user. The user terminal 300 configures, in the storage area of the user terminal 300, a virtual space for the content selected by the user from among the virtual spaces configured in the distribution server 100 on the basis of the content data received from the distribution server 100, and displays images in the virtual space and outputs sound. This allows the user to view and experience the virtual space of the content via the user terminal 300.

The user terminal 300 configures, in the storage area of the user terminal 300, information on the content selected by the user from among the multiple pieces of content (e.g., announcements and schedule information) managed by the specific user information media management server 500 on the basis of the content data received from the specific user information media management server 500, and displays images and text of the content. This allows the user to identify and recognize the information of content (including information on the specific user) via the user terminal 300.

The user terminal 300 also accepts operations on the displayed virtual space and objects, various icon selection operations, content selection operations, text input operations, and other operations. The user terminal 300 transmits information in accordance with the operation with the terminal to the distribution server 100 to operate and move their user character within the virtual space of the content in which the user is participating. The movement of the user character, for example, may be reflected (synchronized) also in the virtual space at each of the user terminals 300 of users participating in the same content, on the basis of the content data transmitted from the distribution server 100 at predetermined time intervals as described above.

While the user terminal 300 enables the user to view and experience the virtual space of content, it also allows the user to post a comment including any message that is an example of action for the virtual space of content where the user is participating in response to an operation with the user terminal. After posting of the comment, such a comment may be reflected on each user terminal 300 so that the users participating in the comment are allowed to check such a comment.

The user terminal 300 stores programs and data distributed from the distribution server 100 when a user selects content, and displays a virtual space corresponding to the selected content in accordance with the programs and data and enables progress (playing) of the content. For instance, if a user selects Area Y, a space simulating a town, on the title screen of the user terminal, the user terminal 300 receives and stores data including a program for displaying the space of Area Y, and displays the space of Area Y on the display unit on the basis of the data. If a user selects certain game content within the virtual space of any of the areas (or the area itself may be a space that provides game content), the user terminal receives and stores data including a program for playing that game content, so that the user is allowed to play the game content.

The distribution user terminal 400 is used by a distribution user who is able to distribute content. In addition to the operation input and communication functions, the distribution user terminal 400 has a motion capture function to capture the actions of a distribution user (e.g., a head-mounted device (HMD), a device equipped with an image capturing device to analyze user actions from images taken of the user by the image capturing device). In this case, the user wears the HMD on the head, for example, and holds a controller that is communicable with the HMD with a hand. Then, when the user moves the head or hand or operates buttons of the controller, this enables the operation of the displayed virtual space and virtual characters.

The distribution user terminal 400 may acquire motion information to identify the head or hand movements of the distribution user and controller operations, and audio information to identify the voice of the distribution user and transmits it to the distribution server 100 to reflect the user character's movements and voice in the participating virtual space. This allows the distribution user terminal to operate the user character of the distribution user in the virtual space as if it were the avatar of the user. The movement and voice of the user character, for example, may be reflected (synchronized) in the virtual space at each of the user terminals 300 of users (including the distribution user) participating in the virtual space, on the basis of the content data transmitted from the distribution server 100 at predetermined time intervals as described above.

Note that the distribution user may be a general user (just a viewer or participant) who views or experiences the distributed content using the user terminal 300 with the same configuration as the distribution user terminal 400, or may be a general user using the user terminal 300 with a configuration different from the distribution user terminal 400. The distribution user terminal 400 and the user terminal 300 may be terminals having the same configuration or may be terminals having different configurations. A distribution user may participate in a virtual space as a distributor who distributes content, or as a general user (just a viewer/participant), not as a distributor. Therefore, a distribution user is included in users. A distribution user is allowed to select or change which position they are in, for example, at a specific timing (e.g., when logging in, when starting content distribution, when displaying the user character of the distribution user in the content to be distributed).

### <Overall Image of Virtual Space>

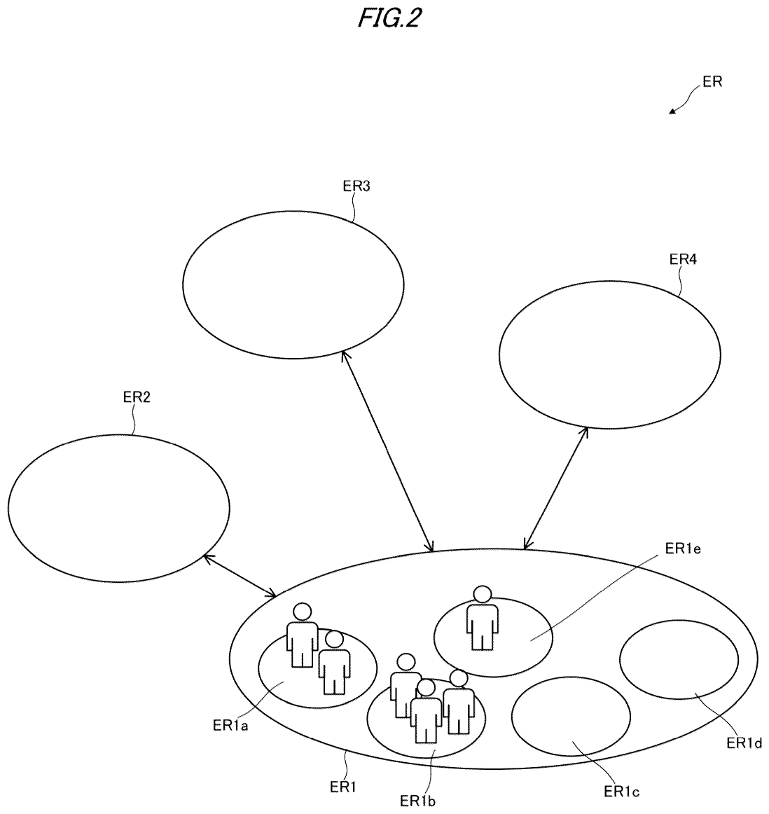

FIG. 2 explains the concept of an overall image of the virtual space provided by the system 1 of this embodiment. Virtual space ER in this embodiment includes a plurality of types of spatial areas ER (spatial area ER1, spatial area ER2, . . . ). In each spatial area ER, content of different genres and types may be provided. These different types of spatial areas ER include an entrance that is an area selected by a user from a title screen displayed after the logging-in to the virtual space ER, and other areas corresponding to various types of content, such as live performance venues, game content, and exhibition halls. For instance, an event venue where live content is held is constructed entirely in a given spatial area ER, or in part of a given spatial area ER.

Each spatial area ER has multiple rooms where the same content is provided. Each room has a fixed maximum number of people that can be admitted to the room, e.g., 200 people. These rooms are managed by a real-time synchronization server, for example. Users in the same room are able to see each other's user avatars and communicate with each other. For instance, they are able to play games together and have conversations through chat. For instance, let that the spatial area ER1 is a space simulating a town. Then, in rooms ER1a, ER1b, . . . corresponding to the spatial area ER1, a space simulating the same town will be provided to the users, and the only avatars that are displayable in the space are the user avatars corresponding to the users associated with the same room. For instance, user avatar 1 of the user associated with room ER1a is not displayed on the user screen of the user associated with room ER1b. However, exceptionally, user avatars of special users (e.g., of performers) may be displayed also in other rooms, not only in the room they are actually in.

Once a user logs into the virtual space, they may be required to enter a spatial area ER first defined as an area (e.g., entrance) that provides special content, and only after that, they may move from one spatial area to another spatial area. Alternatively, they may be allowed to move back and forth between spatial areas ER without entering the defined spatial area. For instance, a user may not be allowed to move from spatial area ER2 to spatial area ER3 without passing through spatial area ER1, or they may be allowed to move directly between spatial area ER2 and spatial area ER3 without passing through spatial area ER1. When moving between spatial areas ER, a switching effect may be performed. For instance, when moving to another spatial area ER, the display screen may be switched to a darkened screen (e.g., displaying a black screen with a message such as “Loading . . . ”). For user access to each spatial area ER, the user may be required to first enter the entrance area after logging in, or the user may be able to select and enter the spatial area ER of their choice without passing through the entrance area, or the user may transition to a spatial area ER that is randomly determined by lottery. For each room, the user may choose a room of their choice to enter, or they may enter a room randomly determined by lottery. Hereinafter, the virtual space ER will also be referred to simply as the virtual space.

In this embodiment, entering a virtual space includes logging in to the virtual space and entering a room.

### <Configuration of Distribution Server>

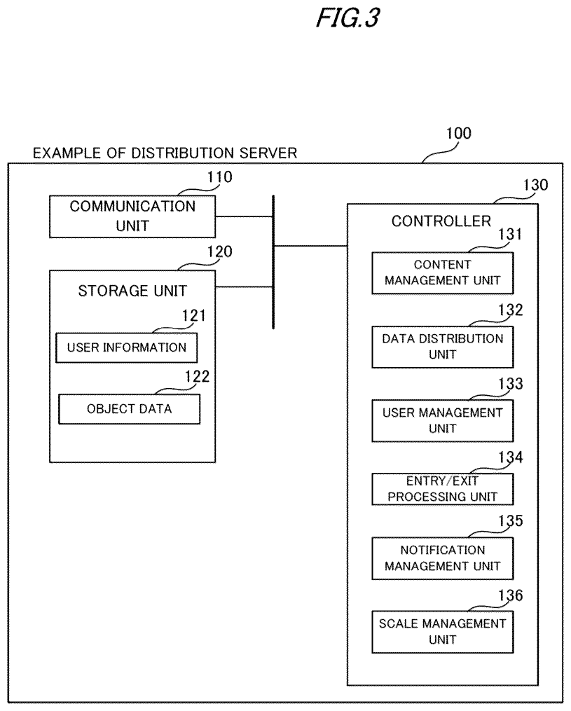

Next the following describes the configuration of the distribution server 100. As shown in FIG. 3, the distribution server 100 includes a communication unit 110 that communicates with other computers, a storage unit 120 that stores various data, and a controller 130 that controls the entire computer. These communication unit 110, storage unit 120, and controller 130 are connected to each other by a bus line. The server may be a virtualized server having its function defined as a server (container) to be implemented as a server.

The communication unit 110 is a communication interface including a network interface card controller (NIC) for performing wired or wireless communication. The communication unit 110 communicates with other computers via the network 2. For instance, the communication unit 110 functions as an interface that allows another computer to obtain part of the information stored in the storage unit 120 (e.g., the entry and exit status of each user into the virtual space, an evaluation index, and an attribute number).

The storage unit 120 includes a random access memory (RAM), a read only memory (ROM), a flash memory or a hard disk drive (HDD). The storage unit 120 stores programs for executing various control processes (e.g., programs for managing and providing content using a virtual space), various data, and others. The various data stored in the storage unit 120 includes information for specifying an image of a virtual space provided for each type of content, and user information 121 relating to a user. The information for specifying an image of the virtual space includes object data 122, for example.

The controller 130 includes a central processing unit (CPU). The controller 130 executes the programs stored in the storage unit 120 to control the overall operation of the distribution server 100 and perform various calculations.

The following describes a functional configuration of the controller 130. The controller 130 functions as at least a content management unit 131, a data distribution unit 132, a user management unit 133, an entry/exit processing unit 134, a notification management unit 135, and a scale management unit 136. These various functions may be performed by separate servers, or multiple functions may be performed on one server (e.g., a virtual server), for example.

The content management unit 131 stores and updates, via the communication unit 110, information for specifying an image in a virtual space corresponding to the content set by the administrator terminal 200 in the storage unit 120. The content management unit 131 stores: in the storage unit 120, information for specifying the type of content set by the administrator terminal 200; information for specifying an image in the virtual space for each content; and information for specifying the date and time of distribution for content such as live performances and programs to be distributed at a predetermined date and time, for example. The information for specifying an image in the virtual space includes information on objects placed in the virtual space, user characters corresponding to users participating in the virtual space, and others. The information for specifying the type of content includes information for specifying an area in the virtual space that can be provided to the user, information about a live event that is to be held, and others.

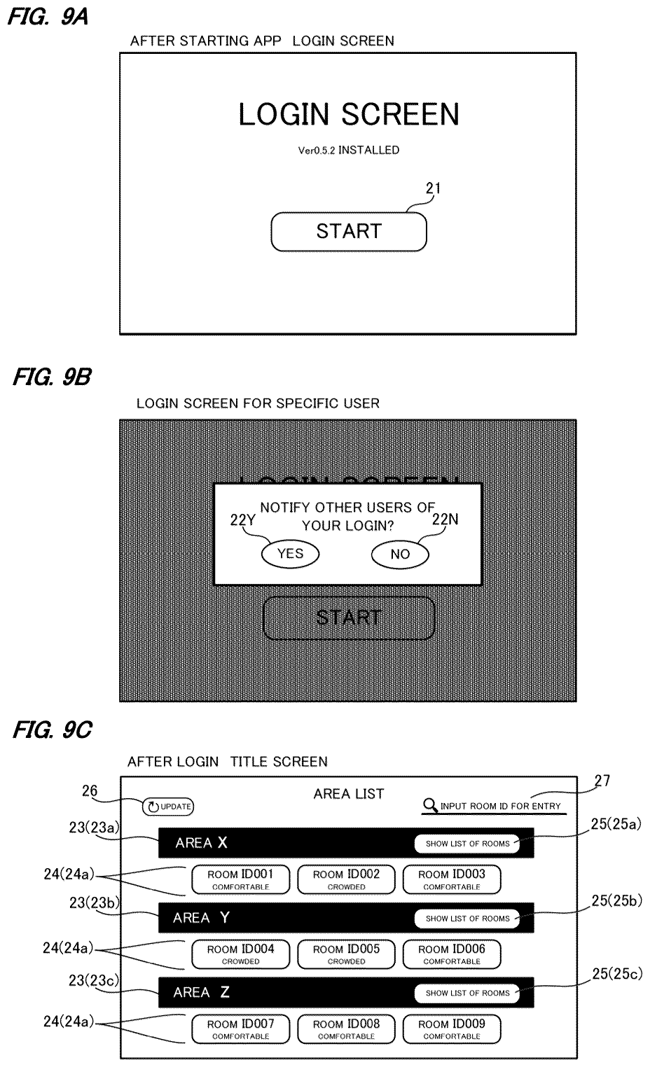

The content management unit 131 also performs processing for providing content and a room to a user and associating them with the user in response to a request from the user terminal via the communication unit 110. For instance, in response to an acquisition request for content information from the user terminal 300, the content management unit 131 transmits information for specifying, in the user terminal, content information that can be provided to the user. For example, it is information relating to an area and a room in the virtual space. Based on this content information, the display unit of the user terminal 300 is able to display areas X to Z and the rooms corresponding to each area on the title screen as shown in FIG. 9C. The content management unit 131 performs a process of having the area selected by the user and the room ID associated and stored as user information 121.

The data distribution unit 132 distributes content data to the user terminal, from which the access originated, at predetermined time intervals, where the content data is for displaying images in the virtual space of the content selected with each terminal and managed by the content management unit 131. When manual operation is performed by the administrator with the administrator terminal 200 or when preset conditions are met, the data distribution unit 132 performs an information amount change process, such as increasing or decreasing the resolution of the texture of an image displayed on the user terminal, increasing or decreasing the number of objects that are displayable, or changing the frequency of synchronizations with the user terminal. For instance, when the computer resource usage rate exceeds a predetermined threshold due to heavy server load (e.g., when it exceeds a certain threshold by referring to the current metrics or the metrics for the past few times), or when a condition set assuming heavy server load is met (e.g., a specific user logs in), it performs the process of decreasing (reducing) the amount of information (amount of data) for displaying and outputting the virtual space that can be distributed to a user terminal via the communication unit 110.

The process of decreasing (reducing) the amount of information to a user terminal by the data distribution unit 132 includes: reducing the amount of information itself transmitted from the data distribution unit 132 to a user terminal and then distributing it; reducing the frequency of synchronization from the data distribution unit 132 to a user terminal; or transmitting a signal from the data distribution unit 132 to a user terminal to cause the user terminal to reduce the amount of information itself requested from the distribution server 100. For instance, when the number of users entering the virtual space increases, causing the virtual space to become crowded and the load to become heavy, the data distribution unit 132 may transmit congestion information to the user terminals. When a user terminal receives this congestion information, it may perform a setting to reduce the amount of information requested from the distribution server 100 (e.g., by a program stored in the storage unit of the user terminal), thereby making it possible to reduce the amount of information distributed in response to a request from the user terminal. For instance, the size of information itself such as image resolution may be reduced, or the number of times that the user terminal transmits a signal requesting synchronization to the distribution server 100 may be reduced, whereby the overall amount of information distributed to the user terminal may be reduced. The congestion information may be transmitted when the entire virtual space becomes congested, or it may be transmitted when the room in which the user is present becomes congested (when the maximum number of people in the room is reached, or when a certain number of people is reached before reaching the maximum number of people).

The user management unit 133 stores and updates user information relating to users in the storage unit 120. For instance, the user information is stored as user information 121 in a database. The user information relating to a user includes an ID for identifying the user, the user name, an evaluation index and attribute number for each user, and information on the entry and exit status of each user into the virtual space. The evaluation index and attribute number may be values determined in advance by the administrator, or may be variable with the user's behavior, the number of followers in social media or in the virtual space, for example. The information on the entry and exit status into the virtual space for each user includes entry and exit information for logging in and out of the virtual space, and entry and exit information that identifies the area and room that the user is in. For instance, the information identifies that the user is currently in room ID 001 in which area X is provided. The user management unit 133 also obtains the user's behavior history in the virtual space and stores it in the storage unit 120. The behavior history includes position information in the virtual space, and participated content history (participated event history). The user management unit 133 may calculate the degree of relationship with other users (e.g., the degree of intimacy or the amount of social tipping to other users) based on the behavioral history, and associate the user with other users.

The entry/exit processing unit 134 performs processing for a user to enter and exit a virtual space in response to an access from the user terminal via the communication unit 110. The user entry detected by the entry/exit processing unit 134 includes logging into the virtual space and entering a room in the virtual space after logging in. For instance, it includes a function to detect user login using a login authentication API server, and a function to manage the user room entry and exit information using a user authentication unit of a real-time synchronization server. Note that the login authentication API server may authenticate that a user has logged in based on the distribution server 100 receiving the information indicating that the user has successfully logged in using another authentication system. When the entry/exit processing unit 134 detects a user entering the virtual space (including logging in), the controller 130 may perform a process related to changing the server settings and notifying (announcing to) other users.

When the entry/exit processing unit 134 detects that a user has entered (logged in) the virtual space, the notification management unit 135 issues a notification (announcement) via the communication unit 110 so that other users, including the administrator, are notified of the entry if the user who entered is a specific user who meets predetermined conditions. A user may select, with the user terminal, whether or not to notify other users of their entry. In this case, when the user has selected not to notify other users (i.e., the user has not selected to notify other users), even if a specific user who meets the predetermined conditions has entered the virtual space, the notification management unit 135 controls so that other users are not notified.

Notification modes via the communication unit 110 include: notification (announcement) to the administrator terminal 200 operated by the administrator; notification to a user terminal via a notification function (e.g., push notification) of an app for displaying a virtual space provided by the distribution server 100 or a community app managed by the specific user information media management server 500; or notification to other users by making information regarding the entry status (e.g., as information regarding a specific user) downloadable in response to a request (viewing request) from the user. In this way, information regarding entry status is made downloadable in response to a user request (viewing request). This allows a WEB page (which may be a specific page within the app) capable of displaying a list of users' entry status to display information if any information is obtainable so that another computer can obtain the entry status of a specific user using an API, or allows a bulletin board object to display the user's entry status so that users can check the user's entry status in the virtual space.

A viewing request is made from a user terminal to the distribution server 100 or the specific user information media management server 500 for information to display a web page (or a specific page within an app (e.g., a community app)) or a specific image within a virtual space (e.g., information displayed on a bulletin board object) on the user terminal. For instance, a viewing request is made (transmitted) from the user terminal to the server by accessing a specific web page, selecting a specific icon within an app, or selecting a specific object within a virtual space (or moving to a specific location). Also, the information on the user's room entry status may be updated and stored in the storage unit 120 so that the information can be downloaded in response to a request from the user. For instance, the information is updated as information for a specific user. In the following description, a spontaneous notification from the server to the user regardless of whether or not a viewing request has been made by the user may also be referred to as a notification (e.g., a push notification).

The scale management unit 136 performs a process of increasing or decreasing the resources of the distribution server 100 (scaling). The process of increasing or decreasing the resources includes: scale-out, which is horizontal scaling of resources to increase the number of servers (also referred to as increasing the number of resources); scale-up, which is vertical scaling of resources to increase the CPU and memory performance of a server; scale-in, which is reducing the number of servers; and scale-down, which is decreasing the performance of a server. This resource increase/decrease process is executed in response to a manual operation by the administrator with the administrator terminal 200 or when predetermined conditions are met. For instance, when the computer resource usage rate exceeds a predetermined threshold due to heavy server load (e.g., when it exceeds a certain threshold by referring to the current metrics or the metrics for the past few times), or when a condition set assuming heavy server load is met (e.g., a specific user logs in), the resource increase/decrease process is performed.

A maximum number of people may be set for a room (the number of users that can be associated with one room). In this case, the resource increase/decrease process may increase the resources to increase the number of rooms when the maximum number of people in a room is reached due to a user entering the room (e.g., when the maximum number of people is reached, or when a predetermined number of people is reached before reaching the maximum number). For instance, one room may be defined for one server. In this case, the number of servers may be increased, or multiple rooms may be defined for one server, and a process to increase the processing performance of one server may be performed to allow the resources to handle an increase in rooms. A server as the distribution server 100 may be configured to perform load balancing processing at any time, together with the scaling.

Servers whose scale is managed by the scale management unit 136 include: a login authentication API server that functions as the entry/exit processing unit 134; a lobby API server that functions as the content management unit 131 that allows users to obtain information such as a list of areas and rooms, or a server corresponding to a room. Note that one room may be defined for one server, but multiple rooms may be defined for one server.

### <Configuration of Administrator Terminal>

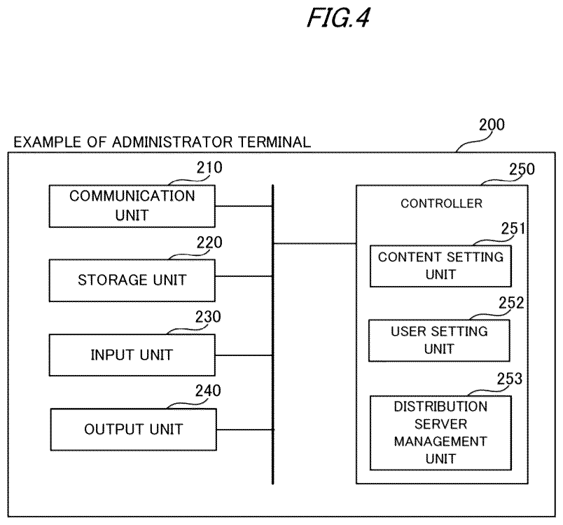

Next the following describes the configuration of the administrator terminal 200. As shown in FIG. 4, the administrator terminal 200 includes a communication unit 210 that communicates with other computers, a storage unit 220 that stores various data, an input unit 230 for inputting operations, an output unit 240 for outputting images and audio, and a controller 250 that controls the entire computer. These communication unit 210, storage unit 220, input unit 230, output unit 240, and controller 250 are connected to each other by a bus line.

The communication unit 210 is a communication interface including a NIC for performing wired or wireless communication. The communication unit 210 mainly communicates with the distribution server 100 and the specific user information media management server 500 via the network 2. The storage unit 220 includes a RAM and a ROM. The storage unit 220 stores programs for executing various control processes (e.g., programs for managing content using a virtual space), various data, and others.

The input unit 230 includes an input device (e.g., a touch panel, a touch pad, a pointing device such as a mouse, and a keyboard) for receiving input operations from the administrator. The output unit 240 includes an output device (e.g., display, speaker) for presenting information to the administrator.

The controller 250 includes a CPU. The controller 250 executes programs stored in the storage unit 220 to control the overall operation of the administrator terminal 200.

The following describes a functional configuration of the controller 250. The controller 250 functions as at least a content setting unit 251, a user setting unit 252, and a distribution server management unit 253.

The content setting unit 251 stores and updates information about the content and virtual space that is managed by the content management unit 131 of the distribution server 100 in response to operations with the administrator terminal 200. This allows information for specifying content, information for specifying an image within the virtual space for each content, and information for setting and specifying information that specifies the date and time of distribution to be stored and updated in the storage unit 120. The information that the content setting unit 251 stores and updates in the storage unit 120 may be set for each area and room.

The content setting unit 251 stores and updates information about the content that is managed by the content management unit 531 of the specific user information media management server 500 in response to an operation with the administrator terminal 200. This allows information for setting and specifying the information (e.g., announcements on a specific user and their trends information) that specifies the content to be stored and updated in the storage unit 520.

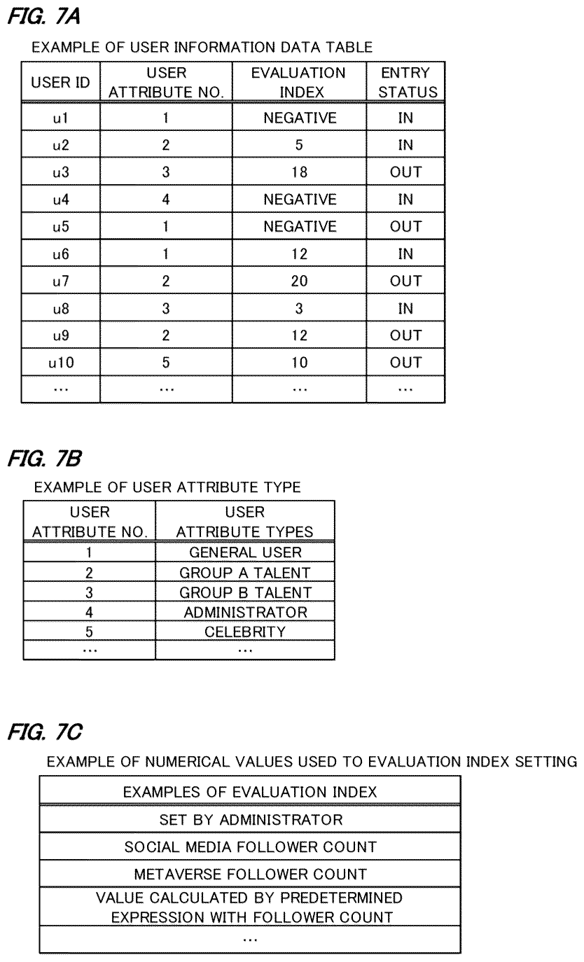

The user setting unit 252 sets user information about a user that is managed by the user management unit 134 of the distribution server 100 or the user management unit 533 of the specific user information media management server 500 in response to an operation with the administrator terminal 200. The setting of the user information includes setting of an evaluation index for each user. The setting of evaluation index includes: the setting of evaluation index for each user as shown in FIGS. 7A, 7B and 7C described below, the setting of the calculation criteria for the evaluation index, and the setting of the attribute number and type for each user. For instance, an administrator who operates the administrator terminal 200 may assign and change an attribute number in advance to a specific user so that general users can be distinguished from the specific users who are different from the general users. For instance, specific users include performers, celebrities, and others. For instance, a performer who is the target of support in a fan community app is a specific user, and fan users who support the specific user in the community are general users.

The distribution server management unit 253 performs a process of making settings related to the scaling of the distribution server 100 and settings related to the amount of information distributed from the distribution server 100 to user terminals. For instance, it stores and updates a program for the resource increase/decrease process (scaling) in the scale management section 136, and a program for the information amount change process to increase/decrease the resolution and number of objects to display the virtual space distributed by the data distribution unit 132 of the distribution server 100 in the storage unit 120. It also stores and updates the conditions for a specific user, which are included in the conditions for changing the settings for the information amount change process and the scale of the distribution server 100 in the storage unit 120.

### <Configuration of Specific User Information Media Management Server>

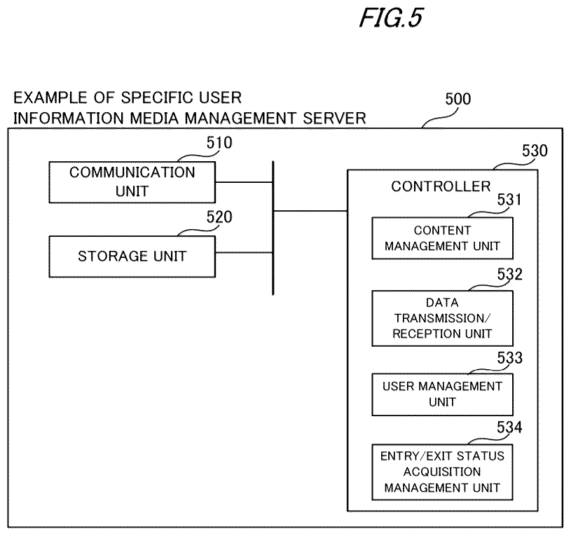

Next the following describes the configuration of the specific user information media management server 500. As shown in FIG. 5, the specific user information media management server 500 includes a communication unit 510 that communicates with other computers, a storage unit 520 that stores various data, and a controller 530 that controls the entire computer. These communication unit 510, storage unit 520, and controller 530 are connected to each other by a bus line. The server may be a virtualized server having its function defined as a server (container) to be implemented as a server.

The communication unit 510 is a communication interface including a network interface card controller (NIC) for performing wired or wireless communication. The communication unit 510 communicates with other computers via the network 2.

The storage unit 520 includes a random access memory (RAM), a read only memory (ROM), a flash memory or a hard disk drive (HDD). The storage unit 520 stores programs for executing various control processes (e.g., programs for managing and providing content), various data, and others. The various data stored in the storage unit 520 includes posting information and trend information provided for each type of content, and user information relating to a user. The information relating to a user includes the user's ID in the specific user information medium, an attribute number for each user, an evaluation index, information for specifying a specific user that the user has previously selected (this may be referred to as selecting as a favorite user), and the user ID of the user information 122 stored in the storage unit 120 of the distribution server 100. For instance, a user ID in the distribution server 100 may be associated with a user ID in the specific user information media management server 500 for the same user, on the basis of the information about a user stored in the storage unit 520. Note that the same ID may be used for the user ID in the distribution server 100 and the user ID on the specific user information media management server 500.

The controller 530 includes a central processing unit (CPU). The controller 530 executes programs stored in the storage unit 520 to control the overall operation of the specific user information media management server 500.

The following describes a functional configuration of the controller 530. The controller 530 functions as at least a content management unit 531, a data transmission/reception unit 532, a user management unit 533, and an entry/exit status acquisition management unit 534.

The content management unit 531 stores and updates, via the communication unit 510, information for specifying text and an image corresponding to the content posted by the administrator terminal 200 or a user terminal in the storage unit 520. For instance, the content management unit 531 stores, in the storage unit 520, information on attributes (e.g., a group to which a specific user belongs, or the specific user itself) that can be associated with content to be provided to a user. The content management unit 531 stores and updates, in the storage unit 520, information for specifying the information such as the category and poster of the content posted with the administrator terminal 200 or a user terminal, and attributes associated with each piece of content.

The data transmission/reception unit 532 receives various types of information transmitted from a user terminal, and transmits (distributes) various types of information to the user terminal via the communication unit 510. The data transmission/reception unit 532 refers to various management tables stored in the storage unit 520 and distributes data to the user terminal. Alternatively, the data transmission/reception unit 532 distributes data stored in another computer as a result of calling an API via the communication unit 510 by the entry/exit status acquisition unit 534, for example, so that the data is viewable on the user terminal. The various types of information transmitted and received by the data transmission/reception unit 532 includes: information regarding the content managed in the content management unit 531; various notification information; and information based on the user information 122 stored in the storage unit 120 of the distribution server 100. The transmission of various types of information includes: push notifications (including desktop notifications), in-app notifications; and distribution of information about a specific user, such as entry and exit information into a virtual space provided by the distribution server 100, in response to a request from a user terminal, which is information about a specific user. Push notifications may be transmitted only when permission has been given in advance (set to ON) with the user terminal.

The entry/exit status acquisition management unit 534 acquires information about users who are in the virtual space provided by the distribution server 100 via the communication unit 510, and causes the data transmission/reception unit 532 to distribute the entry/exit information of a specific user into the virtual space to a user terminal. It may receive user information from the distribution server 100 and stores it in the storage unit 520 of the specific user information media management server 500, or it may acquire the result of calling the API of the user entry/exit status of the distribution server 100. Based on the user information acquired by the entry/exit status acquisition management unit 534 and the user information (including information for determining a specific user) stored in the storage unit 520 of the specific user information media management server 500, if a specific user has entered the virtual space, it may cause the data transmission/reception unit 532 to notify the user terminal of the information that the specific user has entered the virtual space.

### <Configuration of User Terminal>

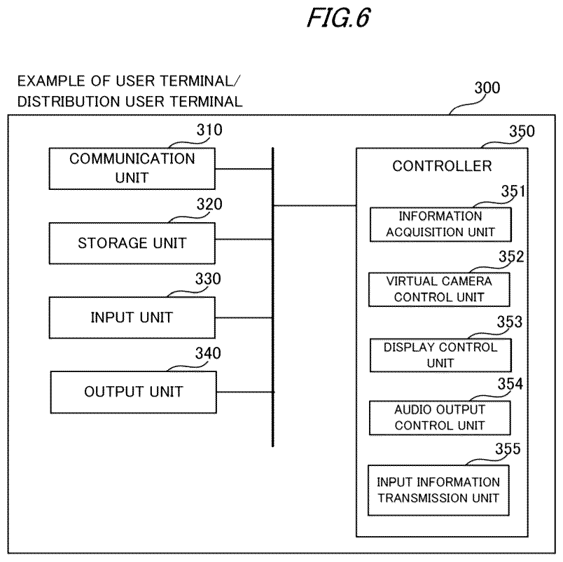

Next, the following describes the configuration of a user terminal (user terminal 300 or distribution user terminal 400) in detail. As shown in FIG. 6, a user terminal includes a communication unit 310 that communicates with other computers including the distribution server 100, a storage unit 320 that stores various data, an input unit 330 for inputting operations, an output unit 340 for outputting images and others, and a controller 350 that controls the entire computer. These communication unit 310, storage unit 320, input unit 330, output unit 340, and controller 350 are connected to each other by a bus line.

The communication unit 310 is a communication interface including a NIC for performing wired or wireless communication. The communication unit 310 communicates with other computers including the distribution server 100 and the specific user information media management server 500 via the network 2. The storage unit 320 includes a RAM and a ROM. The storage unit 320 stores programs for executing various control processes (e.g., programs for viewing content using a virtual space, and programs for distributing content using a virtual space in a distribution user terminal via the distribution server 100), various data, and others.

The input unit 330 includes an input device (e.g., a touch panel, a touch pad, a pointing device such as a mouse, a keyboard, and microphone) for receiving input operations and sounds from a user. The distribution user terminal 400 includes an input device such as an HMD with a motion capture function and includes a motion input unit that is an input unit 330 to acquire user motions as motion information. In this way, the distribution user terminal 400 used by a distribution user for content distribution has different hardware and functions from the user terminal 300 used for participation as a general user. In this embodiment, a user operation refers to an operation performed by the user with the input unit 330. For example, the operation includes touch operation, slide operation, flick operation on a touch panel, button operation, drag (swipe) operation, operation on icons displayed on the display unit of the user terminal 300, operation with a pointing device or keyboard, and voice input into a microphone.

The output unit 340 includes an output device (e.g., display unit such as display, or speaker) for presenting and outputting information (text, images, sounds and others) to a user. The controller 350 includes a CPU. The controller 350 executes programs stored in the storage unit 320 to control the overall operation of the user terminal 300.

The following describes a functional configuration of the controller 350. The controller 350 functions as an information acquisition unit 351, a virtual camera controller 352, a display controller 353, an audio output controller 354, and an input information transmission unit 355.

The information acquisition unit 351 acquires content data, comment information, and others from the distribution server 100 via the communication unit 310, and stores in the storage unit 320 information for displaying an image in a virtual space in which various objects are placed based on the content data, and also stores in the storage unit 320 information for displaying comments posted based on the comment information. It also acquires content data and others from the specific user information media management server 500, and stores in the storage unit 320 information for displaying text and images (posted information, trend information, and others) relating to the content based on the content data.

The virtual camera control unit 352 controls a virtual camera that is placed in the virtual space stored in the storage unit 320 and specifies a region (visible region) of an image in the virtual space to be displayed on the user terminal 300. The virtual camera control unit 352 controls the position, orientation, inclination, and others of the virtual camera in response to an operation with the input unit 330.

The display control unit 353 displays on a display unit (such as a display) an image corresponding to the visible region, which is the field of view from the virtual camera, in the virtual space stored in the storage unit 320, on the basis of the content data acquired by the information acquisition unit 351. In other words, the user can change the position, orientation, inclination and others of the virtual camera placed in the virtual space in response to operations with the input section 330, so that the user terminal 300 displays an image within the visible region of the virtual camera among images in the virtual space for viewing. The image data displayed by the display control unit 353 may have its resolution setting and the amount of object data displayed changeable by any user setting with the input unit 330. The display control unit also displays content information (e.g., headlines of articles about the content) related to the content stored in the storage unit 320, which is based on the content data acquired by the information acquisition unit 351 from the specific user information media management server 500, so that the user can view it. For instance, it causes the user terminal 300 to display headlines of the distribution schedule of a specific user such as a performer, so that the user can recognize that the content is a distribution schedule related to the performer.

This embodiment describes an example where information for displaying images in a virtual space based on content data is stored in the storage unit 320, a virtual camera is placed in the virtual space stored in this storage unit 320, and the visible region displayed on the user terminal 300 is changed by controlling the virtual camera. The present invention is not limited to this. For instance, the user's virtual camera may be placed in the virtual space stored in the storage unit 120 of the distribution server 100, and the virtual camera control unit 352 may be used to control the virtual camera to change the visible region of the virtual camera. Then data to specify an image in the visible region may be received and displayed on the user terminal 300.

The display control unit 353 causes the display unit (such as a display) to display the history of posted comments stored in the storage unit 320 based on the comment information acquired by the information acquisition unit 351. The audio output control unit 354 causes an audio output unit (e.g., speaker) to output sounds on the basis of the content data acquired by the information acquisition unit 351.

The display control unit 353 displays user interface (UI) images (including a menu image selectable by the user and an operation image that accept operations) corresponding to the content being distributed on the basis of the program stored in the storage unit 320. In this embodiment, different UI images may be displayed on a user terminal 300, which is used for participation as a general user, and on a distribution user terminal 400, which is used by a distribution user for content distribution. For instance, a UI image for posting a comment may be displayed on the user terminal 300 (when the program is executed for viewing/experience), but not displayed on the distribution user terminal 400 (when the program is executed for content distribution), which mainly communicates by sounds. The menu items required between during viewing/experiencing and during content distribution are different. Thus, the UI image for selecting a menu may differ between the user terminal 300 (when executing a program for viewing/experiencing) and the distribution user terminal 400 (when executing a program for content distribution).

The input information transmission unit 355 transmits the audio information, operation input information, and others acquired by the input unit 330 to the distribution server 100. The operation input information includes various types of information, such as information on the user's entry and exit into the virtual space, operation information for specifying operations on objects in the displayed virtual space and on the user characters placed in the virtual space (including motion information acquired by the motion input unit 260 (such as an HMD)). The information on the user's entry and exit into the virtual space includes the user's login information (login request to the virtual space), logout information, area of each virtual space, and room movement.

### <Overview of the Relationship Between Specific User and Server Process>

In this embodiment, in response to a specific user entering a virtual space, the distribution server 100 performs an entry notification process for notifying other users that the specific user has entered the virtual space. The distribution server 100 also performs, in response to a specific user entering the virtual space, a setting change process to change the settings of the resources of the distribution server 100 (also referred to as a virtual space provision unit) and the amount of information to be distributed to user terminals to provide a virtual space.

### <Types of Users in Virtual Space>

(Example of Data Table about Users)

Referring to FIG. 7, the following describes a user to whom the virtual space in this embodiment is provided, as well as a specific user who may influence the behavior of other users. FIG. 7A is an example of a data table about users stored in the user information 121 of the distribution server 100. Each user is associated with a “user ID” (u1, u2, u3, . . . ), a “user attribute number,” an “evaluation index,” and an “entry status.” In this embodiment, the distribution server 100 determines whether or not the user is a specific user on the basis of the user's “user attribute number” or “evaluation index,” and performs the processes to change the settings of the distribution server 100 and to notify other users of the information about the user's entry.

The “entry status” is associated with the entry status of each user into the virtual space. For instance, if a user is logged in to the virtual space, “In” is associated with them, and if a user is logged out, “Out” is associated with them. A user may also be associated with which room they are currently in (e.g., area, room ID).

FIG. 7B explains an example of the types of “user attribute numbers”. The “user attribute” is an identification ID for sorting users according to attribute type. For instance, a user who is a general user is assigned a user attribute number “1.” If a user is a performer (this may be called a “talent”), they may be further categorized by the group to which they belong. A performer belonging to group A is assigned a user attribute number “2,” and a performer belonging to group B is assigned a user attribute number “3.” The administrator who manages and administers the virtual space is assigned a user attribute number “4”. Other celebrities, such as persons who are considered influential in the virtual space, are assigned a user attribute number “5”. These attribute type items are managed in the administrator terminal 200, for example, and the administrator who operates the administrator terminal 200 may add or change these items as needed. Special privileges may be granted in the virtual space according to the attribute type of user.

The specific user in this embodiment has a user attribute type of a performer or celebrity. A user who is a performer or celebrity is assigned the user attribute number “2,” “3,” or “5.” Therefore, when a user associated with the user attribute number “2,” “3,” or “5” enters the virtual space, it is considered that a specific user has entered the virtual space.

For instance, user IDs “u1”, “u5”, and “u6” in FIG. 7A are not considered specific users because their attribute number is “1” and their attribute type is general user. User ID “u4” is not considered a specific user because their attribute number is “4” and their attribute type is administrator. User IDs “u2” and “u7” are considered a specific user because their attribute number is “2” and their attribute type is a performer belonging to group A. User IDs “u3” and “u8” are considered a specific user because their attribute number is “3” and their attribute type is a performer belonging to group B. User ID “u10” is considered a specific user because their attribute number is “5” and their attribute type is a celebrity.

FIG. 7C is an example of the numerical values used to set the “evaluation index.” The evaluation index is a numerical value that varies according to external evaluations, which are evaluations from someone other than the user themselves. For instance, the numerical value may be set in advance by the administrator, or it may be a value corresponding to the number of followers on social media that is different from the virtual space. A mutual follow function may be provided within the virtual space (metaverse space) in this embodiment, and the value may correspond to the number of followers in the metaverse space. For instance, when game content is provided within a virtual space, a follow function for the game content may be provided. Then, the value may be the number of game followers in the virtual space. The number of followers may be a value that is an index of popularity, such as the number of registration as a favorite. A users with a predetermined number of followers or more is treated as a specific user (such as influencer) who has influence over other users. For instance, different processes may be performed according to the actual number of followers.

Alternatively, the “evaluation index” may be a value calculated using a predetermined mathematical expression for a given index of popularity, such as the number of followers. For instance, an evaluation index may be determined using a predetermined calculation expression based on the number of followers, and a user who achieves a positive value using the calculation expression may be regarded as a specific user. The predetermined calculation expression may be, for example, “[number of followers−1000000]/prescribed value=evaluation index (may be rounded up to the first decimal place)”, but is not limited to this.

The evaluation index in FIG. 7A is an example in which it is determined using a predetermined calculation expression for a value that is an index of popularity. User IDs “u1”, “u4”, and “u5” are not considered specific users because their evaluation index is negative. User IDs “u2” and “u3” are considered specific users because their evaluation index is positive. Even if a user is not considered to be a specific user based on either the above-mentioned user attribute number or the evaluation index, they may be considered to be a specific user based on one of them. In this case, the distribution server 100 treats the user as a specific user and performs a process accordingly. For instance, user ID “u6” is a general user with a user attribute number of “1”. This user, however, is processed as a specific user because the user is high in-game popularity in the metaverse and the evaluation index is a positive value.

### (Relationship Between Evaluation Index and Server Expansion)

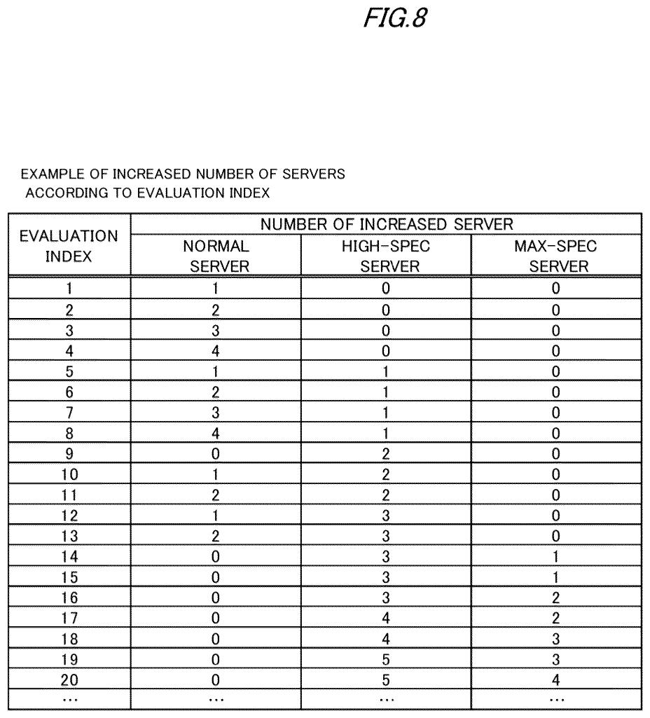

In this embodiment, the setting change process of the distribution server 100 may be configured to execute a different process for each specific user. FIG. 8 is an example of a setting change process for the distribution server 100, showing the number of servers to be increased for each evaluation index when a scale-out process is performed to increase the number of servers in response to a specific user entering a virtual space. As shown in FIG. 8, there are multiple types of servers with different processing capacities. They include a normal server, a high-spec server having higher performance than the normal server, and a maximum spec server having even higher performance than the high-spec server. The number of these servers to be increased is predetermined according to the evaluation index. For instance, when user ID “u2” in FIG. 7A logs in, having the evaluation index of 5, then one normal server and one high-spec server are added. When user ID “u7” logs in, having the evaluation index of 20, then five high-spec servers and four maximum spec servers are added. When scale-up is performed in the setting change process, the scale-up stage for increasing the resource performance (the specification values of the CPU and memory) may be varied according to the evaluation index for each user.

The amount of resources (number of servers or the specification values of CPU and memory) may be defined for each attribute number. In this case, the setting change process is performed according to the predetermined resource amount for each attribute number. For instance, if the user's attribute number is “2”, the number of servers may be increased by 5, and if the user's attribute number is “5”, the number of servers may be increased by 3. Even for the same attribute type, multiple attribute numbers may be provided according to the resource amount to be changed. For instance, for performers having the same type, “performer in group A” in FIG. 7B, their attribute numbers may be set as in “2”, “6” and “7” according to the number of servers to be increased. Then, if a performer from group A with attribute number of “2” enters the space, the number of servers may be increased by three; if a performer from group A with attribute number of “6” enters the space, the number of servers may be increased by five; and if a performer from group A with attribute number of “7” enters the space, the number of servers may be increased by ten.

### <Example of Display Screen on User Terminal>

Referring to FIG. 9A through FIG. 11, the following describes an example of display screen on user terminal in this embodiment. FIGS. 9A, 9B and 9C are an example of a screen displayed on a user terminal when a user enters a virtual space. FIG. 9A shows a login screen that appears after an application for displaying a virtual space provided by the distribution server 100 is activated. Applications for displaying a virtual space include a web app that runs on a web browser, a desktop app, and a smartphone app. Hereinafter, these may be referred to as apps or various apps. When START icon 21 in FIG. 9A is selected, login request information is transmitted from the user terminal to the distribution server 100. If the user who transmitted the login request information is a specific user, the distribution server 100 determines that the user who made the login request is a specific user based on the login request information, and performs a process to display the screen of FIG. 9B.

FIG. 9B is a screen that allows the user to select whether or not to notify other users of their login. For instance, when the user selects a “Yes” icon 22Y or a “No” icon 22N displayed together with a message “Notify other users of your login?”, then information as to whether or not to notify (hereinafter called notification permission information) is transmitted to the distribution server 100. For instance, when the “Yes” icon 22Y is selected, the notification management unit 135 performs a process of notifying other users of the login on the basis of the notification permission information. When the “No” icon 22N is selected, even if the user logs in to the virtual space, the notification management unit 135 does not notify other users of the login on the basis of the notification permission information.

FIG. 9C is an example of a title screen that is displayed after the login authentication process for the virtual space has been completed. Once the login authentication process for virtual space has been performed for a user by the entry/exit processing unit 134, an area list is displayed on the user terminal, where the area list corresponds to each content and may be provided by the content management unit 131. On the title screen, an area bar 23, a room icon display area 24, a room list display icon 25, an update icon 26, a room ID input area 27, and others are displayed.

The area bar 23 is to display to indicate the areas (content) that can be currently provided to the user by the content management unit 131. In FIG. 9C, area bars 23a to 23c indicate that areas X to Z are available, respectively.

The room icon display area 24 displays icons of rooms in the area that is available and displayed by the area bar 23 to let the users enter the rooms. A user may select a room icon displayed in these room icon display areas 24, and is allowed to enter the room so that each area is provided to the user within the room. FIG. 9C shows a room icon display area 24a for the rooms in which area X is provided, a room icon display area 24b for the rooms in which area Y is provided, and a room icon display area 24c for the rooms in which area Z is provided. In this manner, a user may select a room icon for any room to enter the room.

Each room icon displayed in the room icon display area 24 may have a room ID, and may be displayed in a manner that allows users to understand the status of rooms, including “comfortable,” “crowded,” or “full” in accordance with the degree of congestion (e.g., number of users in the room). The entry status of a specific user, a follow user, or a friend user (whether or not they are in) also may be displayed. For instance, the user may be able to understand the congestion level based on text information, face mark icons (e.g., a smiling face indicates comfortable, a sad face indicates congestion), and changes in color patterns, for example. The entry status of a specific user, a follow user, and a friend user may be displayed in a manner that allows the user to specify who is in the room. Alternatively or in addition to this, an icon indicating that a friend is in the room may be displayed without displaying who is in the room.

In FIG. 9C, the room icon display area 24a, in which the rooms in area X are displayed, displays a room with a room ID 001, a room with a room ID 002, and a room with a room ID 003. It also shows that the congestion status of room ID 001 is “comfortable,” while the congestion status of room ID 002 is “crowded.” “Comfortable” means that there is still some room until the room's maximum capacity is reached, “crowded” means that there is not much room left before the room's maximum capacity is reached (e.g., the maximum capacity is reached with 10 people), and “full” means that the maximum capacity has been reached and no new users can enter the room.

In response to selection of a room icon, a confirmation pop-up screen before entering the room may be displayed. For instance, along with a message such as “Do you want to enter the room?”, the user may be able to choose to enter or cancel it. For instance, only the room IDs may be displayed in the room icon display area 24, and other information such as congestion information may be displayed on the pop-up screen.

The room list display icon 25 is for displaying all icons of the rooms for entering the area displayed by the area bar 23, when the icon is selected. Even if there are still rooms that are not displayed in the room icon display area 24, pressing this icon will display all the rooms. For instance, although six rooms are available in area X, the number of rooms displayed on one screen is reduced for reasons of the layout of the display screen (e.g., to reduce the number of rooms to be displayed and increase the number of areas displayed on one screen), or while the priority of displaying rooms on the room icon display area 24 that are full and cannot be entered or are crowded may be lowered, and the priority of not-crowdy, comfortable rooms may be raised. Also in these cases, pressing this icon enables displaying all the rooms. In FIG. 9C, the room list display icons 25a to 25c are displayed corresponding to the area bars 23a to 23c, respectively.

The update icon 26 is an icon that, when selected, transmits a request to the distribution server 100 to reacquire the list data of areas and rooms that can be entered and to refresh (reload) the title screen. This updates the rooms displayed in the room icon display area 24, for example.

The room ID input area 27 is a search area in which a user is allowed to directly input a room ID to display the room. For instance, a user may know the ID of a room in which a friend user is in. In this case, the user can directly input the room ID in the room ID input area 27 to directly specify the room and attempt to enter it. For instance, when the user inputs the room ID, a confirmation pop-up screen before entering the room, which is displayed when the room icon is selected, may be displayed.

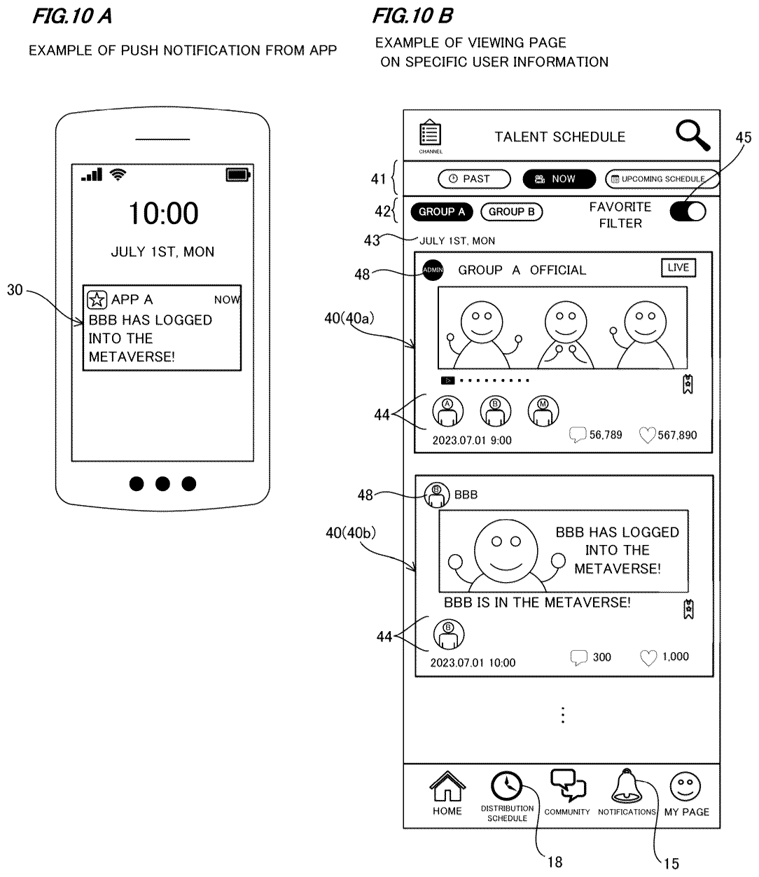

FIGS. 10A and 10B are an example of a display screen of a user terminal, and this is an example of a display screen for push notification by an app downloaded to the user terminal and a predetermined page within the app. The following describes an example of smartphone screen, which may be the screen of another computer device. The app downloaded to the user terminal is the one that provides the virtual space provided by the distribution server 100 on the user terminal (app that allows the user to enter the virtual space by opening the app) and the one that is managed by the specific user information media management server 500. In the following, an example will be described in which performer BBB corresponds to user ID “u2” in FIG. 7A.

FIG. 10A is an example of a screen when a push notification is made on a user terminal to notify that a specific user has entered the virtual space. The push notification screen 30 displays a message such as “BBB has logged into the metaverse!”, notifying the user that performer BBB has logged into the virtual space. The push notification screen may also show the area or room ID that a specific user has entered (e.g., as in “BBB has entered room ID 0001!”). Push notifications may also be configurable on the user side to turn notifications on or off. Therefore, if the user has set push notifications to be turned off (has not given permission), the push notification screen will not be displayed on the user terminal.

FIG. 10B is an example of a display screen of a fan community app that is provided to users by the specific user information media management server 500, where performer BBB is included in the performers to be supported. FIG. 10B is a page where information about a specific user can be viewed. For instance, this is a page where the schedule regarding the performer can be viewed, including past (e.g., most recent), current, and future video distributions and trends. This page on which a performer schedule can be viewed displays a period selection area 41, a group selection area 42, a date and time area 43, a content heading 40, an account 48, related performer 44, a favorite filter 45, and others. Also, at the bottom of the screen, a schedule icon 18, a notification icon 15 are displayed. In this community app, a performer's schedule screen may be displayed by selecting the schedule icon 18. By selecting the notification icon 15, the user may check a list of notifications transmitted by push notification in FIG. 10A.

The favorite filter 45 is an icon that, when a user has selected and stored a favorite performer in advance in a fan community (e.g., in the storage unit 520 or the storage unit 320), extracts and displays only the information of the favorite performer (favorite) that has been selected and stored in advance, in response to the selection.

In the period selection area 41, icons of periods such as “past”, “now”, and “upcoming schedule” are displayed. When “past” icon is selected, the performer's most recent video distribution history and the history of entry into the virtual space (history of logged out) are displayed. When the “now” icon is selected, information such as the currently streaming video and the current entry status into the virtual space will be displayed. When the “upcoming schedule” is selected, upcoming distributions and schedules for entering the virtual space will be displayed. The schedule of live events (e.g., live performances) in the virtual space related to the specific user may be displayed, and the area and room ID where the specific user entered may be displayed. For instance, when the “now” icon is selected, information about a currently on-going live event in the virtual space where the performer is appearing is displayed.

Performers may be classified by the group to which they belong. In this case, the group selection area 42 displays icons that display information for each group to which performers belong. The content heading 40 separates the display area into individual pieces of content (e.g., distributions and entry information to a virtual space). The account 48 displayed in the content heading 40 displays icons such as a video distribution channel account and a user account in a virtual space. The related performers 44 displayed in the content heading 40 displays performers related to the content displayed in the each of the content headings 40 in association with the content heading 40. For instance, this shows the icon of the performer appearing in the distributed video (e.g., the collaborator) or the icon of the performer who entered the virtual space. In this way, the performers are associated with each piece of content. Thus, by selecting the favorite filter 45, only the content with which the pre-selected performer is associated as the related performers can be extracted and displayed. The related performer is automatically associated based on the poster's operation when posting the content or creating the content heading 40, or based on information acquired via an API, for example.

Also, in the push notification shown in FIG. 10A, only the entry information of the favorite performer that the user has selected and stored in advance may be transmitted as a push notification. The information to identify a specific user (performer) selected and stored by the user in advance is stored in the storage unit 520 of the specific user information media management server 500, for example. The specific user information media management server 500 distributes information that identifies a pre-selected user by the user (information that identifies whether the user has been selected or not), along with information that includes information about other specific users, for each user. The user terminal receives the information distributed from the specific user information media management server 500 and performs a process of extracting the pre-selected specific user. This makes it possible to display information relating to the pre-selected user (e.g., information about a favorite performer extracted when the favorite filter 45 is on).

In FIG. 10B, the “now” icon is selected in the period selection area 41, group A is selected in the group selection area 42, and the favorite filter 45 is turned on. Therefore, information relating to the current group A, in which the performers selected and stored in advance by the user are associated as related performers, is extracted and displayed. For instance, FIG. 10B is an example screen of a user who has previously selected and stored performer BBB as the favorite. Therefore, the screen shows content heading 40a, which displays the content of the streaming video associated with performer BBB, and content heading 40b, which is the entry information into the virtual space on performer BBB. An image portion of each content heading 40 may be selected to transition the screen to another screen. For instance, when the image of the content heading 40a is selected, a transition to a video being distributed (e.g., a video distribution on an external web service) may occur, and when the image of the content heading 40b is selected, a transition to a virtual space may occur. For instance, a virtual space app may be activated and a login screen may appear, or the user may be able to transition to a room in which the performer is currently located. When a performer logs out, information indicating the logout may be displayed together with the past distribution history in the history information displayed by a past icon that allows past information to be viewed, rather than by the now tab. Alternatively, the display itself may be removed from the list. That is, the content heading 40 itself may be deleted.

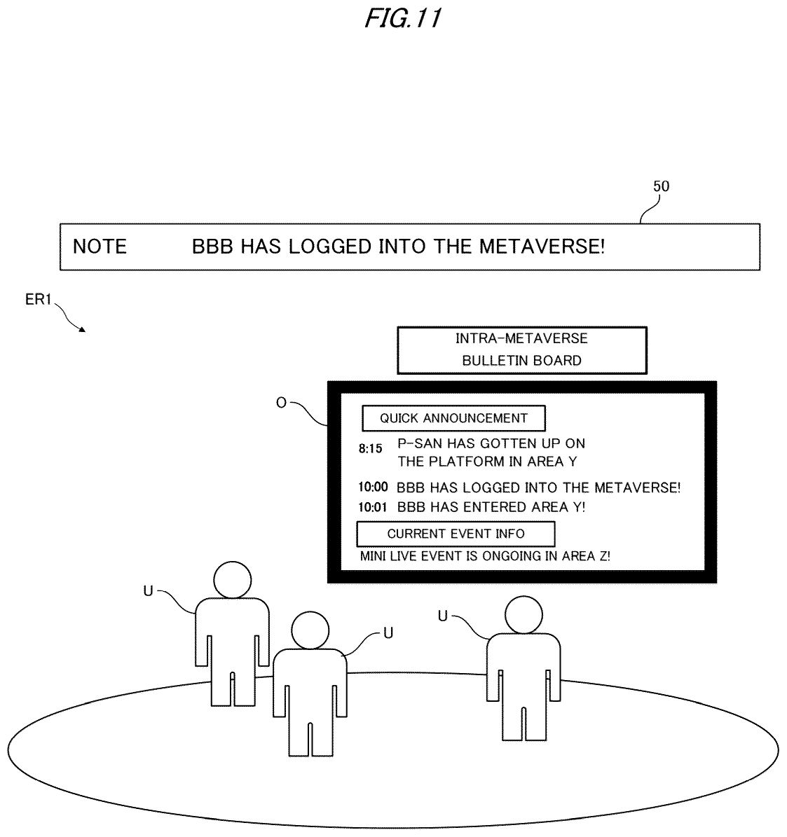

FIG. 11 is an example of an image of the virtual space displayed on a user terminal and provided by the distribution server 100. For instance, this is an example of the screen that is displayed when a desktop app, a smartphone app, or a web browser is launched, for example. FIG. 11 is a display image in the room corresponding to spatial area ER1, where the entrance space (entrance content) is provided. At the entrance, a bulletin board object O is displayed, which allows a user to view information within the virtual space (metaverse). Based on the information stored in the storage unit 120, the bulletin board object O displays information about a specific user, live event information, various other news, quick announcement, and others. Examples of the information about a specific user include information on the name of a specific user who entered the virtual space (e.g., logged in), the time, and the area entered.

The bulletin board object O in FIG. 11 displays quick announcement and current live event information. For the quick announcement, the messages are displayed “BBB has logged into the metaverse!” at 10:00 and, “BBB has entered Area Y!” at 10:01. This displays the information that a specific user, performer BBB, has logged into the virtual space, as well as which area of the virtual space they entered. Other examples of information indicating special actions taken by users within the virtual space include the quick announcement at 8:15, “P-san has got up on the platform in Area Y!”, and current live event information, “Mini live event is ongoing in area Z!.”

A user who is in the room is displayed as a user avatar U, and by operating the user avatar U, the user is able to move within the virtual space, and change the viewpoint. An image in the virtual space may be a bird's-eye view of the user avatar U as illustrated in FIG. 11, or it may be an image viewed from the perspective of the user avatar U without displaying the user avatar U operated by the user themselves. The bulletin board object O may be configured to pop-up as a large image in the bulletin board on the screen of the user terminal or to be displayed on the entire screen when the user selects the bulletin board object O while bringing the user avatar U close to it.

This allows the user to move to a location of the bulletin board in the virtual space and obtain display information on the bulletin board from the distribution server 100 when they want to obtain information about the specific user and view information about the specific user. That is, the user is able to acquire information on a specific user in response to their request. In FIG. 10B, a page that displays information (e.g., schedule) about a performer who is the target of support in a fan community app may display information about the entry of a user who is not a performer and the actions that the user takes in the virtual space, if the user (e.g., a celebrity in FIG. 7B) meets certain conditions.

The information on a specific user is not limited to being displayed as an image in a virtual space, and this may be notified (announced) within the app, such as an in-app notification bar 50 in FIG. 11. The in-app notification bar 50 displays the message “BBB has logged into the metaverse!” as an announcement. This information about BBB login in the in-app notification bar 50 and in the bulletin board object O becomes displayable by the entry/exit processing unit 134 performing the login authentication processing for BBB (e.g., a specific user of user “u2”) and the notification management unit 135 performing a distribution process.

### (Entry Notification Process)

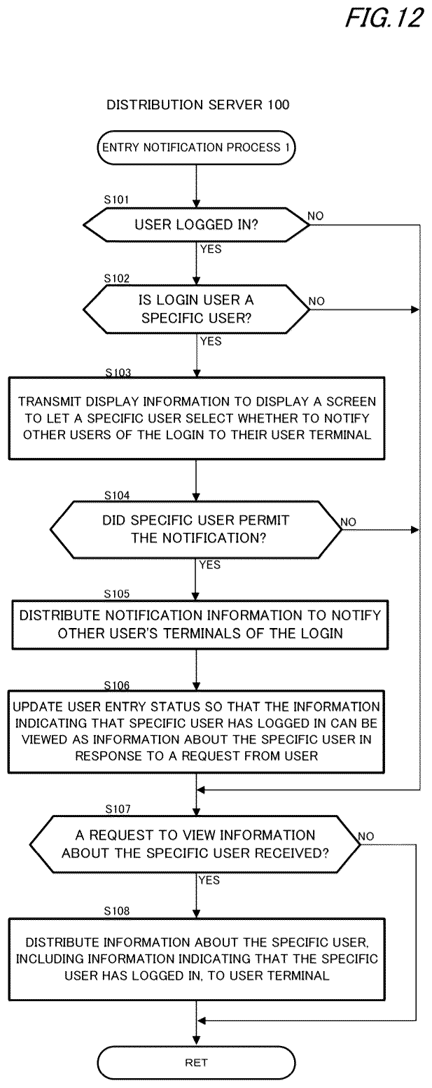

Referring to FIG. 12 through FIG. 15, the following describes a notification process for notifying other users that a specific user has logged into the virtual space provided to users by the distribution server 100. In this embodiment, the ways of notifying information about a specific user (e.g., a performer) includes: receiving a push notification on the information about the specific user; and in response to a viewing request from a user terminal (transmission of a request signal (request)), and on the basis of the viewing request from the user terminal (request signal transmitted from the user terminal) to a server that enables a user to view information about the specific user, receiving and displaying response information distributed (transmitted) to the user terminal. The server that enables a user to view information about a specific user includes: a server that manages smartphone apps related to specific users; a server (specific user information media management server 500) that manages a website that displays information about specific users; or a distribution server 100 that provides a virtual space into which a specific user has logged in. The specific user information media management server 500 (e.g., a server managing a smartphone appl, a server managing a website) obtains information on whether a specific user has logged in to the virtual space using an entry status API that enables the user's entry status (e.g., the user information data table in FIG. 7A) stored in the storage unit 120 of the distribution server 100 to be obtained via the communication unit 110.

### (Entry Notification Process 1)

Entry notification process 1 notifies, in response to entry (login) by a specific user into a virtual space, other users that the specific user has entered (logged in) (e.g., by push notification or by displaying the information on the user terminal in response to a viewing request from the user). Hereinafter, the entry notification process 1 will be described with reference to the flowchart of FIG. 12. The entry notification process 1 is repeatedly executed at predetermined time intervals by the controller 130 in the distribution server 100 when a user logs in to the virtual space. The distribution server 100 performs various processes including the entry notification process 1 on the basis of the program stored in the storage unit 120. The following is an example where the determination of whether or not the user is a specific user is based on the user attribute number in FIG. 7A.

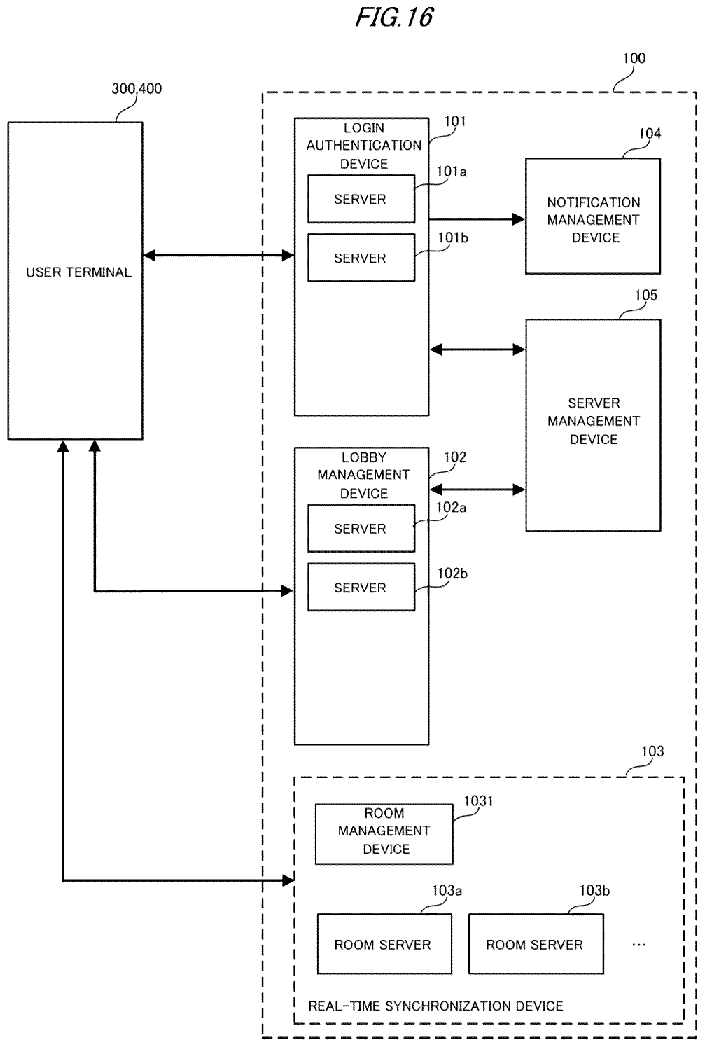

First, in step S101, it is determined whether or not a user has logged in to the virtual space. If it is not determined that a user has logged in, the process proceeds to step S107. If it is determined that a user has logged in, the process proceeds to step S102 to determine whether the login user is a specific user or not. For instance, when the entry/exit processing unit 134 (e.g., a login authentication device 101 described later with reference to FIG. 16) performs a login authentication process based on a login request from a user, it determines whether the user who has logged in is a specific user. The user's login request is transmitted to the distribution server 100 by selecting the START icon 21 in FIG. 9A, for example. For instance, if the user who logged in is user ID “u1” in FIG. 7A, the user attribute number is 1 and the user is a general user. Thus, the user is not determined to be a specific user. If the user who logged in is user ID “u2”, the user attribute number is 2 and the user is a performer belonging to group A. Thus, the user is determined to be a specific user. If the user is not determined to be a specific user in step S102, the process proceeds to step S107.

If the user is determined to be a specific user in step S102, the process proceeds to step S103. In step S103, display information for displaying a selection screen for letting the user select whether or not to notify other users of the login is distributed (transmitted) to the user terminal of the specific user who has logged in. At this time, the distribution server 100 performs a process of displaying the post-login title screen shown in FIG. 9C on the user terminal of the logged-in user. For instance, if the login user is a specific user with user ID “u2”, the controller 130 transmits display information for displaying the selection screen of FIG. 9B on the user terminal of “u2” to the user terminal of the specific user who has logged in. This allows the specific user “u2” to select whether or not to inform other users that they have logged in by selecting the “Yes” icon 22Y or “No” icon 22N in FIG. 9B. When either the “Yes” icon 22Y or the “No” icon 22N is selected, the notification permission information is transmitted to the distribution server 100.

In step S104, it is determined whether the specific user who is determined to have logged in in steps S101 and S102 has permitted being notified of their login, based on the notification permission information transmitted from the user terminal of the specific user. If it is not determined that permission has been given, the process proceeds to step S107. For instance, if the specific user logs in while selecting “No” icon 22N on the screen shown in FIG. 9B, the notification management unit 135 (e.g., the notification device 104 described below with reference to FIG. 16) controls not to perform the process to notify that the specific user has logged in, on the basis of the received notification permission information.

If it is determined in step S104 that permission has been given, the process proceeds to step S105 to distribute notification information to notify user terminals that the specific user has logged in. The destinations to which the notification information is distributed from the distribution server 100 are user terminals and the specific user information media management server 500. For instance, if the user logs in while selecting “Yes” icon 22Y on the screen of FIG. 9B, then it is determined that the user has given the permission to notify other users based on the notification permission information received by the notification management unit 135. When the notification information is distributed from the distribution server 100, each user terminal receives, based on the information received from the distribution server 100, a push notification as in FIG. 10A or an in-app notification as in in-app notification 50 in FIG. 11.

A notification (announcement) may also be transmitted to the administrator terminal 200, and even if the specific user has not permitted to notify other users, a notification (announcement) may be transmitted to the administrator terminal 200. For instance, even if the specific user selects “No” icon 22N on the screen in FIG. 9B, the notification may not be transmitted to other user terminals, but transmitted to the administrator terminal 200 operated by the administrator.

In step S106, a process is performed to update information on the user entry status so that the information indicating that the specific user, who was determined to have permitted the notification in step S104, has logged in can be viewed as information about the specific user in response to a request from the user (viewing request). For instance, the notification management unit 135 updates the user's entry status and stores it in the storage unit 120 (which may be the user information 121). This allows other servers (e.g., the specific user information media management server 500), which obtain the user access status through the user access status API, to obtain the information that the specific user logged in in steps S101 to S104. Then, the app in FIG. 10B and the web browser that displays information about the specific user will be able to display that the specific user, including the specific user in steps S101 to S104, has logged in. When this entry status is updated, information about the specific user can be displayed in the virtual space, and the specific user's login can be displayed in the bulletin board object O shown in FIG. 11. After receiving the notification permission information, the distribution server 100 performs a process of displaying the post-login title screen as illustrated in FIG. 9C on the user terminal of the user who has logged in.

In step S107, it is determined whether or not a request to view information about the specific user (request from a user) has been received. If no viewing request is received, the process ends. If it is determined in step S107 that a viewing request has been received, the process proceeds to step S108, where information about the specific user, including information indicating that the specific user has logged in, is distributed to the user terminal, and the process ends. For instance, the viewing request may be a request made from a user terminal to display a bulletin board object O in the virtual space illustrated in FIG. 11 (e.g., a request to obtain information for displaying the space in which the bulletin board object O is placed, or a request to obtain information about the bulletin board object O by selecting the bulletin board object O), and in response to the request, a message is displayed on the user screen of the user terminal indicating that a specific user has logged in. For instance, information during the most recent predetermined period (e.g., the past three hours) may be displayed.

### (Entry Notification Process 2)

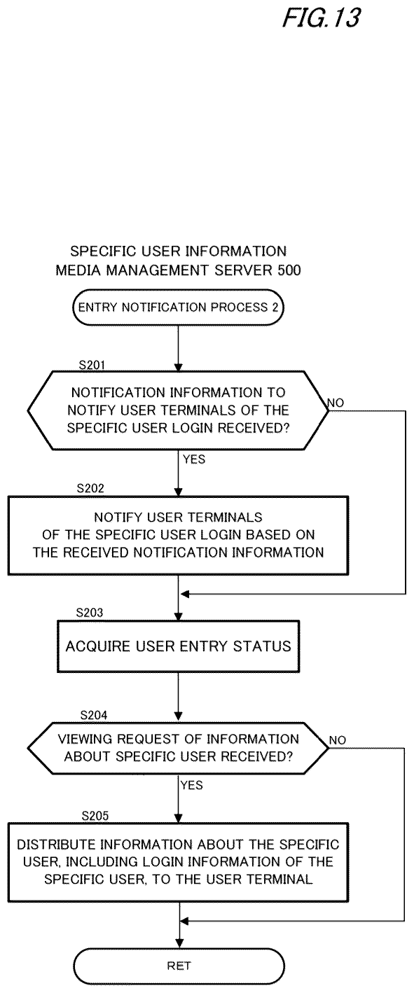

Entry notification process 2 is executed by the specific user information media management server 500, and is for notifying user terminals (e.g., by push notification or by displaying the information that the specific user has entered the virtual space in response to a viewing request from the user) of the information that a specific user has logged in the virtual space on the basis of the information received from the distribution server 100 in the entry notification process 1 described referring to FIG. 12. Hereinafter, the entry notification process 2 will be described with reference to the flowchart of FIG. 13. The entry notification process 2 is repeatedly executed at predetermined time intervals by the controller 530 in the specific user information media management server 500. The specific user information media management server 500 performs various processes including the entry notification process 2 on the basis of the program stored in the storage unit 520.

First, in step S201, it is determined whether or not notification information is received at the user terminal to notify that the specific user has logged in. If it is not determined that the notification information is received, the process proceeds to step S203. If it is determined in step S201 that notification information has been received, the process proceeds to step S202, where the information that the specific user has logged in is notified (announced) to the user terminal based on the received notification information. For instance, when performer BBB logs in, notification information is transmitted from the distribution server 100 in step S105 of FIG. 12, and then when this notification information is received by the specific user information media management server 500, a push notification is made to the user terminal to inform the user that performer BBB has logged in to the virtual space as shown in FIG. 10A.

In step S203, the user entry status is acquired from the distribution server 100. For instance, the user entry status API of the distribution server 100 is used to obtain a list of user entry statuses stored in the storage unit 120, which is updated by step S106 in FIG. 12. The obtained information on the entry status of users may be stored in the storage unit 520 of the specific user information media management server 500.

In step S204, it is determined whether or not a request to view information about a specific user (a request from a user) has been received from a user terminal. If it is not determined that a request to view information about a specific user has been received, the process ends. If it is determined that a viewing request for the information about a specific user has been received, the process proceeds to step S205, where information about the specific user, including the login information of the specific user obtained in step S203, is distributed to the user terminal, and the process ends. For instance, when the viewing request is made to display a screen showing the schedule for a specific user in FIG. 10B, the content heading 40a, which is the video distribution information of the specific user, and the content heading 40b, which is the login information of the specific user to the virtual space, are displayed on the user screen.

### (Entry Notification Process 3)

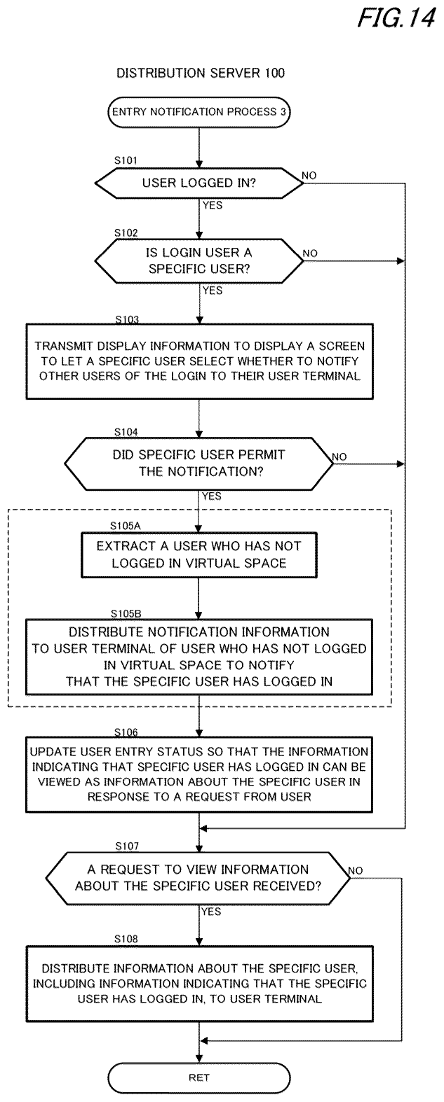

Entry notification process 3 distributes notification information for notifying (announcing to) the user terminals of users who are not in the virtual space that a specific user has entered (logged in). This process is different from the entry notification process 1 described referring to FIG. 12 in the target user terminal to which notification information is distributed. While in the entry notification process 1, a user is notified regardless of whether or not the user has entered the virtual space (the user terminal of the user whose room entry status is “In” in FIG. 7A is also included in the target of the notification), a notification is given to a user who has not entered the space in the entry notification process 3. Hereinafter, the entry notification process 3 will be described with reference to the flowchart of FIG. 14. This process differs from the entry notification process 1 in steps S105A and S105B that are enclosed by dashed lines. Hereinafter, explanations are omitted for the processes that overlap with the entry notification process 1. The entry notification process 3 is repeatedly executed at predetermined time intervals by the controller 130 of the distribution server 100. The distribution server 100 performs various processes including the entry notification process 3 on the basis of the program stored in the storage unit 120.

If it is determined in step S104 that the specific user has permitted to notify other users that the specific user has logged in, the process proceeds to step S105A to extract a user who has not entered the virtual space. In step S105B, notification information is distributed to the user terminal of user who has not entered the virtual space to notify the user that the specific user has logged in. For instance, the notification management unit 135 refers to the user information 122 and extracts a user who is not currently in the virtual space and is in a logged-out state. In step S105B, notification information is distributed (e.g., push notification) to the user terminal of the user extracted in step S105A. For instance, the notification information is distributed to user IDs “u3”, “u5”, and “u7” whose entry status is “Out” in FIG. 7A. For instance, push notifications may be transmitted only to the general user's terminal.

Although in step S105 of FIG. 12, notification is transmitted to a user regardless of whether the user is in the virtual space or not, the entry notification process 3 in FIG. 14 is able to extract a user who has not entered the virtual space and is likely to be unaware that the specific user has entered, and then transmit a notification. This also does not bother a user by transmitting a notification to the user who has already entered the virtual space and knows that the specific user has entered.

### (Entry Notification Process 4)

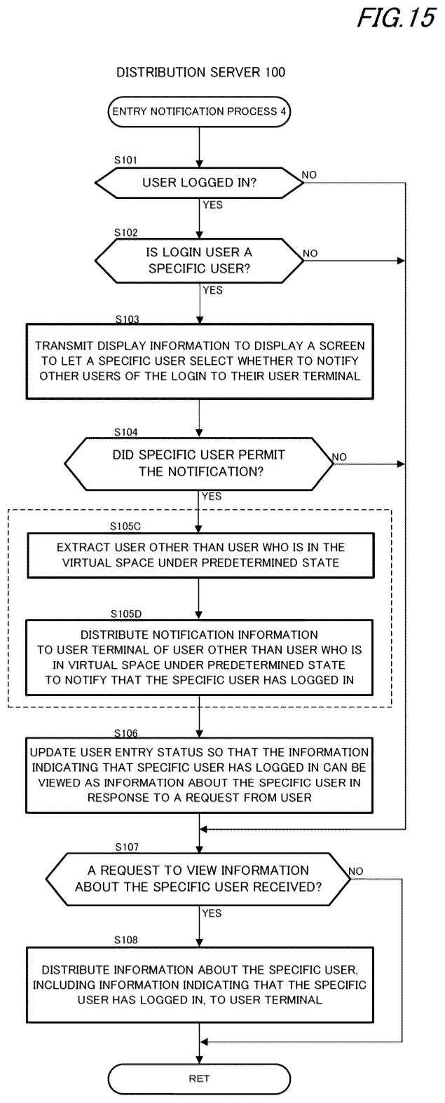

Entry notification process 4 distributes notification information for notifying (announcing to) the user terminals of users other than the users who are in the virtual space under predetermined state that a specific user has entered (logged in). This entry notification process is different from the entry notification process 1 described referring to FIG. 12 in the target of user terminals, to which notification information is distributed. While users are notified in the entry notification process 1 regardless of their room entry status in the virtual space (e.g., regardless of whether they are participating in the live event or they are in the virtual space while being scheduled to participate in the live event in advance), users other than those who have entered the virtual space under predetermined state (including users who have not entered the virtual space) are notified in the room entry notification process 4. Hereinafter, the entry notification process 4 will be described with reference to the flowchart of FIG. 15. This process differs from the entry notification process 1 in steps S105C and S105D that are enclosed by dashed lines. Hereinafter, explanations are omitted for the processes that overlap with the entry notification process 1. The entry notification process 4 is repeatedly executed at predetermined time intervals by the controller 130 of the distribution server 100. The distribution server 100 performs various processes including the entry notification process 4 on the basis of the program stored in the storage unit 120.

If it is determined in step S104 that the specific user has permitted to notify other users that the specific user has logged in, the process proceeds to step S105C to extract a user except those who have entered the virtual space under predetermined state. In step S105D, notification information is distributed to the user terminal of a user except those who have entered the virtual space under predetermined state to notify the user that the specific user has logged in in step S104.

For instance, under predetermined state refers to the states in which a user is participating in predetermined content within a virtual space, including when the user is participating in highly immersive content, such as when the user is participating in a live event held within a virtual space, when the user is participating in a fan meeting, or when the user is participating in a game. For instance, in some games that require quick operation, such as during a battle game, no notification may be given, but in other games where operation is relatively less urgent, such as building games, notification may be given. In this way, in the case where the user would be disadvantaged by being distracted by a notification or where there is a possibility of the user losing immersion, the notification may not be transmitted.

Other examples of the predetermined state may include a specific period of time before a live event that the user plans to attend, or a specific period of time before a live event that is scheduled to be held in a virtual space (e.g., one hour before the start time of the live event). This is because when a predetermined live event is to be held, users already may know the information for a specific user to enter the virtual space.

As described above, information about a specific user's entry into the virtual space may be reported to user terminals. This makes it possible for users to feel closer to the specific user more quickly, thereby enriching fan activities, enjoying various content (activities) with the specific user through the virtual space, and anticipating the possibility of a live event being held because the specific user has entered the virtual space (e.g., anticipating a guerrilla live performance by a performer), so that the user experience in the virtual space becomes more interesting.

### (Setting Change Process)

Referring to FIG. 16 to FIG. 19, a process of changing the setting of the distribution server 100 to a continuous provision state will be described, which may change with the user's behavior including entering the virtual space. In this embodiment, the controller 130 of the distribution server 100 may perform the setting change process of the distribution server 100 to set the distribution server 100 to a continuous provision state so that the virtual space can be continuously provided to users, either by manual operation by the administrator of the administrator terminal 200 or when preset conditions are met. A state in which continuous provision is not possible (a state other than a continuous provision state) refers to the following state, that is, when the distribution server 100 provides a virtual space to a user, waiting times or failures may occur due to the processing capacity (e.g., the number of activated servers, specifications) of the distribution server 100, which may cause the possibility of making it difficult to continuously provide the virtual space smoothly or causing the provision to be temporarily interrupted. Whereas, in a continuous provision state, there is no or extremely low possibility of such a situation.

The followings are examples of user behaviors that may make it difficult or temporarily disruptive for the distribution server 100 to smoothly and continuously provide a virtual space to users (maintain a state of continuous provision).

(1) The load on the distribution server 100 increases due to a large number of users making a login (entry) request to the virtual space in a short period of time (intensively) (e.g., a situation in which the CPU usage rate of the distribution server 100 remains high for a certain period of time).

(2) The number of user requests to enter the virtual space exceeds the predetermined upper limit of the number of people that can be associated (enter) the space (e.g., the upper limit of the number of users that can be associated with one server), resulting in a waiting time to start a new room.

(3) The load on the distribution server 100 increases due to an increase in the motion actions of users who are already in the virtual space.

Note that a motion action means an action that is considered to increase the amount of communication between the user terminal and the distribution server 100, such as a user's movement within a virtual space, an item use, or a chat. For instance, the amount of information to be synchronized with other user terminals and the frequency of the synchronizations (e.g., synchronization of user avatar position information and synchronization of stage effect information resulting from item use) increase, which increases the processing load on the distribution server 100.

In conventional systems, when the load on the distribution server 100 increases or the number of users exceeds the allowable number due to a user behavior that would make it difficult to maintain the above-mentioned continuous provision state, a setting change process is performed to place the distribution server 100 to a continuous provision state by increasing the server resources of the distribution server 100 (server expansion process) or decreasing (reducing) the amount of information distributed to user terminals. However, if such a process is performed after the load increases, the processing time at the distribution server 100 will increase by the amount of the increased load, and users will have to wait longer than when the load is not increased. In other words, once the load on the distribution server 100 increases, the processing of the distribution server 100 becomes slower than usual, and it takes time to perform the processing of letting a user enter the virtual space and of distributing data to the user terminal. In particular, in this embodiment, when a specific user enters the virtual space, this may affect the actions of other users, and the load on the distribution server 100 may increase. Furthermore, when other users are notified that a specific user has entered the virtual space, this may have a greater impact on the behavior of those other users, which may result in longer waiting times for processing and increased susceptibility to server failures. Thus, this embodiment performs the process of reducing the load on the distribution server 100 in advance, in response to the entry of a specific user into the virtual space as a trigger. This makes it possible to maintain the continuous provision state even if user behaviors occur that are expected to make it difficult to maintain the continuous provision state as described above.

The processes of increasing the resources of the distribution server 100 (increasing the processing capacity of the server) in this embodiment include the following.

(1) The process of increasing the number of servers used to provide a virtual space (scale out).

(2) The process of increasing the performance of servers for providing a virtual space (scale up).

The processes of decreasing (reducing) the amount of information distributed from the distribution server 100 to a user terminal in this embodiment include the following.

(1) Reducing the overall amount of information by reducing the frequency of synchronization between the distribution server 100 and user terminals.

(2) Decreasing the amount of information itself that is distributed from the distribution server 100 to user terminals.

These processes may be implemented by transmitting a signal from the distribution server 100 to a user terminal to reduce the number of synchronization requests from the user terminal or to lower the amount of information requested from the user terminal, or the frequency of synchronization from the distribution user 100 to the user terminal and the amount of information to be transmitted may be suppressed. For instance, the distribution server 100 may periodically distribute a signal regarding server congestion information to users, and transmit a signal to user terminals regarding server congestion information generated when the server load increases. Then, when receiving the signal of congestion information, a user terminal may perform the process of decreasing the frequency of transmitting a signal that requests synchronization or of lowering the amount of information requested from the user terminal. For instance, the amount of information requested is drawing (this may be called “rendering”) information, which includes the amount of objects (including user avatars) displayed in the virtual space and the image resolution. This reduces the processing load caused by frequent data input/output in the distribution server 100 and by reading heavy data in the distribution server 100 in order to read information to be distributed to user terminals.

### (Example of System Configuration and Process)

FIG. 16 shows an example of the system configuration and a process of the distribution server 100. In an example of the configuration, the distribution server 100 includes a login authentication device 101, a lobby management device 102, a real-time synchronization device 103, a notification management device 104, and a server management device 105. These devices may be configured with one or more servers (communication infrastructure). For instance, the login authentication device 101 may be an API server for performing login authentication, and the lobby management device 102 may be a lobby API server for providing information on areas, rooms, and others of the virtual space to user terminals. For instance, the login authentication device 101 includes a plurality of servers such as a server 101a, a server 101b . . . , and the lobby management device 102 includes a plurality of servers such as a server 102a, a server 102b . . . .

The login authentication device 101 is a computer having a function of performing a process for user login authentication, which is executed by the entrance/exit processing unit 134, for example. The login authentication device 101 receives login information from a user terminal, determines whether or not login is permitted, and after the authentication is completed, transitions the user to a login state. For instance, the authentication is performed by referring to the user information contained in the login information and the user data table stored in the user information 121.

When the user who has undergone the login authentication process at the login authentication device 101 is a specific user, the login authentication device 101 transmits predetermined information to the notification device 104 and the server management device 105. To the notification device 104, information specifying that a specific user has logged in is transmitted. To the server management device 105, a request for increasing the server resources is transmitted.

The notification management device 104 is a computer that performs a process of notifying (announcing to) a user terminal and others that a specific user has logged in, which is executed by the notification management unit 135, for example. For instance, when the notification management device 104 receives information that a specific user has logged in (which may include information on whether or not entry notification is permitted) from the login authentication device 101, the notification management device 104 performs a process to transmit a push notification to user terminals and the administrator terminal 200. The information that a specific user has logged in may include the information on whether or not entry notification is permitted, which is transmitted from the user terminal of the specific user. Alternatively, the notification management device 104 may be an entry status API server that lets another server acquire the entry status of a user into a virtual space in response to a request from this server. The login authentication device 101 may perform the process of notifying (announcing to) the administrator terminal 200 itself or the user terminal itself of information that a specific user has logged in.

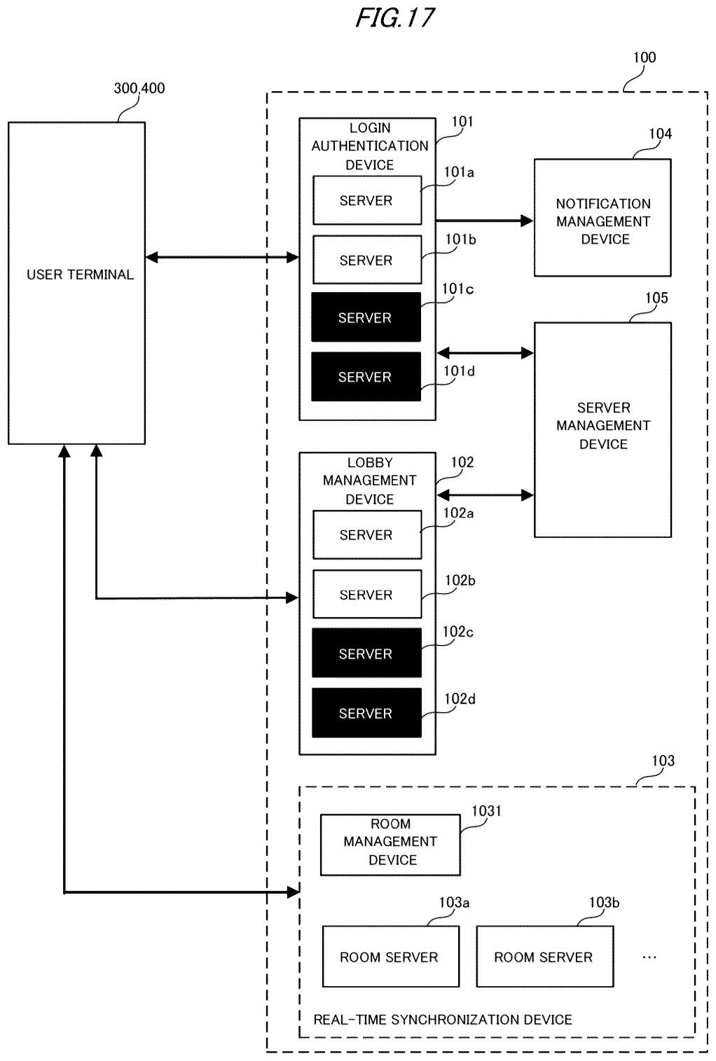

The server management device 105 is a computer that performs a process of changing the resource settings of the server, which is executed by the scale management unit 136, for example. The login authentication device 101 and the lobby management device 102 are examples of servers, for which the server management device 105 increases the resources. When the server management device 105 performs a process of increasing the number of servers as a process of increasing resources, as illustrated in FIG. 17, servers 101c and 101d are added as servers of the login authentication device 101, and servers 102c and 102d are added as servers of the lobby management device 102.

The number of servers of the login authentication device 101 increases, whereby the login authentication device 101 withstands the load caused by login requests (access) from a large number of users in a short period of time, thereby reducing the possibility of users having to wait and making it possible to continuously provide the virtual space to users. The number of servers of the lobby management device 102 increases, whereby the lobby management device 102 withstands the load caused by the large number of users requesting information about the virtual space, such as about areas and rooms, in a short period of time, thereby reducing the possibility of users having to wait and making it possible to continuously provide the virtual space to users.

The lobby management device 102 is a computer having functions of providing users with information about areas of the virtual space and a list of rooms that can be entered related to the area, which is executed by the content management unit 131. The user terminal of a user who has been logged in by the login authentication device 101 requests information about areas and rooms from the lobby management device 102, and based on the information obtained in response to the request, displays on the display unit a screen showing information about the areas of the virtual space that can be entered and various rooms, as illustrated in FIG. 9C.

The real-time synchronization device 103 is a computer that performs real-time synchronous communication within a room and between rooms, which is executed by the content management unit 131 and the scale management unit 136. It is also possible to set an upper limit on the number of users who can be associated with (enter) each room (e.g., an upper limit of 200 people). For instance, the real-time synchronization device 103 includes a room management device 1031, a room server 103a, a room server 103b . . . . The room management device 1031 controls communication related to the rooms. For the communication control, rooms are assigned in response to a communication request from a user terminal. For instance, in response to a request from a user terminal to the real-time synchronization device 103 to enter one of the rooms based on the information obtained from the lobby management device 105, the user can enter a room by obtaining connection information to the room from the room management device 1031.

The room management device 1031 also changes the resources of the room server according to the load on the room server or the number of people entering the room. For instance, this includes scaling out or scaling up a room server. The room management device 1031 may be configured to, when the user who entered the room is a specific user, increase the number of rooms in which content (e.g., content with a specific area or within the area) corresponding to the room entered by the specific user is provided. For instance, for multiple rooms corresponding to one area, only the user avatars of users who have entered the same room will be displayed in principle. For a specific user, however, the user avatar of the specific user can be mirrored and reflected in the same type of room where the same content is provided, even if the specific user has not entered the same room. This allows users in other rooms to be provided with the experience of being in the same room as the specific user. Therefore, it is conceivable that the number of users attempting to enter the same types of rooms in which the same content is provided will increase. Thus, a process is performed to increase the number of rooms in advance.

In this embodiment, the room management device 1031 may also be configured to change the amount of information in the virtual space provided to users by the room server. For instance, this may include reducing the amount of drawing information in the rooms where content corresponding to the room entered by the specific user is provided. Note that the server management device 105 may perform the process of reducing the amount of drawing information in the rooms.

When the login authentication device 101 authenticates the login of a specific user, the room management device 1031 may change the resources of the room server or the amount of information provided to users. For instance, when the specific user's login is authenticated, multiple rooms may be started and placed on standby, and after the specific user enters a room, the room servers placed on standby may provide the content corresponding to the content of the room where the specific user has entered. Also, the amount of information may be reduced only in the room that the specific user has entered. The present invention is not limited to this, and such a change to the resources of the room server may be made regardless of the area (content) that a specific user enters.

### (Virtual Space Providing Server Expansion Process)

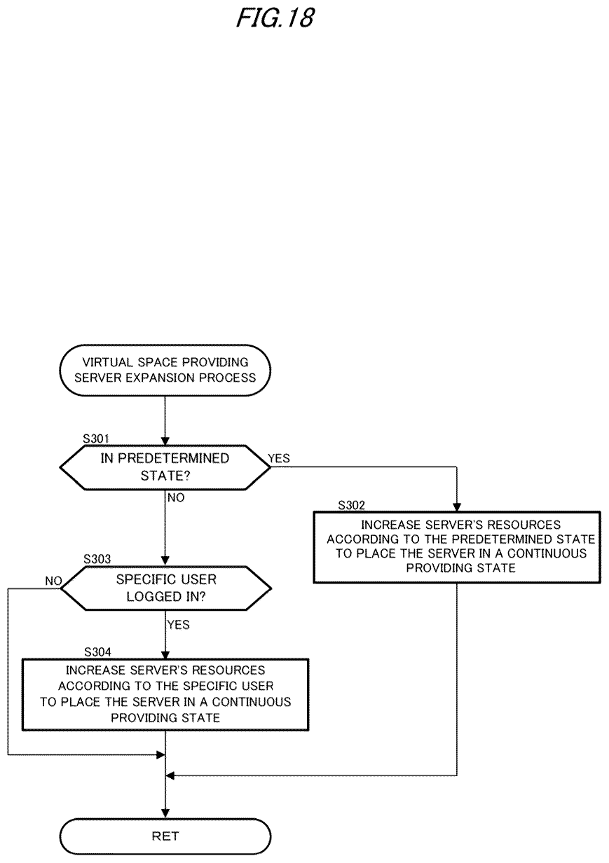

FIG. 18 is a flowchart illustrating a virtual space providing server expansion process for changing server resources, which is part of the setting change process of the distribution server 100 executed in the distribution server 100. This virtual space providing server expansion process is repeatedly executed at predetermined time intervals by the controller 130 of the distribution server 100. The distribution server 100 performs various processes including the virtual space providing server expansion process on the basis of the program stored in the storage unit 120. The following is an example where the determination of whether or not the user is a specific user is based on the evaluation index in FIG. 7A. In the virtual space providing server expansion process, a state when the server load becomes heavy or a state immediately before (just before) the server load becomes heavy is called a predetermined state.

First, in step S301, the process makes a determination whether or not it is in the predetermined state. If it is determined in step S301 that it is in the predetermined state, the process proceeds to step S302, where a process is performed to increase the server's resources according to the predetermined state so as to place the server in a continuous providing state. Then, the process ends. For instance, if the predetermined state of heavy load on the server happens due to factors including user behavior (e.g., entry by logging in, entry into a room, or motion action), the scale management device 136 performs a process of increasing the number of servers that is a process of increasing server resources.

If it is not determined in step S301 that it is in the predetermined state, it is then determined in step S303 whether or not a specific user has logged in. If it is not determined that a specific user has logged in, the process ends. If it is determined that a specific user has logged in, the process proceeds to step S304. For instance, when the entry/exit processing unit 134 (e.g., login authentication device 101) performs a login authentication process based on a user's login request, it determines whether the user who logged in is a specific user. For example, if the user who logged in is user ID “u1” in FIG. 7A, the evaluation index is negative, so it is not determined that a specific user logged in, and the process ends. If the user who logged in is user ID “u2”, the evaluation index is positive, so it is determined that a specific user logged in.

In step S304, the server's resources are increased according to the specific user who has logged in to place the server in a state of continuous provision. Then, the process ends. For instance, if the type and number of servers to be increased are determined according to the evaluation index, and the login user has user ID “u2,” the evaluation index is 5. Then, the scale management unit 136 (e.g., server management device 105) executes a process of increasing the number of normal servers and high-spec servers by one each. If the logged-in user has user ID “u3,” the evaluation index is 18. Then, the scale management unit 136 executes a process of increasing the number of high-spec servers by four and the number of maximum spec servers by three. This increases the number of servers according to the influence of each specific user, thereby enhancing the processing capacity of the distribution server 100.

As a result, even when it is not in the predetermined state and the server load has not increased yet, the server can be expanded in advance when a specific user logs in and before the predetermined state is reached.

The process of increasing the server's resources may be a scale-up that increases the server's performance. The predetermined state may also include a state where the room exceeds its upper limit of capacity (when the room is full, or when a predetermined number of people is reached before reaching full). When the upper limit of the number of people in a room is exceeded, the number of servers may be increased to increase the number of rooms, or the performance of the server may be enhanced to increase the number of rooms that can be provided in one server.

### (Distribution Information Amount Change Process)

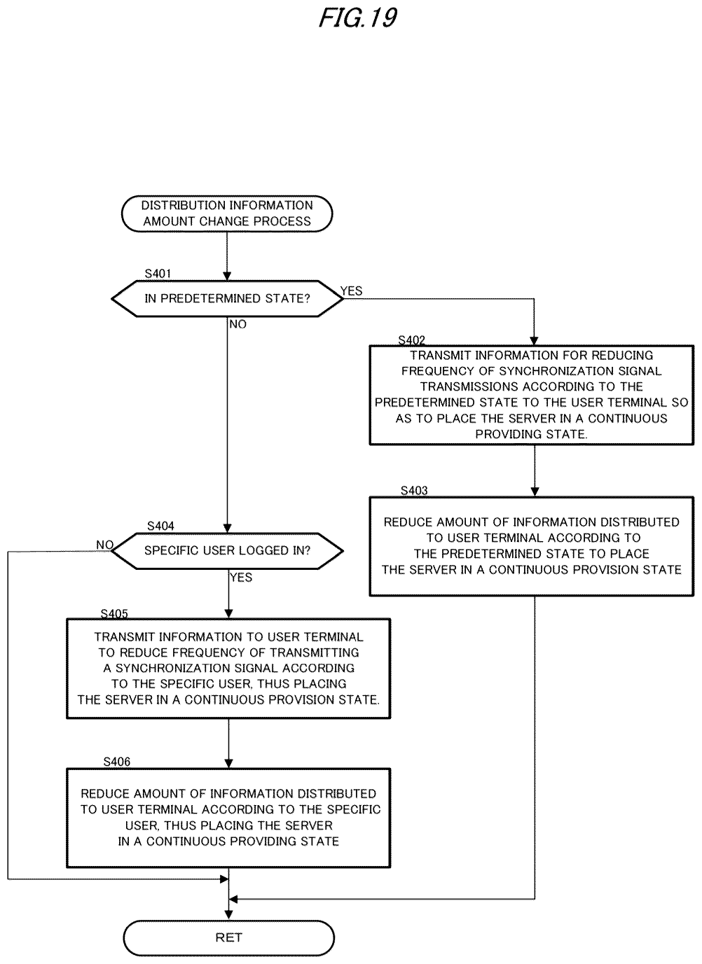

FIG. 19 is a flowchart illustrating a distribution information amount change process of changing the amount of information distributed from the distribution server 100 to a user terminal, which is part of the setting change process of the distribution server 100 executed in the distribution server 100. The distribution information amount change process is repeatedly executed at predetermined time intervals by the controller 130 of the distribution server 100. The distribution server 100 performs various processes including the distribution information amount change process on the basis of the program stored in the storage unit 120. The following is an example where the determination of whether or not the user is a specific user is based on the evaluation index in FIG. 7A. In the distribution information amount change process, a state when the server load becomes heavy or a state immediately before (just before) the server load becomes heavy is called a predetermined state.

First, in step S401, the process makes a determination whether or not it is in the predetermined state. If it is determined in step S401 that it is in the predetermined state, the process proceeds to step S402, where a process is executed to transmit information for reducing the frequency of synchronization signal transmissions according to the predetermined state (load state) to the user terminal so as to place the server in a continuous providing state. For instance, if the predetermined state is heavy load on the server due to factors including user behavior (e.g., entry by logging in, entry into a room, or motion action), the data distribution unit 132 transmits, to the user terminal, information that the server is congested to reduce the frequency of synchronizations from the user terminal, thus decreasing the amount of information transmitted from the distribution server 100 to the user terminal.

In step S403, the amount of information (the amount of information itself) distributed from the distribution server 100 to the user terminal is set to be reduced according to the predetermined state to place the server in a continuous provision state, and the process ends. For instance, a process of changing settings is performed so that the amount of drawing information (the amount of drawing load) of the virtual space distributed from the data distribution unit 132 to the user terminal is decreased and then is distributed to the user terminal. For instance, when the predetermined state is the heavy load on the server due to factors including user behavior, the process is performed to reduce the amount of objects (including user avatars) displayed and the amount of drawing information such as image resolution that are distributed from the server.

If it is not determined in step S401 that it is in the predetermined state, it is then determined in step S404 whether or not a specific user has logged in. I it is not determined that a specific user has logged in, the process ends. If it is determined that a specific user has logged in, the process proceeds to step S405. For instance, when the entry/exit processing unit 134 (e.g., login authentication device 101) performs a login authentication process based on a user's login request, it determines whether the user who logged in is a specific user. For example, if the user who logged in the room is user ID “u1” in FIG. 7A, the evaluation index is negative, so it is not determined that a specific user logged in, and the process ends. If the user who logged in is user ID “u2”, the evaluation index is positive, so it is determined that a specific user logged in.

In step S405, information is transmitted to the user terminal to reduce the frequency of transmitting a synchronization signal according to the specific user, thus placing the server in a continuous provision state. For instance, the data distribution unit 132 transmits, to the user terminal, information that the server is congested to reduce the frequency of synchronizations from the user terminal, thus decreasing the amount of information transmitted from the distribution server 100 to the user terminal. For instance, the frequency of synchronizations may be changed according to the evaluation index. For users with evaluation indexes between 1 and 5, the number of synchronizations per second is controlled to three instead of the usual six. For users with evaluation indexes of 6 or higher, the frequency of synchronizations may be controlled to once per second.

In step S406, the amount of information distributed from the distribution server 100 to the user terminal is reduced in accordance with the specific user, and the server is placed in a continuous providing state. Then, the process ends. For instance, a process of changing settings is performed so that the amount of drawing information (the amount of drawing load) of the virtual space distributed from the data distribution unit 132 to the user terminal is reduced and is distributed to the user terminal. A different process performed may vary with each specific user. For instance, the amount of information may be reduced so that the number of objects displayed in the virtual space is reduced more when a user with an evaluation index of 11 or more enters the virtual space than when a user with an evaluation index of 1 to 10 enters the virtual space.

As a result, even when it is not in the predetermined state and the server load has not increased yet, the process can be performed in advance to reduce the amount of information distributed from the distribution server 100 to the user terminal when a specific user logs in and before the predetermined state is reached.

The processes in steps S402 and S405 are not limited to transmitting information to the user terminal to reduce the frequency of synchronization signal transmissions. The data distribution unit 132 may change settings to reduce the frequency of synchronizations with the user terminal (synchronization frequency reducing setting), and this process of reducing the frequency of synchronizations between the distribution server 100 and the user terminal may place the server in the continuous provision state. In the processes in steps S403 and S406, the data distribution unit 132 may transmit information to the user terminal that the server is congested, thereby reducing the amount of drawing information of the virtual space requested from the user terminal, and thereby placing the server in a continuous provision state.

The predetermined state may also include a state where the room exceeds its upper limit of capacity (when the room is full, or when a predetermined number of people is reached before reaching full). When the upper limit of capacity in the room is exceeded, the process of reducing the amount of information distributed to the distribution server 100 and user terminals may be performed. If the number of people in the room increases, users' motion actions may increase and thus the amount of information when updating (synchronizing) the information in the virtual space may increase. This process therefore is performed to place the server to be in a continuous provision state in advance.

### <Example of Specific Configuration and Effects>

(1-1) In the above-described embodiment, when a predetermined state occurs, such as when the load on the distribution server 100 exceeds a threshold or when the upper limit of the number of people that can be associated with a room is reached due to factors including multiple types of user actions (e.g., entering while logging in, entering a room, motion action in the virtual space), the server expansion process of steps S301 to S302 in FIG. 18 and the distribution information amount change process of steps S401 to S403 in FIG. 19 are executed based on a program stored in the distribution server 100 (e.g., a program stored in a non-transitory computer-readable storage medium), thus placing the server to be in a continuous provision state so that the virtual space can be continuously provided to users. Note here that even in a situation that is not in the predetermined state, such as when the load on the distribution server 100 does not exceed a threshold or when the upper limit of the number of people that can be associated with a room is not reached, if a specific user, such as a performer or celebrity with user attribute numbers “2,” “3,” or “5” in FIG. 7A or a specific user with a positive evaluation index, enters the virtual space, the server expansion process of steps S303 to S304 in FIG. 18 and the distribution information amount change process of steps S404 to S406 in FIG. 19 are executed to perform the process to place the distribution server 100 to be in a continuous provision state. This allows the setting of the virtual space provision unit to be changed in advance to the setting of the continuous provision state when a specific user enters the virtual space. This allows for countermeasures to be taken in advance for the load that may be caused by a specific user entering the space.

(1-2) In the embodiment described above, the process of setting the virtual space provision unit to a continuous provision state includes performing the server expansion process (process to increase the resources) of the distribution server 100 in steps S302 and S304 of FIG. 18. For the server expansion process, the server management device 105 in FIG. 16 and FIG. 17 performs a process of adding the number of servers 101c and 101d of the login authentication device 101, thus scaling out the distribution server 100 (increasing the number of servers) and scaling up the distribution server (increasing specifications of the CPU and memory of the server). This increases the resources available to function as the distribution server 100, thereby enhancing the processing capacity of the distribution server 100 so as to withstand the load, allowing the virtual space to continuously be provided to users.

(1-3) In the embodiment described above, in the process of setting the distribution server 100 to the continuous provision state, the distribution information amount change process is performed to reduce the overall amount of information distributed from the distribution server 100 to a user terminal, such as steps S402, S403, S405, and S406 in FIG. 19. The distribution information amount change process includes: a process to transmit information to reduce the frequency of synchronization signal transmissions from the user terminal, such as steps S402 and S405 in FIG. 19; a process to transmit information to reduce the amount of drawing information to be requested, thus reducing the frequency of synchronizations between the distribution server 100 and the user terminal; a process to reduce the amount of information that is distributed from the distribution server 100 to the user terminal, such as steps S403 and S406 in FIG. 19; and a process to perform a setting process to reduce the frequency of synchronizations from the distribution server 100 to the user terminal, thus reducing the amount of information itself distributed from the distribution server 100 to the user terminal. This reduces the amount of information distributed from the distribution server 100 to the user terminal, reducing the processing load on the distribution server 100 and enabling the server to withstand the load, thus making it possible to continuously provide the virtual space to users.

(1-4) In the embodiment described above, the setting change process is performed to make the settings of the distribution server 100 to a continuous provision state, in preparation for a predetermined state or a predetermined state in response to a specific user entering the virtual space. The predetermined state includes: a state in which the load on the distribution server 100 exceeds a predetermined threshold due to a user's entry into the virtual space, a user's movement within the virtual space, or a motion action such as the use of an item; and a state in which waiting time occurs due to the number of users requesting entry that exceeds the number of people allowed to enter the room. In this embodiment, the setting change process is performed, thus changing the settings of the distribution server 100 to be a continuous provision state even if the distribution server 100 is placed under a load exceeding a predetermined threshold, which may cause the virtual space to be unable to be continuously provided to the user. This allows the virtual space to be continuously provided to users.

(1-5) In the embodiment described above, if a specific user, such as a performer or celebrity with user attribute types of “2”, “3”, or “5” in FIGS. 7A, 7B and 7C or a user with a positive evaluation index, enters the virtual space, the setting change processing of the distribution server 100 in FIG. 18 and FIG. 19 is executed so that the process corresponds to the evaluation index of the specific user. This makes it possible to change the settings of the distribution server 100 to a continuous provision state in advance before the predetermined state occurs, in response to the entry of a user whose entry into the virtual space is considered to have an influence on the behavior of other users.

(1-6) In the embodiment described above, an entry into the virtual space includes an entry by logging in to the virtual space. The setting change process of the distribution server 100 is performed in response to logging in of a specific user. In step S304 of the server expansion process in FIG. 18, the resources of the servers may be increased, the servers corresponding to the login authentication API server for authenticating (process) whether the user login has been successful, the login authentication device 101 in FIG. 16, and the entry/exit processing unit 134, for example. This allows the server to withstand the load even if the server that performs the login authentication process is overloaded due to other users login after a specific user has logged in.

(2-1) In the embodiment described above, if a specific user, such as a performer or celebrity with a positive evaluation index indicating evaluations from other than users and varying with external evaluations or with user attribute numbers “2,” “3,” or “5,” as shown in FIG. 7A, enters the virtual space, the entry notification process is executed to notify (announce to) other users that the specific user has entered as shown in FIG. 12 through FIG. 15, based on the programs stored in the distribution server 100, the specific user information media management server 500, and user terminals (e.g., a program stored in a non-transitory computer-readable storage medium). This allows other users to be notified that a specific user has entered the virtual space, making it easier for other users to obtain information about the specific user, thereby livening up the virtual space.

(2-2) In the embodiment described above, the users of the user terminals to which notification information is to be distributed in step S105 of FIG. 12 include users whose entry status in FIG. 7 is “In.” This allows a user in the virtual space also to be notified of the specific user entering the space, thereby preventing the user from being unaware that the specific user has entered the virtual space.

(2-3) In the embodiment described above, the users of the user terminals to be notified (announced) that the specific user has entered the virtual space do not include users whose entry status in FIG. 7 is “In”, but includes users whose entry status in FIG. 7 is “Out” in steps S105A and S105B in the entry notification process 3 of FIG. 14, based on the programs stored in the distribution server 100, the specific user information media management server 500, and user terminals (e.g., a program stored in a non-transitory computer-readable storage medium). In this way, users in the virtual space are not notified that a specific user has entered the virtual space, thereby suppressing the possibility of the notification disrupting the users' sense of immersion in the virtual space.

(2-4) In the embodiment described above, the push notification in FIG. 10A, the page displaying information about a specific user in FIG. 10B, and the content of the bulletin board object O in FIG. 11 may include information about the area (e.g., “entered area X!”) or room (e.g., “entered room ID 0001”) where the specific user has entered. This allows other users who have received the push notification or who have viewed the information on the bulletin board object O to specify the virtual space that the specific user has entered. This allows other users to easily follow and enter the same space (e.g., the same area or the same room), thereby livening up the virtual space.

(2-5) In the embodiment described above, in a fan community app as illustrated in FIG. 10B, a user may pre-select and store a favorite user as a favorite performer from among specific users who are performers and others. When the pre-selected performer and others (specific user) enters the virtual space, the user may be notified by push notification as shown in FIG. 10A that the performer has entered the virtual space. The user may operate the favorite filter 45 for selection on a predetermined page or others in the app that displays information about the specific user in FIG. 10B, and may be allowed to extract and display information about the pre-selected performer entering the virtual space. This allows the user to set the information on a specific user to be notified as they like, thereby improving the level of satisfaction with the notified information.

(3-1) In the embodiment described above, information about a specific user entering the virtual space may be displayed on the schedule information of performers in a community app such as FIG. 10B or on a bulletin board object O placed in the virtual space such as FIG. 11, which allow users to view information about the specific user, when the specific user enters the virtual space in response to a viewing request from the user in steps S105 through S107 in FIG. 12 and steps S203 through S205 in FIG. 13, based on the programs stored in the distribution server 100, the specific user information media management server 500, and user terminals (e.g., a program stored in a non-transitory computer-readable storage medium). This allows other users to view the entry of the specific user into the virtual space as information about the specific user, thereby enhancing convenience for users who are looking for information about the specific user.

(3-2) In the embodiment described above, information about a specific user is displayable in a specific area in the virtual space, such as the bulletin board object O in FIG. 11. This allows users to view the information on the specific user even when they are in the virtual space, thereby enhancing convenience for users who are looking for information about the specific user.

(4-1) In the embodiment described above, when a specific user logs in, the user terminal of the specific user may display the screen of FIG. 9B in steps S102 and S103 of FIG. 12, allowing the specific user to select whether or not to notify other users of the login, based on the programs stored in the distribution server 100 and user terminals (e.g., a program stored in a non-transitory computer-readable storage medium). When the specific user selects “Yes” icon 22Y in FIG. 9B, so that the setting state permits to notify other users of the login, steps S105 and S106 enable notifying to other users that the specific user has entered the virtual space. This allows the specific user to set whether or not to notify other users that they enter the space, taking into account the specific user's preferences, circumstances, and others, thereby enhancing convenience for the specific user.

(4-2) In the embodiment described above, when a specific user enters a virtual space, upon a selection of the permission, such as “Yes” icon 22Y being selected on the screen in FIG. 9B, that allows other users to be notified of the login, steps S105 and S106 in FIG. 12 allow other users to be notified of the entry. This allows the specific user to select whether or not to notify other users of the entry when they enter the virtual space, thereby allowing the specific user to make effective notifications in accordance with the situation of their entry.

(5-1) In the embodiment described above, user terminals of users except the users who are in the virtual space under predetermined state, such as participating in predetermined content (e.g., a live event) in the virtual space, are notified (announced) of the entry of a specific user in steps S105C and S105D in the entry notification step 4 of FIG. 15, based on the programs stored in the distribution server 100, and the specific user information media management server 500 (e.g., a program stored in a non-transitory computer-readable storage medium). This avoids a situation where the notification is given to a user who is in the virtual space under the predetermined state and whose necessity of being notified of the specific user's entry is low. The notification is not given to a user who is participating in a specific event, so that the user's immersion in the event is not interrupted.

### MODIFICATION EXAMPLES

The following is a list of modification examples and others of the embodiments described above.

### Other Examples of Specific User and Setting Change Process

### (Attribute Numbers and Server Expansion Process)

The above embodiment describes an example in which the server expansion process described with reference to FIG. 18 is executed so that if a user with a positive evaluation index logs in at step S303, it is determined that a specific user has logged in. The present invention is not limited to this, and if a user who is a performer or celebrity with an attribute number such as “2,” “3,” or “5” logs in, it may be determined that a specific user has logged in, and resources may be increased according to the attribute number.

### (Relationship Between Evaluation Index, Attribute Number and Amount of Information Distributed)

The above embodiment describes, referring to FIG. 8, an example in which the resources of the server (the number of servers and specifications of the CPU and memory) to be changed for each evaluation index are defined, and the resources of the server are changed according to the evaluation index of each specific user. Similarly for the amount of information distributed, the frequency of synchronizations between the distribution server 100 and the user terminal may be changed or the amount of information distributed from the distribution server 100 to be reduced may be adjusted according to the evaluation index. For instance, if a user with an evaluation index of 1 to 5 enters the virtual space, the frequency of synchronizations may be set to three, and when a user with an evaluation index of 6 or higher enters there, the frequency of synchronizations may be set to one. In addition, the number of objects displayed in the virtual space may be reduced more when a user with an evaluation index of 11 or more enters the virtual space than when a user with an evaluation index of 1 to 10 enters there.

The amount of information distributed may be adjusted for each attribute number. For instance, if a specific user with an attribute number “2” in FIG. 7B enters the virtual space, the frequency of synchronizations per second may be set to one, and if a specific user with an attribute number “5” enters there, the frequency of synchronizations per second may be set to three.

### (Evaluation Index and Entry Notification Process)

In the above-described embodiment, the determination as to whether or not a user is a specific user in step S102 of FIG. 12 is made based on the attribute number associated with the user. The determination on a specific user may be made based on an evaluation index. For instance, if a user has a positive evaluation index, the user is determined to be a specific user, and thus the process is executed to notify other users that the user has entered the virtual space; if a user has a negative evaluation index, the user is not determined to be a specific user, and thus the process is not executed to notify other users that the user has entered the virtual space.

### (User Attribute Number and Evaluation Index)

The above embodiment describes, referring to FIGS. 7A, 7B and 7C, an example in which a user attribute number and a user evaluation index are associated with each user. The present invention is not limited to this, and only one of the “user attribute number” and the “evaluation index” may be defined.

When a user account is created (when a user ID is created), the default attribute number may be set to “1” that is for a general user. The administrator may change and store the attribute number of an already created user account to any number. Alternatively, the administrator may assign an attribute number to the user beforehand and then add the user to the data table of the user information 121. The attribute number is not limited to a default number or any number that is assigned by the administrator, but may vary with other factors. For instance, it may vary with the “evaluation index,” and a user whose “evaluation index” exceeds a predetermined value may be assigned a user attribute number “5” indicating that the user is a celebrity.

The above embodiment describes, referring to FIG. 8, an example in which the degree of change (e.g., amount of resources, amount of distribution) in the setting change process of the distribution server 100 is predetermined for each evaluation index or attribute number. In addition to this, a predetermined number of servers may be associated with each user ID. For instance, user ID “u2” may be associated with three servers, and user ID “u7” may be associated with ten servers: if “u2” logs in, three servers are added, and if “u7” logs in, ten servers are added.

Alternatively, the administrator may determine an evaluation index corresponding to a desired number of servers, for example, in advance for each user. For instance, if user ID “u2” enters the room, the administrator may wish to increase the number of normal servers and high-spec servers by one for each server. In this case, the administrator may determine the evaluation index for user ID “u2” as “5” in advance.

### (Another Example of Determining a Specific User (Special User))

The above embodiment describes an example of determining whether or not a user is a specific user based on an attribute number or evaluation index. As exemplified by user ID “u6” in FIG. 7A, when both the attribute number and the evaluation index are defined, if one of them indicates they are a specific user, the user may be determined to be a specific user and a process may be accordingly performed. The present invention is not limited to this. When both the attribute number and the evaluation index are defined, the process for special user may not be performed unless they are considered a specific user in terms of both the user attribute number and the evaluation index. For instance, regardless of whether the attribute number is those of a specific user (e.g., 2, 3, and 5 in FIG. 7B), if the evaluation index is not a positive value, the user may not be determined to be a specific user.

Alternatively, when both the attribute number and the evaluation index are defined, the criterion to be used when determining whether the user is a specific user may be predetermined as the attribute number or the evaluation index, according to the processing content (e.g., which one of the entry notification processing or the setting change processing of the distribution server 100 is performed). In this way, the criteria to be referred to when determining whether a user is a specific user may differ with the processing content. For instance, when performing the entry notification process to notify other users that the specific user has entered the virtual space, the notification process may be executed when it is determined that the user is a specific user by referring to the attribute number of the user who has entered. The setting change process of the distribution server 100 may be executed by referring to the evaluation index of the user who has entered, and then the process may be performed in accordance with whether it is determined that the user is a specific user.

### <Related to Entry Notification Process>

### (Selecting Whether to Notify Other Users)

The above embodiment describes an example in which if the specific user does not permit other users to be notified of the login by selecting “NO” icon 22N of FIG. 9B in step S104 of FIG. 12, for example, the other users are not notified of the specific user logging in. The method of permitting notifications is not limited to the screen of FIG. 9B being displayed each time a login is performed. Instead of or in addition to the screen of FIG. 9B being displayed, the user may select whether the notification screen is turned on or off in advance on a settings screen. Alternatively, either on or off of notification may be set as a default, and the user may select on or off each time they log in. In addition, a specific user may be allowed to select the content of the information to be notified, such as whether or not to notify other users of the entry into a room or of the room ID.

The above embodiment describes an example in which after transmitting a login request to the distribution server 100 of FIG. 9A in step S101 of FIG. 12, then if the user is determined to be a specific user in step S102, the user is allowed to select whether or not to notify other users of the login as in FIG. 9B. The present invention is not limited to this. For instance, the user terminal may be a dedicated terminal for a specific user, and the selection screen of FIG. 9B may be displayed before the user transmits a login request to the distribution server 100. If the user selects “Yes” icon 22Y or “No” icon 22N in FIG. 9B, the login request may be transmitted to the distribution server 100 together with information indicating whether or not to permit notification to other users.

### (Push Notification)

The above embodiment describes an example referring to FIG. 10A, for example, in which a push notification is given to notify (announce to) other users that a specific user has entered the virtual space. The push notification may be configured so that the user is able to move to the virtual space where the specific user has entered by selecting the push notification displayed on the user terminal. For instance, a login screen for the virtual space may be displayed in response to the operation with the push notification. Alternatively, the user may be able to enter the room in which the specific user has entered, or a room in which the area corresponding to the room in which the specific user has entered is provided.

The push notification may include special benefit grant information for granting a special benefit. For instance, a serial code may be displayed in the push notification message along with the login information of the specific user, and the user may be granted a special benefit by inputting the serial code when entering the virtual space. This further encourages users to enter the virtual space via the push notification. An expiration date may be set for the serial code, so that the special benefit will not be given unless the serial code is input within a predetermined period (e.g., within three hours) after being notified. The serial code may be input not only when entering the virtual space, but also in a specified area within the virtual space, an item shop, and others.

(Example of the Place to Display Information about a Specific User)

The above embodiment describes, referring to FIG. 10B, an example where a page provided by the specific user information media management server 500 where information about a specific user is viewable is a display in a fan community app. The present invention is not limited to this, and information about a specific user that can be displayed on the display screen of the user terminal may be reported on the screen of a website that is made available to the user via a web browser. For instance, if a specific user is a performer, information about the performer's video distribution on a video distribution site, their entry status into a virtual space, and other information may be displayed. The information page of the website uses the API to obtain information about distributions by the performer's account on video distribution sites and a handle in the description box, and then displays information about the performer's appearances. The entry status API of virtual space users may be used, and if the users who have entered the virtual space include the account of a specific user, a performer, then the entry information may be displayed on a web page together with the icon of the performer, as shown in FIG. 10B, for example. When the performer logs out, the entry information may be deleted or changed to indicate that the performer has already left the room. When the web site is accessed from a user terminal, the web page is displayed on the web browser of the user terminal, allowing the user to obtain information about the performer. Also, the user may be allowed to transition to the virtual space based on the entry information.

### (Other Examples of Users Who are to be Notified to Other Users)

As described with reference to FIG. 10B, the above embodiment describes an example, in which selecting the favorite filter icon 45 in a fan community app allows information on a performer and others that the user has selected as a favorite in advance to be extracted and displayed (or enabling push notification), and thus notifying the user that a specific user that the user has selected in advance among specific users has entered the virtual space. The entry notification process may be configured so that not only when a user has been pre-selected as a favorite in the fan community app, but also when the user has pre-selected them as a specific user, only information about the entry of the specific user that has been pre-selected by the user may be reported. For instance, notification may be given for pre-selected users in the virtual space, or only information about a specific user that the user follows in the virtual space or a specific user that the user pre-selects from a list of specific users (e.g., a list of performers) who have entered the room may be reported. This process may be performed by storing a pre-selected user by the user in the storage unit 120 of the distribution server 100 or in the storage unit 320 of the user terminal. Then, if the login of the specific user is detected, a notification may be given on the user terminal of the user who pre-selected the specific user.

The above embodiment describes an example in which information identifying a user who has been pre-selected by the user (information specifying whether the selection has been made or not), which is stored in the storage unit 520 of the specific user information media management server 500, is transmitted from the specific user information media management server 500 to each user, together with information including information on other specific users. When receiving the information transmitted, the user terminal extracts the pre-selected specific user. The distribution server 100 may also perform a similar process. For instance, information identifying a user who has been pre-selected by the user (information specifying whether the selection has been made or not), which is stored in the storage unit 120 of the distribution server 100, may be transmitted from the distribution server 100 to each user, and the user terminal may extract the pre-selected specific user. Alternatively, based on the information stored in the storage unit 120, 520 of the distribution server 100 or the specific user information media management server 500, a specific user previously selected by the user may be extracted, and only information regarding the entry of the extracted specific user may be distributed to the user terminal.

It may also be possible to calculate an involvement index among users on the basis of their behavior history in the virtual space, and to notify users whose involvement index with a specific user who has entered the virtual space is above a predetermined value that the specific user has entered. The involvement index is calculated by the controller 130 based on the behavior history such as the number of times of participating a live event related to the specific user, the amount of money charged related to the specific user (e.g., social tipping, and purchase of goods), or the number of times the user has been in the same room (or in the same area) with the specific user. The period for calculation of the involvement index does not need to be limited, or the calculation period may be limited and the calculation may be performed based on the amount of charges during the predetermined period.

The above embodiment describes an example, in which the information to be notified to other users is information related to the entry of a specific user. In addition to this, if there is a user who has performed a predetermined action within the virtual space, even if this user is not a specific user, other users may be notified of the presence of the user who has performed the predetermined action. For instance, this includes detecting that the user has moved to a position corresponding to a predetermined region in the virtual space. For instance, the predetermined region is a platform on which a live event is held, and the presence of a user who has moved to this predetermined region suggests that a live event is about to begin. When a user who has gotten up on the platform is detected, as illustrated in the bulletin board object O in FIG. 11, a message such as “P-san has got up on the platform in Area Y!” is reported.

(Information about Specific User)

The above embodiment describes, as illustrated with reference to FIG. 10B and FIG. 11, an example in which information about a specific user that is viewable in response to a viewing request from a user includes information other than entry information into the virtual space about the specific user (e.g., video distribution information, live event information within the virtual space). The present invention is not limited to this, and the information may be a page in an app where only information about a specific user's entry into the virtual space is viewable, or an object in a virtual space, for example.

### (Entry Notification Process)

The above embodiment describes referring to FIG. 12 to FIG. 15 an example in which the entry notification process is performed in response to a specific user logging into the virtual space. Instead of or in addition to this, it may be determined in step S101 of FIG. 12 whether a specific user has entered a room in the virtual space, and when a specific user has entered a room, then other users may be notified. In addition to the entry of the specific user, other users may be notified which room they have entered. For instance, in response to a specific user entering area Y, a push notification may be given together with the information on the area entered.

Alternatively, as illustrated in the bulletin board object O in FIG. 11, the timing at which a specific user logs in and the entry of the specific user into a predetermined area may be reported in stages. Instead of or in addition to the area information, the room ID of the room that a specific user has entered may be reported.

Also, when a specific user moves to a room different from that they have entered, a process may be performed to report that the specific user has moved each time they move.

Even if a specific user enters the virtual space, no notification may be given if a predetermined time has not elapsed since the user's previous entry. For example, the predetermined time is set to 10 minutes. Then even if a specific user logs in, if 10 minutes have not elapsed since the previous login, the subsequent (this time) login will not be reported. Similarly, when a user enters a specific room again within a predetermined time period after the previous entry into the same room, no notification may be given. This prevents a push notification from being transmitted multiple times due to a specific user accidentally logging out, for example.

### (Entry Notification Process 2)

The above embodiment describes an example, in which in step S201 in FIG. 13, information about a specific user's login is reported to the user terminal when the specific user information media management server 500 receives the notification information distributed from the distribution server 100 in step S105 in FIG. 12. In other words, this is an example where the distribution server 100 identifies the newly login specific user who is the target of notification to other users. The present invention is not limited to this. The specific user information media management server 500 may identify the specific user who newly logged in on the basis of the user entry status obtained in step S203. A determination may be made whether or not a newly logged-in specific user is included in the user entry status obtained in step S203, and if a newly logged-in specific user is included, a push notification, for example, may be given autonomously from the specific user information media management server 500 to the user terminal.

The above embodiment describes an example, in which the entry status is acquired using the user entry status API of the distribution server 100 in step S203 in FIG. 13. The present invention is not limited to this, and when a specific user logs in, the distribution server 100 may distribute (transmit) the latest information about the user entry status to the specific user information media management server 500.

### (Entry Notification Process 3)

The above embodiment describes an example in which the distribution server 100 notifies (announces to) users who are not in (has not logged in) the virtual space that a specific user has entered (logged in) the virtual space in steps S105A and S105B in FIG. 14, and the specific user information media management server 500 may perform a similar process. For instance, the user ID in the specific user information media management server and the user ID in the virtual space provided by the distribution server 100 are associated with the storage unit 520 of the specific user information media management server 500 in advance, or the same ID is used for both user IDs. As a result, a notification may be given to the user terminals of users who are not included in the user entry status acquired in step S203 in FIG. 13.

The above embodiment describes an example in which users who are not in (has not logged in) the virtual space are notified (announced) that a specific user has entered (logged in) the virtual space in steps S105A and S105B in FIG. 14. Even if a user is logged in to the virtual space, the notification may be given to a user who is not in a room in the same area as the specific user (or in the same room as the specific user) has the entered.

In the entry notification process 3, for a user who is not logged in to the virtual space and is extracted in step S105A, information indicating that the specific user has logged in may be included in the information about the specific user distributed in step S108; for a user who is logged in the virtual space, information distributed to the user may not include information indicating that the specific user has logged in.

### (Entry Notification Process 4)

The above embodiment describes an example in which the distribution server 100 notifies (announces to) users except the users who have entered the virtual space under the predetermined state that a specific user has entered (logged in) to the virtual space in steps S105C and S105D in FIG. 15, and as explained above (Entry notification process 3), the specific user information media management server 500 may also perform a similar process. For instance, the user entry status obtained in step S203 of FIG. 12 may include information on the content in which each user is participating, and based on the obtained user entry status, a notification may not be transmitted to the user terminal of a user who has entered the virtual space under the predetermined state.

The above embodiment describes an example, in which a user who has entered the virtual space under predetermined state is not notified (announced) that a specific user has entered (logged in). The present invention is not limited to this, and when a specific user enters the virtual space under predetermined state, the entry of the specific user may not be notified. For instance, the predetermined state may include a case where the specific user enters a virtual space in order to hold or carry out a previously scheduled live event. If a specific user is a performer and enters the virtual space for a previously scheduled live event in which they are the major player, other users may not be notified that this specific user has entered the virtual space. In this case, if the distribution server 100 determines that the specific user logs in and it is during a specific live event that is previously scheduled, then the distribution server 100 may not perform a process of notifying other users.

If a login of a specific user occurs under predetermined state, the information about the specific user that is distributed in response to a viewing request from the user in step S107 of FIG. 12 and step S204 of FIG. 13 may not include the login information of the specific user who logged in under the predetermined state. For instance, the user may expect in advance that a specific user will log in or the time of login, or when the user may know in advance that a specific user will enter the virtual space. In this case, the user may not be notified of the login. For instance, a user may be notified of information about a specific user, such as the information about a scheduled entry or event as exemplified in FIG. 10B and FIG. 11, whereby the user may obtain information in advance about the possible entry of the specific user. When a large-scale live event is planned and a large number of specific users are expected to participate, this prevents the amount of information notified from becoming too large. In this way, in accordance with whether or not the entry of a specific user is a previously scheduled entry, if the entry is a previously scheduled one, other users may not be notified.

In the entry notification process 4, for a user except the user who is in the virtual space under predetermined state and is extracted in step S105C, information indicating that the specific user has logged in may be included in the information about the specific user distributed in step S108; for a user who is logged in the virtual space under predetermined state, information distributed to the user may not include information indicating that the specific user has logged in.

### <Setting Change Process of Distribution Server 100>

(Entry into Virtual Space)

The above embodiment describes an example in which a determination is made whether a specific user has logged in in step S303 of FIG. 18 and in step S404 of FIG. 19. The present invention is not limited to this, and the determination whether a specific user has logged in the virtual space may be made at the time of entering a room, and the process may be performed. For instance, if it is determined in step S303 of FIG. 18 or in step S404 of FIG. 19 that a specific user has entered a specific room in the virtual space, the process may be performed to increase the server resources in step S304, or the process may be performed in steps S405 and S406 to reduce the amount of information. The server whose resources change may include: a server corresponding to the entry/exit processing unit 134 that performs login authentication (e.g., a login authentication API server); a server having a function for providing the user with information about an area in the virtual space and a list of rooms that can be entered related to the area; a server corresponding to a room. The process of steps S405 and S406 in FIG. 19 may be performed for the user terminals of all the users who have entered the virtual space, or it may be performed for the user terminals of some users. For instance, some users include a user who enters a room in the same area as the area the specific user entered, or a user who enters the same room as the room the specific user entered.

### (Example of not Changing Settings)

The above embodiment describes an example in which, if the user who has entered the virtual space is a specific user in step S303 in FIG. 18 and in step S404 in FIG. 19, the setting change process is performed. However, if the desired level of resources or the amount of information has already been reached, no processing may be performed even if a specific user enters the virtual space. For instance, in FIG. 8, an increase in the number of operating servers is defined, and a maximum number of operating servers may be defined. If the number of operating servers already reaches the maximum number, the number of servers may not be increased even if a specific user logs in.

### (Degree of Setting Change in the Setting Change Process)

The above embodiment describes, as illustrated in FIG. 8, step S304 in FIG. 18, step S405 and step S406 in FIG. 19, an example of changing the degree of resources (e.g., the number of servers) and the amount of information (e.g., the frequency of synchronizations) that are examples of changing the degree of predetermined settings in accordance with a specific user. The present invention is not limited to this, and the degree of change in the settings that is made when a specific user enters the virtual space may be set uniform. Specifically, if a user is a specific user, a certain process may be performed regardless of their associated evaluation index or attribute number. For instance, the number of servers to be increased may be three whether the user ID “u2” in FIG. 7A logs in or the user ID “u7” logs in. Alternatively, the frequency of synchronizations may be set to three regardless of whether “u2” or “u7” logs in.

Alternatively, each time a specific user enters the virtual space, the degree of change of the settings may be calculated according to the specific user. For instance, the degree of change may be calculated each time, using a predetermined expression that defines the evaluation index of the specific user at the time of entry and the current resource usage rate as variables.

### (When Multiple Specific Users Log in)

When multiple specific users enter the virtual space, the change setting process in the above embodiment may be configured so that the degree of change in resources or information amount is calculated based on the degree of change in settings by a specific user who has already entered the virtual space and the degree of change in settings by a specific user who enters later. Then, the controller 130 performs the process according to the calculation results in response to the entry of the specific users. For instance, if user ID “u2” in FIG. 7A is in the virtual space and then user ID “u8” enters there, the degree of change then may be calculated using a criterion that combines their evaluation indices of “5” and “3.” For instance, the degree of resources or the degree of information amount may be in accordance with the evaluation index that corresponds to the sum of the evaluation indexes, or a higher degree of resources or such a degree of information amount may be used. Specifically, if a user with an evaluation index of “3” has already entered the virtual space and then a user with an evaluation index of “5” enters there, the setting change process has already been performed according to the evaluation index “3”. In this case, the setting change process according to the evaluation index “5” may be performed (e.g., increasing the number of servers from the maximum number of operating servers according to the evaluation index “3” to the maximum number of operating servers according to the evaluation index “5”). If a user with an evaluation index of “5” has already entered the virtual space and then a user with an evaluation index of “3” smaller than “5” enters there, the setting change process has already been performed according to the evaluation index “5”. In this case, the setting may not be changed again. For instance, the degree of resources or the degree of information amount may be in accordance with the evaluation index obtained by adding a half of the lower evaluation index to the higher evaluation index, or the degree of change may be calculated by a predetermined mathematical expression using these evaluation indexes as variables.

### (Setting Change Process According to Content Load)

The setting change process in the above embodiment may be performed according to the load of each piece of content provided by the distribution server 100. For instance, the degree of increase in resources and the degree of decrease in distribution amount may be greater when a specific user enters a room providing game content that is considered to have a high load than when the specific user enters a room providing chat-only content that has a relatively light load.

Furthermore, the settings may be changed in response to a specific user's movement between rooms within the virtual space. In the case of a server expansion process, for example, a process may be performed to increase server resources corresponding to game content when a specific user moves from a room in which chat-specific content is provided (server resources may have already been increased in accordance with the room in which the chat-specific content is provided) to a room in which game content is provided. In addition, the server resources of the room in which the chat-only content is provided and the user had entered before the movement may be reduced. Alternatively, when a specific user moves from a room in which game content is provided to a room in which chat-only content is provided, the server resources of the room in which the game content is provided and the specific user was in before the movement may be reduced. These rooms include a room corresponding to an area, a room to which a user can transition by selecting content from within an area, a room to which a user can transition from within an area via a portal, and a room that is provided regardless of an area.

In the case of a distribution information amount change process, for example, a process may be performed to reduce the amount of information distributed from the distribution server 100 to a user terminal in response to a specific user moving from a room where chat-only content is provided to a room with a high load where game content is provided. For instance, in a room where chat-only content is provided, the setting change process is not performed because the processing load is relatively light. Then, if the specific user moves to a room with heavy processing load, the setting change process may be performed.

### (Relationship Between Areas and Rooms)

The relationship between areas and rooms in the virtual space in the above-described embodiment is not limited to one type of room being defined for an area. Multiple types of rooms each having different content to be provided may be defined within the area. For instance, in an area that simulates a town, a user may transition between a room that simulates the town and a room that provides different content via a portal in the room or by selecting gate content, for example.

The above embodiment describes referring to FIG. 18 an example, in which the number of servers may be increased in step S302 and in step S304 to increase the number of rooms. For instance, when a user enters a room, the rooms to be increased may be automatically assigned to the user by a load balancing function (e.g., on the screen of FIG. 9C, the user only needs to select an area, and the room to enter may be automatically determined), and the entry process may be performed so that the number of people in each room is distributed, without being concentrated in one room. The number of servers may then be increased to increase the number of rooms when the number of people in a room exceeds the maximum number (when the room becomes full or when the room reaches a predetermined capacity just before being full). Even if a room is automatically assigned, a user may be allowed to input a room ID in the room ID input area 27 and enter a room with this room ID.

### (Examples of Server)

The server in the above-described embodiment may be any server that has a function as a server, and may include a physical server and a server configured using virtualization technology. Servers configured using virtualization technology include host OS-based virtualization, hypervisor-based virtualization, and container-based virtualization. All or some of the various servers may be configured on a cloud service (cloud system), which is an infrastructure configured using virtualization technology. For instance, a different server may be defined for each function or content.

For instance, in the case of a container-based virtualized server, one container or multiple containers are defined as one server, and control is performed to increase the number of running servers. For instance, if the login authentication device 101 detects that a specific user, a performer, has logged in, it transmits a command to the server management unit 105 to increase the number of containers to run the login authentication device 101. This increases the number of containers (servers) functioning as the login authentication device 101 (increasing the amount of CPU and memory allocated as computer resources), enhancing the processing performance of the servers.

### (Distribution Information Amount Change Processing)

The above embodiment describes an example of decreasing the drawing information of the virtual space to decrease the information amount distributed from the distribution server 100 to a user terminal, which is explained referring to step S403 and step S404 of FIG. 19. Such reduced drawing information includes reducing the number of user avatars. For instance, user avatars located at a predetermined distance from the user avatar being operated are displayed in a room, but user avatars located farther away than the predetermined distance are not displayed. However, a specific user such as a performer and a user avatar such as a friend (e.g., user that they follow) may be displayed even if they are farther away than the predetermined distance.

The distribution server 100 may transmit, to the user terminal, information for each user that identifies a user that they have selected in advance to follow and that is stored in distribution server 100 (information specifying whether or not the selection has been made) and a list of users who are in the same room including information for specifying the specific user. The user terminal may then extract the IDs of the user that they follow and the specific user, and the user terminal may request the distribution server 100 to display only the avatars of the extracted users as other user avatars. This reduces the processing load on both the distribution server 100 and user terminal.

In the distribution information amount change process, either the process of reducing the information requested by the user terminal (e.g., the process of transmitting information to reduce the frequency of the synchronization signal transmitted in step S402 and step S405 in FIG. 19) or the process for reducing the amount of information itself distributed to the user terminal (e.g., step S403 and step S406 in FIG. 19) may be executed first, or they may be executed simultaneously. The present invention is not limited to executing both of the processes, and they may be executed in stages according to the load status or the specific user. For instance, when the load is at a relatively light stage in a heavy state, or when the specific user with a relatively low evaluation index logs in, the frequency of synchronizations is reduced; and when the load is at a relatively heavy stage exceeding a predetermined threshold in a heavy state, or when the specific user with a relatively high evaluation index logs in, the frequency of synchronizations is reduced, and the amount of information distributed from the distribution server 100 to the user terminal also may be reduced.

### <User Terminals>

A user terminal operated by a specific user in the above-described embodiment may be the user terminal 300 or the distribution user terminal 400. A specific user may enter the virtual space from a dedicated application that is different from the application installed on the user terminals of other users.

### (Rooms to Enter)

The above embodiment describes an example, in which a user logs in to a virtual space from the screens of FIG. 9A and FIG. 9B, for example, and then enters a room by selecting the room corresponding to each area from the screen in FIG. 9C. The present invention is not limited to this, and a room may be automatically assigned (associated) when a user logs into the virtual space. Alternatively, in FIG. 9C, a user may select an area, whereby a room may be automatically assigned by a load balancing function.

### <Example of Execution Order of Entry Notification Process and Setting Change Process>

In the above-described embodiment, the entry notification process as in FIG. 12 and the setting change process of the distribution server 100 as in FIG. 18 and FIG. 19 may be performed either first or simultaneously. For instance, when the login authentication device 101 illustrated in FIG. 16 performs the login authentication processing for a specific user, the login authentication device 101 may first transmit a command to execute the process to the server management device 105, and then transmit information to the notification management device 104 to notify that the specific user has logged in.

Only one of the virtual space providing server expansion process and the distribution information amount change process, which are the setting change process, may be executed, or both may be executed according to the load situation or the specific user who has entered the virtual space. Alternatively, one of the processes may be executed preferentially, and both may be executed according to the load situation and the specific user who has entered the virtual space. For instance, the setting change process of the distribution server 100 may be executed when a specific user logs in, and the entry notification process may be executed when the specific user enters one of the rooms.

### [Addendum 1]

A system is known, which provides a virtual space to users via a network and enables them to interact with other users in the virtual space (e.g., a metaverse platform, and virtual social media).

In fan activities (supporting favorites), which involve supporting a favorite target, such as a performer or other person or thing, the mainstream approach is to collect the latest information about the target by checking posts from the performer themselves on social media, or posts from the accounts of the agency or other entity to which the performer belongs (see, for example, the above-described Non-Patent Literature).

Non-Patent literature: “Social media (SNS) indispensable to the supporting activities of young women in Japan”, [online], [searched on Jul. 21, 2023], Internet <https://news.mynavi.jp/article/womansns-50/>

When a specific user, such as a performer who is the target of support in fan activities, enters a virtual space like a virtual space provided by the metaverse platform as described above, for example, fan users tend to follow the specific user and try to enter the same virtual space. A specific user may suddenly initiate a live event in the virtual space without prior notice. Therefore, if users are able to quickly obtain information about a specific user entering the virtual space, their fan activities will be more fulfilling.

In views of the above, the present invention provides a method and a system that are capable of notifying other users that a specific user has entered a virtual space.

(1) A computer control method according to one aspect of the present invention makes a computer (e.g., distribution server 100, specific user information media management server 500 and user terminals) perform a process on the basis of a user's entry status into a virtual space,
the user having an evaluation value (e.g., evaluation index and user attribute number in FIG. 7A) defined, the evaluation value changing according to external evaluation from other than the user, and the method includes:
a step of executing a process that is not performed when a user who does not satisfy a predetermined condition according to the evaluation value (e.g., a user having a negative evaluation index in FIG. 7A) enters the virtual space (e.g., entering the virtual space by login, or entering a room), and is performed when a specific user who satisfies the predetermined condition according to the evaluation value (e.g., a user having a positive evaluation index, a user with a user attribute number “2”, “3”, or “5” such as a performer or celebrity in FIG. 7A) enters the virtual space, the process being to notify other users that the specific user has entered the virtual space (e.g., entry notification process in FIG. 12 to FIG. 15) (e.g., process by the notification management unit 135, data distribution unit 532, entry/exit status acquisition management unit 534, output unit 340, information acquisition unit 351, and display controller 353, for example).

This configuration allows other users to be notified that a specific user who satisfies the predetermined condition according to the evaluation value has entered the virtual space, making it easier for other users to obtain information about the specific user, thereby livening up the virtual space.

(2) In the above (1), the predetermined condition includes a condition that is satisfied when the evaluation value is a predetermined value (e.g., as illustrated in FIG. 7A, the user attribute number is “2,” “3,” or “5” for performers and celebrities, and the evaluation index is a positive value).

This configuration allows other users to be notified when a user having a predetermined value has entered the virtual space, making it easier to manage a specific user who is the target of notifications to other users.

(3) A computer control method according to one aspect of the present invention makes a computer (e.g., distribution server 100, specific user information media management server 500 and user terminals) perform a process on the basis of a user's entry status into a virtual space,
the user including a specific user (e.g., a performer or celebrity with user attribute number “2”, “3”, or “5” in FIG. 7A) predetermined by an administrator that operates the virtual space, the method includes a step of executing a process that is not performed when a user who has entered the virtual space is not the specific user (e.g., a general user having a user attribute value “1” in FIG. 7A), and is performed when a user who has entered the virtual space is the specific user, the process being to notify other users that the specific user has entered the virtual space (e.g., entry notification process in FIG. 12 to FIG. 15) (e.g., process by the notification management unit 135, data distribution unit 532, entry/exit status acquisition management unit 534, output unit 340, information acquisition unit 351, and display controller 353, for example).

This configuration allows other users to be notified that a specific user who is predetermined by the administrator has entered the virtual space, making it easier for other users to obtain information about the specific user, thereby livening up the virtual space.

(4) In the above (1) or (3), users to be notified that the specific user has entered the virtual space include a user who is currently in the virtual space (e.g., a user whose entry status in FIG. 7A is “In”).

This configuration allows a user in the virtual space also to be notified of the specific user entering the space, thereby preventing the user in the virtual space from being unaware that the specific user has entered the virtual space.

(5) In the above (1) or (3), users to be notified that the specific user has entered the virtual space do not include a user who is currently in the virtual space (e.g., a user whose entry status in FIG. 7A, is “In”), and includes a user who is not in the virtual space (e.g., a user whose entry status in FIG. 7A is “Out”) (see step S105A and step S105B in FIG. 13, (Entry notification process 3) in Modification Examples, for example).

With this configuration, a user in the virtual space is not notified that a specific user has entered the virtual space, thereby suppressing the possibility of the notification disrupting the users' sense of immersion in the virtual space.

(6) In the above (1) or (3), the virtual space includes multiple types of virtual spaces each having a different piece of content provided (e.g., areas, a room for each content), and
the step of executing the notification process includes notifying other users each time the specific user enters any of the multiple types of virtual spaces (see (Entry Notification Process) in Modification Examples, for Example).

This configuration allows other users to obtain information about a specific user's activity within the virtual space as appropriate, making it easier for other users to obtain information about the specific user, thereby livening up the virtual space.

(7) In the above (1) or (3), the notification content about the specific user having entered the virtual space includes information that enables identification of the virtual space that the specific user has entered among the multiple types of virtual spaces (e.g., displaying information about the area that the specific user has entered in the push notification of FIG. 10A).

This configuration enables identification of the virtual space where the specific user has entered, making it easier for other users to follow the specific user and enter the same space, thereby livening up the virtual space.

(8) In the above (1) or (3),
the method includes a step of determining whether or not a user has moved to a position (e.g., a region such as a platform that suggests that a live event is about to begin) corresponding to a predetermined region in the virtual space (e.g., user management unit 133), and
the step of executing the notification process includes, in response to a determination by the determining step that a user has moved to a position corresponding to the predetermined region, notifying other users that the user has moved to the predetermined region regardless of whether the user is a specific user (see (Other examples of users who are to be notified to other users) in Modification Examples).

This configuration allows other users to be notified of the presence of a user who has moved to a position corresponding the predetermined region, thus making other users focus on the predetermined region, and livening up the virtual space.

(9) In the above (1) or (3), even if the specific user enters the virtual space, and if a predetermined time has not elapsed since the previous entry into the virtual space, the step of executing the notification process does not notify other users that the specific user enters the virtual space (see (Entry notification process) in Modification Examples, for example).

This configuration prevents notifications from being issued multiple times in a short period of time, thereby suppressing discomfort caused by too many notifications.

(10) In the above (1) or (3), the step of executing the notification process includes displaying information (e.g., push notification in FIG. 10A, information about the specific user in FIG. 10B) indicating that the specific user has entered the virtual space on a display unit of a computer that the user owns, thus notifying the user notification, and
the method includes a step of accepting an operation on the information displayed by the step of executing the notification process, thus allowing the user who performed the operation to enter the virtual space where the specific user has entered via the displayed information (see (Push notification), (Example of the place to display information about a specific user), for example).

This configuration allows a user to enter the virtual space where the specific user has entered via a notification, making it easier to follow the specific user and enter the virtual space, and enhancing the level of satisfaction of other users.

(11) In the above (1) or (3), the notification content about the specific user having entered the virtual space, which is notified by the step of executing the notification process, includes special benefit grant information (e.g., a serial code) that grants a special benefit in response to inputting the information before entering the virtual space, and
the method further includes a step of granting a special benefit to the user when the user inputs the special benefit grant information before entering the virtual space (see (Push notification) in Modification Examples, for example).

This configuration grants a special benefit to a user, which can be further motivation to enter the virtual space. This therefore livens up the virtual space.

(12) In the above (1) or (3),
the method further includes a step of storing a selected specific user previously selected by a user from among the specific users in response to an operation from the user (e.g., following in the virtual space, selecting a favorite performer in a fan community app), and
the step of executing the notification process includes, when a user who has entered the virtual space is the specific user, notifying the user who has selected the specific user as the selected specific user that the specific user has entered the virtual space (see FIGS. 10A and 10B and (Other examples of users who are to be notified to other users) in Modification examples, for example).

This configuration allows the user to be notified of the information on their favorite, preselected specific user, thereby improving the level of satisfaction with the notified information.

(13) In the above (1) or (3),
the method includes a step (e.g., the controller 130) of calculating and storing, for each user, an involvement index with the specific user in the virtual space (e.g., the number of times of participating a live event related to the specific user, the amount of money charged related to the specific user, or the number of times the user has been in the same room with the specific user), based on a behavior history of the user in the virtual space, and
the step of executing the notification process includes, when a user who has entered the virtual space is the specific user, notifying a user having the involvement index with the specific user that is a predetermined value or more that the specific user has entered the virtual space (see (Other examples of users who are to be notified to other users) in Modification examples, for example).

This configuration allows a user to be notified that the specific user whose involvement index is the predetermined value or more has entered the virtual space, meaning that information more beneficial to other users can be reported. This improves the user's satisfaction with the notification information.

(14) In the above (1) or (3), the computer control method makes a computer (e.g., distribution server 100) perform a process of controlling a virtual space provision unit (e.g., controller 130, login authentication API server, and room server) that provides a user with the virtual space, and the method includes:
a first setting change step of executing a process (e.g., steps S301 to S302 in FIG. 18 and steps S401 to S403 in FIG. 19) of changing setting of the virtual space provision unit to a continuous provision state so that the virtual space can be continuously provided to users when it is a predetermined state that is established in response to multiple types of actions including entry into the virtual space by a user other than the specific user (e.g., entry by logging in, entry into a room, motion action in the virtual space), the predetermined state being for changing the setting of the virtual space provision unit (e.g., when the load on the distribution server 100 exceeds a threshold or when the upper limit number of people that can be associated with a room is reached); and
a second setting change step of, in response to the specific user entering the virtual space (e.g., entering by logging in or entering a room), executing a process (e.g., steps S303 to S304 in FIG. 18, steps S404 to S406 in FIG. 19) of changing the setting of the virtual space provision unit to the continuous provision state also in a situation where the predetermined state would not be established when a user other than the specific user entered the virtual space (e.g., NO in step S301 in FIG. 18, NO in step S401 in FIG. 19, the load on the distribution server 100 does not exceed a threshold, or the upper limit of the number of people that can be associated with a room is not reached).

(15) A system according to one aspect of the present invention includes a computer that performs a process on a basis of a user's entry status into a virtual space, and the system includes
the computer including a processor and a memory,
the user having an evaluation value defined, the evaluation value changing according to external evaluation from other than the user,
the processor being configured to
execute a process that is not performed when a user who does not satisfy a predetermined condition according to the evaluation value enters the virtual space, and is performed when a specific user who satisfies the predetermined condition according to the evaluation value enters the virtual space, the process being to notify other users that the specific user has entered the virtual space.

This configuration allows other users to be notified that a specific user who satisfies the predetermined condition according to the evaluation value has entered the virtual space, making it easier for other users to obtain information about the specific user, thereby livening up the virtual space.

(16) A system according to one aspect of the present invention includes a computer that performs a process on a basis of a user's entry status into a virtual space, and the system includes
the computer including a processor and a memory,
the user including a specific user predetermined by an administrator that operates the virtual space,
the processor being configured to
execute a process that is not performed when a user who has entered the virtual space is not the specific user, and is performed when a user who has entered the virtual space is the specific user, the process being to notify other users that the specific user has entered the virtual space.

This configuration allows other users to be notified that a specific user who is predetermined by the administrator has entered the virtual space, making it easier for other users to obtain information about the specific user, thereby livening up the virtual space.

### [Addendum 2]

A system is known, which provides a virtual space to users via a network and enables them to interact with other users in the virtual space (e.g., a metaverse platform, and virtual social media).

In fan activities (supporting favorites), which involve supporting a favorite target, such as a performer or other person or thing, the mainstream approach is to collect the latest information about the target by checking posts from the performer themselves on social media, or posts from the accounts of the agency or other entity to which the performer belongs (see, for example, the above-described Non-Patent Literature).

When a specific user, such as a performer who is the target of support in fan activities, enters a virtual space like a virtual space provided by the metaverse platform as described above, for example, fan users tend to follow the specific user and try to enter the same virtual space. Therefore, if users are able to quickly obtain information about a specific user entering the virtual space, their fan activities will be more fulfilling.

In views of the above, the present invention provides a method and a system that are capable of notifying other users that a specific user has entered a virtual space.

(1) A computer control method according to one aspect of the present invention makes a computer (e.g., distribution server 100, specific user information media management server 500 and user terminals) perform a process on the basis of a user's entry status into a virtual space, and the method includes
a step of performing a process so that information on a specific user is viewable to a user (e.g., processing by the notification management unit 135, data distribution unit 532, entry/exit status acquisition management unit 534, output unit 340, information acquisition unit 351, and display controller 353, for example), in which
the step of performing the process to make the information viewable includes, when the specific user enters the virtual space, performing a process such that information to make the entry of the specific user into the virtual space identifiable, which is information about the specific user, is viewable to other users (e.g., steps S106 to S108 in FIG. 12 and steps S203 to S205 in FIG. 13, which make it possible to display the performer schedule information in FIG. 10B and information about the specific user's entry on the bulletin board object O in FIG. 11).

This configuration allows other users to view the entry of the specific user into the virtual space as information about the specific user, thereby enhancing convenience for users who are looking for information about the specific user.

(2) In the above (1), the user has an evaluation value (e.g., evaluation index and user attribute number in FIG. 7A) defined, the evaluation value changing according to external evaluation from other than the user, and
the specific user is a user who satisfies a predetermined condition according to the evaluation value.

This configuration allows other users to view that a specific user who satisfies the predetermined condition according to the evaluation value has entered the virtual space, making it easier for other users to obtain information about the specific user, thereby livening up the virtual space.

(3) In the above (2), the predetermined condition includes a condition that is satisfied when the evaluation value is a predetermined value (e.g., as illustrated in FIG. 7A, the user attribute number is “2,” “3,” or “5” for performers and celebrities, and the evaluation index is a positive value).

This configuration allows other users to view when a user having a predetermined value has entered the virtual space, making it easier to manage a specific user who is the target of notifications to other users.

(4) In the above (1), the specific user includes a user (e.g., a performer or celebrity with user attribute number “2”, “3”, or “5” in FIG. 7A) predetermined by an administrator that operates the virtual space.

This configuration allows other users to view that a specific user who is predetermined by the administrator has entered the virtual space, making it easier for other users to obtain information about the specific user, thereby livening up the virtual space.

(5) In the above (1), the users who are allowed to view information that identifies that the specific user has entered the virtual space include a user who is currently in the virtual space (e.g., a user whose entry status in FIG. 7A is “In”).

This configuration allows a user in the virtual space also to view the information that identifies that the specific user has entered the space, thereby preventing the user in the virtual space from being unaware that the specific user has entered the virtual space.

(6) In the above (1), the virtual space includes multiple types of virtual spaces each having a different piece of content provided (e.g., areas, a room for each content), and
the step of performing the process to make the information viewable includes allowing other users to view information that identifies that the specific user has entered the virtual space each time the specific user enters any of the multiple types of virtual spaces (see (Entry notification Process) in Modification Examples, for example).

This configuration allows other users to obtain information about a specific user's activity within the virtual space as appropriate, making it easier for other users to obtain information about the specific user, thereby livening up the virtual space.

(7) In the above (1), the information that identifies that the specific user has entered the virtual space includes information that enables identification of the virtual space that the specific user has entered among the multiple types of virtual spaces (e.g., displaying information about the area that the specific user has entered in the content heading 40 in FIG. 10B or on the bulletin board object O in FIG. 11).

This configuration enables identification of the virtual space where the specific user has entered, making it easier for other users to follow the specific user and enter the same space, thereby livening up the virtual space.

(8) In the above (1)
the method includes a step of determining whether or not a user has moved to a position (e.g., a region such as a platform that suggests that a live event is about to begin) corresponding to a predetermined region in the virtual space (e.g., user management unit 133), and
the step of performing the process to make the information viewable includes, in response to a determination by the determining step that a user has moved to a position corresponding to the predetermined region, allowing other users to view information that identifies that the user has moved to the predetermined region regardless of whether the user is a specific user (see (Other examples of users who are to be notified to other users) in Modification Examples).

This configuration allows other users to view information that identifies the presence of a user who has moved to a position corresponding to the predetermined region, thus making other users focus on the predetermined region, and livening up the virtual space.

(9) In the above (1), even if the specific user enters the virtual space, and if a predetermined time has not elapsed since the previous entry into the virtual space, the step of performing the process to make the information viewable does not allow other users to view information that identifies that the specific user enters the virtual space (see (Entry notification process) in Modification Examples, for example).

This configuration prevents information about the specific user from being updated multiple times in a short period of time, thereby suppressing discomfort caused by too many viewing multiple times in a short period of time.

(10) In the above (1)
the method further includes a step of storing a selected specific user previously selected by a user from among the specific users in response to an operation from the user (e.g., following in the virtual space, selecting a favorite performer in a fan community app), and
the step of performing the process to make the information viewable includes, when a user who has entered the virtual space is the specific user, allowing the user who has selected the specific user as the selected specific user to view information that identifies that the specific user has entered the virtual space (see (Other examples of users who are to be notified to other users) in Modification examples, for example).

This configuration allows the user to view the information on their favorite, preselected specific user, thereby improving the level of satisfaction with the notified information.

(11) In the above (1),
the method includes a step (e.g., the controller 130) of calculating and storing, for each user, an involvement index with the specific user in the virtual space (e.g., the number of times of participating a live event related to the specific user, the amount of money charged related to the specific user, or the number of times the user has been in the same room with the specific user), based on a behavior history of the user in the virtual space, and
the step of performing the process to make the information viewable includes, when a user who has entered the virtual space is the specific user, allowing the user who has an involvement index with the specific user that is a predetermined value or more to view information that identifies that the specific user has entered the virtual space (see (Other examples of users who are to be notified to other users) in Modification examples, for example).

This configuration allows a user to view that the specific user whose involvement index is the predetermined value or more has entered the virtual space, meaning that other users are allowed to view information more beneficial to them. This improves the user's satisfaction with the information about the specific user that that user is allowed to view.

(12) In the above (1), the computer control method further makes a computer (e.g., distribution server 100) perform a process of controlling a virtual space provision unit (e.g., controller 130, login authentication API server, and room server) that provides a user with the virtual space, and the method includes:
a first setting change step of executing a process (e.g., steps S301 to S302 in FIG. 18 and steps S401 to S403 in FIG. 19) of changing setting of the virtual space provision unit to a continuous provision state so that the virtual space can be continuously provided to users when it is a predetermined state that is established in response to multiple types of actions including entry into the virtual space by a user other than the specific user (e.g., entry by logging in, entry into a room, motion action in the virtual space), the predetermined state being for changing the setting of the virtual space provision unit (e.g., when the load on the distribution server 100 exceeds a threshold or when the upper limit number of people that can be associated with a room is reached); and
a second setting change step of, in response to the specific user entering the virtual space (e.g., entering by logging in or entering a room), executing a process (e.g., steps S303 to S304 in FIG. 18, steps S404 to S406 in FIG. 19) of changing the setting of the virtual space provision unit to the continuous provision state also in a situation where the predetermined state would not be established when a user other than the specific user entered the virtual space (e.g., NO in step S301 in FIG. 18, NO in step S401 in FIG. 19, the load on the distribution server 100 does not exceed a threshold, or the upper limit of the number of people that can be associated with a room is not reached).

This configuration allows the setting of the virtual space provision unit to be changed in advance to the setting of the continuous provision state when a specific user enters the virtual space. This allows for countermeasures to be taken in advance for loads that may be caused by a specific user entering the space.

(13) In the above (1), the step of performing the process to make the information viewable includes displaying information about the specific user in a specific region (e.g., bulletin board object O in FIG. 11) in the virtual space so that information about the specific user is viewable in the specific region by a user in the virtual space.

This configuration allows users to view the information on the specific user even when they are in the virtual space, thereby enhancing convenience for users who are looking for information about the specific user.

(15) A system according to one aspect of the present invention includes a computer that performs a process on a basis of a user's entry status into a virtual space, and the system includes
the computer including a processor and a memory,
the processor being configured to
perform a process to allow a user to view information about the specific user,
the process to make the information viewable includes, when the specific user enters the virtual space, performing a process such that information to make the entry of the specific user into the virtual space identifiable, which is information about the specific user, is viewable to other users.

This configuration allows other users to view the entry of the specific user into the virtual space as information about the specific user, thereby enhancing convenience for users who are looking for information about the specific user.

### [Addendum 3]

A system is known, which provides a virtual space to users via a network and enables them to interact with other users in the virtual space (e.g., a metaverse platform, and virtual social media).

In fan activities (supporting favorites), which involve supporting a favorite target, such as a performer or other person or thing, the mainstream approach is to collect the latest information about the target by checking posts from the performer themselves on social media, or posts from the accounts of the agency or other entity to which the performer belongs (see, for example, the above-described Non-Patent Literature).

When a specific user, such as a performer who is the target of support in fan activities, enters a virtual space like a virtual space provided by the metaverse platform as described above, for example, fan users tend to follow the specific user and try to enter the same virtual space. Therefore, if users are able to quickly obtain information about a specific user entering the virtual space, their fan activities will be more fulfilling.

However, some specific users may wish to keep the fact that they have entered a virtual space a secret. If fans are always notified of their entry, the specific users will eventually become hesitant to enter the virtual space, which could result in hindering the activation of the virtual space.

In views of the above, the present invention provides a program, a method and a system that allow a specific user to select whether or not to notify other users that the specific user has entered a virtual space.

(1) A computer control method according to one aspect of the present invention makes a computer (e.g., distribution server 100, and user terminals) perform a process on the basis of a user's entry status into a virtual space, and the method includes:
a step of performing a process of allowing a specific user to set whether or not to notify other users of the specific user entering the virtual space (e.g., a process of displaying the screen of FIG. 9B on the user terminal by the notification management unit 135 and the display controller 353); and
a step of executing the process of notifying other users of the specific user entering the virtual space when the specific user has entered the virtual space and when a setting state of the specific user is to notify other users (e.g., when “Yes” icon 22Y is selected in FIG. 9B) (e.g., see steps S103 to S106 in FIG. 12 and (Selecting whether to notify other users) in Modification Examples).

This configuration allows the specific user to set whether or not to notify other users when they enter the space, taking into account the specific user's preferences, circumstances, and others, thereby enhancing convenience for the specific user.

(2) In the above (1), the user has an evaluation value defined, the evaluation value changing according to external evaluation from other than the user, and
the specific user includes a user who satisfies a predetermined condition according to the evaluation value.

This configuration allows other users to be notified that a specific user who satisfies the predetermined condition according to the evaluation value has entered the virtual space, making it easier for other users to obtain information about the specific user, thereby livening up the virtual space.

(3) In the above (2), the predetermined condition includes a condition that is satisfied when the evaluation value is a predetermined value (e.g., as illustrated in FIG. 7A, the user attribute number is “2,” “3,” or “5” for performers and celebrities, and the evaluation index is a positive value).

This configuration allows other users to be notified when a user having a predetermined value has entered the virtual space, making it easier to manage a specific user who is the target of notifications to other users.

(4) In the above (1), the specific user includes a specific user (e.g., a performer or celebrity with user attribute number “2”, “3”, or “5” in FIG. 7A) predetermined by an administrator that operates the virtual space.

This configuration allows other users to be notified that a specific user who is predetermined by the administrator has entered the virtual space, making it easier for other users to obtain information about the specific user, thereby livening up the virtual space.

(5) In the above (1), the specific user being in a setting state of notifying other users that the specific user has entered the virtual space includes the specific user performing a selection operation to notify other users that the specific user enters the virtual space when entering the virtual space (e.g., selecting “Yes” icon 22Y in FIG. 9B), and
the step of executing the notification process includes, in response to a specific user's selection operation to notify the other users when entering the virtual space, performing a process of notifying the other users that the specific user enters the virtual space (see step S103, S104 in FIG. 12, FIG. 9B, (Selecting whether to notify other users) in Modification Examples), for example).

This configuration allows the specific user to select whether or not to notify other users of the entry when they enter the virtual space, thereby allowing the specific user to make effective notifications in accordance with the situation of their entry.

(6) In the above (1), the other users to be notified that the specific user has entered the virtual space include a user who is currently in the virtual space (e.g., a user whose entry status in FIG. 7A is “In”).

This configuration allows a user in the virtual space also to be notified of the specific user entering the space, thereby preventing the user in the virtual space from being unaware that the specific user has entered the virtual space.

(7) In the above (1), the other users to be notified that the specific user has entered the virtual space does not include a user who is currently in the virtual space (e.g., a user whose entry status in FIG. 7A is “In”), and includes a user who is not in the virtual space (e.g., a user whose entry status in FIG. 7A is “Out”) (see step S105A and step S105B in FIG. 13, (Entry notification process 3) in Modification Examples, for example).

With this configuration, a user in the virtual space is not notified that a specific user has entered the virtual space, thereby suppressing the possibility of the notification disrupting the users' sense of immersion in the virtual space.

(8) In the above (1), the virtual space includes multiple types of virtual spaces each having a different piece of content provided (e.g., areas, a room for each content), and
the step of executing the notification process includes notifying other users each time the specific user enters any of the multiple types of virtual spaces (see (Entry notification Process) in Modification Examples, for example).

This configuration allows other users to obtain information about a specific user's activity within the virtual space as appropriate, making it easier for other users to obtain information about the specific user, thereby livening up the virtual space.

(9) In the above (1), the notification content about the specific user having entered the virtual space includes information that enables identification of the virtual space that the specific user has entered among the multiple types of virtual spaces (e.g., displaying the information on the area where the specific user has entered on the push notification in FIG. 10A, content heading 40 in FIG. 10B, and bulletin board object O in FIG. 11).

This configuration enables identification of the virtual space where the specific user has entered, making it easier for other users to follow the specific user and enter the same space, thereby livening up the virtual space.

(10) In the above (1), even if the specific user enters the virtual space, and if a predetermined time has not elapsed since the previous entry into the virtual space, the step of executing the notification process does not notify other users that the specific user enters the virtual space (see (Entry notification process) in Modification Examples, for example).

This configuration prevents notifications from being issued multiple times in a short period of time, thereby suppressing discomfort caused by too many notifications.

(11) In the above (1),
the method further includes a step of storing a selected specific user previously selected by a user from among the specific users in response to an operation from the user (e.g., following in the virtual space, selecting a favorite performer in a fan community app), and
the step of executing the notification process includes, when a user who has entered the virtual space is the specific user, notifying the user who has selected the specific user as the selected specific user that the specific user has entered the virtual space (see FIGS. 10A and 10B and (Other examples of users who are to be notified to other users) in Modification examples, for example).

This configuration allows the user to be notified of the information on their favorite, preselected specific user, thereby improving the level of satisfaction with the notified information.

(13) A system according to one aspect of the present invention includes a computer that performs processing on a basis of a user's entry status into a virtual space, and the system includes
the computer including a processor and a memory,
the processor being configured to a step of performing a process of allowing a specific user to set whether or not to notify other users of the specific user entering the virtual space; and
a step of executing the process of notifying other users of the specific user entering the virtual space when the specific user has entered the virtual space and when a setting state of the specific user is to notify other users.

This configuration allows the specific user to set whether or not to notify other users when they enter the space, taking into account the specific user's preferences, circumstances, and others, thereby enhancing convenience for the specific user.

### [Addendum 4]

A system is known, which provides a virtual space to users via a network and enables them to interact with other users in the virtual space ((e.g., a metaverse platform, and virtual social media).

In fan activities (supporting favorites), which involve supporting a favorite target, such as a performer or other person or thing, the mainstream approach is to collect the latest information about the target by checking posts from the performer themselves on social media, or posts from the accounts of the agency or other entity to which the performer belongs (see, for example, the above-described Non-Patent Literature).

When a specific user, such as a performer who is the target of support in fan activities, enters a virtual space like a virtual space provided by the metaverse platform as described above, for example, fan users tend to follow the specific user and try to enter the same virtual space. Therefore, if users are able to quickly obtain information about a specific user entering the virtual space, their fan activities will be more fulfilling.

Various live events are expected to be held in the virtual space, and there may be cases where some live events are hosted by specific users. If a user has already entered the virtual space to participate in a live event to be held in the virtual space, the user may already know that a specific user will enter the virtual space, or the immersion in the live event may be reduced by the notification.

In views of the above, the present invention provides a program, a method and a system that are capable of notifying other users that a specific user has entered a virtual space, in accordance with a login status of other users or a specific user.

(1) A computer control method according to one aspect of the present invention makes a computer (e.g., distribution server 100, and specific user information media management server 500) perform a process on the basis of a user's entry status into a virtual space, and the method includes
a step of executing a process that is not performed when a user who does not satisfy a predetermined condition (e.g., a user having a user attribute number “1” or a user having a negative evaluation index in FIG. 7A) enters the virtual space (e.g., entering the virtual space by login, or entering a room), and is performed when a specific user who satisfies the predetermined condition (e.g., a user such as a performer or celebrity having a user attribute number “2”, “3” or “5” or a user having a positive evaluation index in FIG. 7A) enters the virtual space, the process being to notify other users that the specific user has entered the virtual space (e.g., entry notification process in FIG. 12 to FIG. 15) (e.g., process by the notification management unit 135, data distribution unit 532, and entry/exit status acquisition management unit 534, for example), and
when the specific user enters the virtual space, the step of executing the notification process notifies other users except a user who is in the virtual space under a predetermined state that the specific user enters the virtual space (see step S104C and step S104D in Entry notification process 4 in FIG. 15, for example).

This configuration avoids a situation where the notification is given to a user who is in the virtual space under the predetermined state and whose necessity of being notified of the specific user's entry is low.

(2) A computer control method according to one aspect of the present invention makes a computer (e.g., distribution server 100, and specific user information media management server 500) perform a process on the basis of a user's entry status into a virtual space, and the method includes
a step of executing a process that is not performed when a user who does not satisfy a predetermined condition (e.g., a user having a user attribute number “1” or a user having a negative evaluation index in FIG. 7A) enters the virtual space (e.g., entering the virtual space by login, or entering a room), and is performed when a specific user who satisfies the predetermined condition (e.g., a user such as a performer or celebrity having a user attribute number “2”, “3” or “5” or a user having a positive evaluation index in FIG. 7A) enters the virtual space, the process being to notify other users that the specific user has entered the virtual space (e.g., entry notification process in FIG. 12 to FIG. 15) (e.g., process by the notification management unit 135, data distribution unit 532, and entry/exit status acquisition management unit 534, for example), and if the specific user enters the virtual space under a predetermined state (e.g., entering the virtual space for a pre-scheduled live event), the step of executing the process does not notify other users that the specific user enters the virtual space (see (Entry notification process 4) in Modification Examples, for example).

This configuration avoids a situation where the notification is given to a user under the predetermined state and whose necessity of being notified of the specific user's entry is low.

(3) In the above (1) or (2), the user has an evaluation value (e.g., evaluation index and user attribute number in FIG. 7A) defined, the evaluation value changing according to external evaluation from other than the user, and
the specific user includes a user who satisfies the predetermined condition according to the evaluation value.

This configuration allows other users to be notified that a specific user who satisfies the predetermined condition according to the evaluation value has entered the virtual space, making it easier for other users to obtain information about the specific user, thereby livening up the virtual space.

(4) In the above (3), the predetermined condition includes a condition that is satisfied when the evaluation value is a predetermined value (e.g., as illustrated in FIG. 7A, the user attribute number is “2,” “3,” or “5” for performers and celebrities, and the evaluation index is a positive value).

This configuration allows other users to be notified when a user having a predetermined value has entered the virtual space, making it easier to manage a specific user who is the target of notifications to other users.

(5) In the above (1) or (2), the specific user includes a specific user (e.g., a performer or celebrity with user attribute number “2”, “3”, or “5” in FIG. 7A) predetermined by an administrator that operates the virtual space.

This configuration allows other users to be notified that a specific user who is predetermined by the administrator has entered the virtual space, making it easier for other users to obtain information about the specific user, thereby livening up the virtual space.

(6) In the above (1),
the user who is in the virtual space under a predetermined state means the user participating in a predetermined event performed in the virtual space (e.g., participating predetermined content such as a live event).

With this configuration, no notification is given to a user who is participating in a predetermined event, so that the user's immersion in the event is not interrupted.

(7) In the above (1) or (2), the predetermined state means a state in which a predetermined event related to the specific user takes place in the virtual space (e.g., before or during a pre-scheduled live event in which a performer plays a leading role) (see, (Entry notification process 4) in Modification Examples, for example).

This configuration does not notify other users in the state where an event related to the specific user takes place, thus avoiding notifications given to the users who may know the information about the specific user entering the virtual space.

(8) A system according to one aspect of the present invention includes a computer that performs a process on a basis of a user's entry status into a virtual space, and the system includes
the computer including a processor and a memory,
the processor being configured to
execute a process that is not performed when a user who does not satisfy a predetermined condition enters the virtual space, and is performed when a specific user who satisfies the predetermined condition enters the virtual space, the process being to notify other users that the specific user has entered the virtual space, and
when the specific user enters the virtual space, notify other users except a user who is in the virtual space under a predetermined state that the specific user has entered the virtual space.

This configuration avoids a situation where the notification is given to a user who is in the virtual space under the predetermined state and whose necessity of being notified of the specific user's entry is low.

(9) A system according to one aspect of the present invention includes a computer that performs a process on a basis of a user's entry status into a virtual space, and the system includes
the computer including a processor and a memory,
the processor being configured to
execute a process that is not performed when a user who does not satisfy a predetermined condition enters the virtual space, and is performed when a specific user who satisfies the predetermined condition enters the virtual space, the process being to notify other users that the specific user has entered the virtual space, and
when the specific user enters the virtual space under a predetermined state, perform no process to notify other users of the specific user entering the virtual space.

This configuration avoids a situation where the notification is given to a user under the predetermined state and whose necessity of being notified of the specific user's entry is low.

### [Examples of Software Implementation]

The various control blocks of the controller of a computer such as a server or terminal in the above-mentioned embodiments may be implemented by a logic circuit (hardware) formed in an integrated circuit (IC chip), or may be implemented by software using a central processing unit (CPU). When the control blocks are implemented by software using a CPU, the computer having the controller includes a CPU that executes the instructions of a program, which is software that implements various functions, a read only memory ROM) or storage device (these are referred to as “recording media”) in which the program and various data are recorded so as to be readable by the computer (or CPU), and a random access memory (RAM) in which the program is expanded. Then, when the computer (or CPU) reads and executes the program from the above recording medium, the aim of the present invention is achieved. The recording medium may be a “non-transitory tangible medium” such as a tape, a disk, a card, a semiconductor memory, or a programmable logic circuit. The program may be supplied to the computer via any transmission medium (e.g., a communication network or broadcast waves) capable of transmitting the program. One aspect of the present invention can also be implemented in the form of a data signal embedded in a carrier wave, in which the above program is embodied by electronic transmission.

The embodiments disclosed in this description are to be considered in all respects as illustrative and not restrictive. The scope of the present invention is defined by the claims, rather than the above description, and is intended to include any modification within the meaning and scope equivalent to the terms of the claims.

### REFERENCE SIGNS LIST

1 Communication system 2 Network 100 Distribution server 200 Administrator terminal 300 User terminal 400 Distribution user terminal 500 Specific user information media management server

What is claimed is:

1. A method of controlling a computer configured to control a virtual space provision unit that provides a virtual space to a user, the method comprising:
a first step of executing a process of changing setting of the virtual space provision unit to a continuous provision state so that the virtual space is continuously provided to users when it is a predetermined state that is established in response to multiple types of actions including entry into the virtual space by a user who does not satisfy a specific condition, the predetermined state being to change the setting of the virtual space provision unit; and
a second step of, in response to an entering of the virtual space among actions by a user who satisfies the specific condition, executing a process of changing the setting of the virtual space provision unit to the continuous provision state, also in a situation where the predetermined state would not be established when a user who does not satisfy the specific condition entered the virtual space.

2. The method of claim 1, wherein the continuous provision state includes increasing resources that function as the virtual space provision unit.

3. The method according to claim 2, wherein the process of changing the setting of the virtual space provision unit to the continuous provision state includes a process of increasing the number of resources that function as the virtual space provision unit.

4. The method according to claim 2, wherein the process of changing the setting of the virtual space provision unit to the continuous provision state includes a process of enhancing performance of resources that function as the virtual space provision unit.

5. The method of claim 1, wherein the continuous provision state includes a state of decreasing an amount of information to be distributed from the virtual space provision unit to a user terminal of a user so as to provide the user with a virtual space.

6. The method according to claim 5, wherein the process of changing the setting of the virtual space provision unit to the continuous provision state includes a process of, in response to a request from a user terminal, distributing, to the user terminal, request information to decrease an amount of information distributed from the virtual space provision unit.

7. The method according to claim 5, wherein the process of changing the setting of the virtual space provision unit to the continuous provision state includes a process of reducing an amount of information distributed for displaying the virtual space.

8. The method according to claim 1, wherein the predetermined state includes a state that occurs when load on the virtual space provision unit exceeds a predetermined threshold.

9. The method according to claim 8, wherein the actions by the user include a motion action in the virtual space, and
the predetermined state includes a state that occurs when frequency of the motion action increases in the virtual space so that load on the virtual space provision unit exceeds a predetermined threshold.

10. The method according to claim 8, wherein the predetermined state includes a state that occurs when load on the virtual space provision unit exceeds a predetermined threshold in accordance with the number of users who have entered the virtual space.

11. The method according to claim 1, wherein the predetermined state includes a state that occurs when the number of users who have entered the virtual space reaches an upper limit number of users that are allowed to be associated with the virtual space provision unit.

12. The method according to claim 1, wherein the specific condition includes a condition that is satisfied when a user who has entered the virtual space is a predetermined special user.

13. The method according to claim 12, wherein the special user belongs to one of a plurality of types,
the continuous provision state includes a plurality of types of continuous provision states each having a different degree of change defined for each type of the special user, and
the second step executes a process of changing setting of the virtual space provision unit to a continuous provision state with a degree of change corresponding to a type of a special user who has entered the virtual space.

14. The method according to claim 1, wherein the user has an evaluation value defined, the evaluation value changing according to external evaluation from other than the user, and
the specific condition includes a condition that is satisfied when a user who has entered the virtual space has the evaluation value that is a predetermined value or higher.

15. The method according to claim 14, wherein the continuous provision state includes a plurality of types of continuous provision states each having a different degree of change according to an evaluation value of a user who satisfies the specific condition, and
the second step executes a process of changing setting of the virtual space provision unit to a continuous provision state with a degree of change corresponding to the evaluation value of a user who has entered the virtual space.

16. The method according to claim 1, wherein the virtual space includes multiple types of virtual spaces each corresponding to a different type of content provided in the virtual space, each type of content having a processing load that is variable on the virtual space provision unit, and
the second step performs a process of changing setting of the virtual space provision unit in accordance with a type of virtual space where a user who satisfies the specific condition has entered.

17. The method according to claim 2, wherein the user has an evaluation value defined, the evaluation value changing according to external evaluation from other than the user,
the specific condition includes a condition that is satisfied when a user who has entered the virtual space has the evaluation value that is a predetermined value or higher, and
when a first user having a first evaluation value that satisfies the specific condition has already entered a virtual space and then a second user having a second evaluation value that satisfies the specific condition enters the virtual space, a degree of increase in resources is calculated so as to correspond a combined evaluation value based on not only the second evaluation value but also based on the first evaluation value.

18. The method according to claim 5, wherein the user has an evaluation value defined, the evaluation value changing according to external evaluation from other than the user,
the specific condition includes a condition that is satisfied when a user who has entered the virtual space has the evaluation value that is a predetermined value or higher, and
when a first user having a first evaluation value that satisfies the specific condition has already entered a virtual space and then a second user having a second evaluation value that satisfies the specific condition enters the virtual space, a degree of decrease in amount of information is calculated so as to correspond a combined evaluation value based on not only the second evaluation value but also based on the first evaluation value.

19. The method according to claim 2, wherein the virtual space provision unit includes a container that is a virtualized server,
the process of changing the setting of the virtual space provision unit includes outputting, to a container management unit that manages execution of the container, a command signal to increase the number of containers executed, and
the continuous provision state includes increasing in the number of containers, thus increasing in an amount of resources of the virtual space provision unit.

20. A system comprising a computer configured to control a virtual space provision unit that provides a virtual space to a user, the system comprising
the computer including a processor and a memory,
the processor being configured to
execute a process of changing setting of the virtual space provision unit to a continuous provision state so that the virtual space is continuously provided to users when it is a predetermined state that is established in response to multiple types of actions including entry into the virtual space by a user who does not satisfy a specific condition, the predetermined state being to change the setting of the virtual space provision unit; and
in response to an entering of the virtual space among actions by a user who satisfies the specific condition, execute a process of changing the setting of the virtual space provision unit to the continuous provision state, also in a situation where the predetermined state would not be established when a user who does not satisfy the specific condition entered the virtual space.
